(19) United States
(12) Patent Application Publication
(10) Pub. No.: US 2025/0377776 A1
(43) Pub. Date: Dec. 11, 2025

(54) USER INTERFACES FOR PROVIDING AND INTERACTING WITH WORKOUT CONTENT

(71) Applicant: Apple Inc., Cupertino, CA (US)

(72) Inventors: Brett L. LAREAU, San Jose, CA (US); Fabiana DI MASO, Morgan Hill, CA (US)

(21) Appl. No.: 19/187,879

(22) Filed: Apr. 23, 2025

Related U.S. Application Data
(60) Provisional application No. 63/657,944, filed on Jun. 9, 2024.

(51) Int. Cl. G06F 3/0485; G06F 3/0482

(52) U.S. Cl. CPC G06F 3/0485; G06F 3/0482

(57) ABSTRACT

The present disclosure generally relates to user interfaces for providing and interacting with workout content.

### CROSS-REFERENCE TO RELATED APPLICATIONS

This application claims priority to U.S. Provisional Patent Application Ser. No. 63/657,944, entitled “USER INTERFACES FOR PROVIDING AND INTERACTING WITH WORKOUT CONTENT,” filed on Jun. 9, 2024, the contents of which are hereby incorporated by reference in their entirety.

### FIELD

The present disclosure relates generally to computer user interfaces, and more specifically to techniques for providing and interacting with workout content.

### BACKGROUND

Electronic devices can be used for accessing workout content (e.g., multimedia workout content), including content that is locally storied or delivered via a service.

### BRIEF SUMMARY

Some techniques for providing and interacting with workout content using electronic devices, however, are generally cumbersome and inefficient. For example, some existing techniques use a complex and time-consuming user interface, which may include multiple key presses or keystrokes. Existing techniques require more time than necessary, wasting user time and device energy. This latter consideration is particularly important in battery-operated devices.

Accordingly, the present technique provides electronic devices with faster, more efficient methods and interfaces for providing and interacting with workout content. Such methods and interfaces optionally complement or replace other methods for providing and interacting with workout content. Such methods and interfaces reduce the cognitive burden on a user and produce a more efficient human-machine interface. For battery-operated computing devices, such methods and interfaces conserve power and increase the time between battery charges.

In some embodiments, a method is disclosed. The method is performed at a computer system that is in communication with one or more display generation components and one or more input devices, and comprises: displaying, via the one or more display generation components, a first user interface that includes: a first scrollable region that is scrollable in a first direction; and a plurality of workout suggestions that are selected for inclusion in the first user interface based on a workout history of a user of the computer system, including a first workout suggestion that is selected for inclusion in the first user interface based on the workout history of the user of the computer system and that, when selected, causes the computer system to initiate a process for playback of a first workout corresponding to the first workout suggestion; displaying, within a first portion of the first scrollable region of the first user interface and concurrently with the first workout suggestion, a second workout suggestion different from the first workout suggestion, wherein the second workout suggestion is selected for inclusion in the first user interface based on the workout history of the user of the computer system and, when selected, causes the computer system to initiate a process for playback of a second workout different from the first workout; while displaying the second workout suggestion within the first portion of the first scrollable region of the first user interface, detecting, via the one or more input devices, a first user input; and in response to detecting the first user input: in accordance with a determination that the first user input is directed to the first scrollable region, displaying, concurrently with the first workout suggestion, scrolling of the first scrollable region to display, within the first portion of the first scrollable region, a workout plan recommendation, wherein: the workout plan recommendation is determined based on the workout history of the user of the computer system; and the workout plan recommendation pertains to a multi-workout workout plan.

In some embodiments, a non-transitory computer-readable storage medium is disclosed. The non-transitory computer-readable storage medium stores one or more programs configured to be executed by one or more processors of a computer system that is in communication with one or more display generation components and one or more input devices, the one or more programs including instructions for: displaying, via the one or more display generation components, a first user interface that includes: a first scrollable region that is scrollable in a first direction; and a plurality of workout suggestions that are selected for inclusion in the first user interface based on a workout history of a user of the computer system, including a first workout suggestion that is selected for inclusion in the first user interface based on the workout history of the user of the computer system and that, when selected, causes the computer system to initiate a process for playback of a first workout corresponding to the first workout suggestion; displaying, within a first portion of the first scrollable region of the first user interface and concurrently with the first workout suggestion, a second workout suggestion different from the first workout suggestion, wherein the second workout suggestion is selected for inclusion in the first user interface based on the workout history of the user of the computer system and, when selected, causes the computer system to initiate a process for playback of a second workout different from the first workout; while displaying the second workout suggestion within the first portion of the first scrollable region of the first user interface, detecting, via the one or more input devices, a first user input; and in response to detecting the first user input: in accordance with a determination that the first user input is directed to the first scrollable region, displaying, concurrently with the first workout suggestion, scrolling of the first scrollable region to display, within the first portion of the first scrollable region, a workout plan recommendation, wherein: the workout plan recommendation is determined based on the workout history of the user of the computer system; and the workout plan recommendation pertains to a multi-workout workout plan.

In some embodiments, a transitory computer-readable storage medium is disclosed. The transitory computer-readable storage medium stores one or more programs configured to be executed by one or more processors of a computer system that is in communication with one or more display generation components and one or more input devices, the one or more programs including instructions for: displaying, via the one or more display generation components, a first user interface that includes: a first scrollable region that is scrollable in a first direction; and a plurality of workout suggestions that are selected for inclusion in the first user interface based on a workout history of a user of the computer system, including a first workout suggestion that is selected for inclusion in the first user interface based on the workout history of the user of the computer system and that, when selected, causes the computer system to initiate a process for playback of a first workout corresponding to the first workout suggestion; displaying, within a first portion of the first scrollable region of the first user interface and concurrently with the first workout suggestion, a second workout suggestion different from the first workout suggestion, wherein the second workout suggestion is selected for inclusion in the first user interface based on the workout history of the user of the computer system and, when selected, causes the computer system to initiate a process for playback of a second workout different from the first workout; while displaying the second workout suggestion within the first portion of the first scrollable region of the first user interface, detecting, via the one or more input devices, a first user input; and in response to detecting the first user input: in accordance with a determination that the first user input is directed to the first scrollable region, displaying, concurrently with the first workout suggestion, scrolling of the first scrollable region to display, within the first portion of the first scrollable region, a workout plan recommendation, wherein: the workout plan recommendation is determined based on the workout history of the user of the computer system; and the workout plan recommendation pertains to a multi-workout workout plan.

In some embodiments, a computer system is disclosed. The computer system is configured to communicate with one or more display generation components and one or more input devices, and comprises: one or more processors; and memory storing one or more programs configured to be executed by the one or more processors, the one or more programs including instructions for: displaying, via the one or more display generation components, a first user interface that includes: a first scrollable region that is scrollable in a first direction; and a plurality of workout suggestions that are selected for inclusion in the first user interface based on a workout history of a user of the computer system, including a first workout suggestion that is selected for inclusion in the first user interface based on the workout history of the user of the computer system and that, when selected, causes the computer system to initiate a process for playback of a first workout corresponding to the first workout suggestion; displaying, within a first portion of the first scrollable region of the first user interface and concurrently with the first workout suggestion, a second workout suggestion different from the first workout suggestion, wherein the second workout suggestion is selected for inclusion in the first user interface based on the workout history of the user of the computer system and, when selected, causes the computer system to initiate a process for playback of a second workout different from the first workout; while displaying the second workout suggestion within the first portion of the first scrollable region of the first user interface, detecting, via the one or more input devices, a first user input; and in response to detecting the first user input: in accordance with a determination that the first user input is directed to the first scrollable region, displaying, concurrently with the first workout suggestion, scrolling of the first scrollable region to display, within the first portion of the first scrollable region, a workout plan recommendation, wherein: the workout plan recommendation is determined based on the workout history of the user of the computer system; and the workout plan recommendation pertains to a multi-workout workout plan.

In some embodiments, a computer system is disclosed. The computer system is configured to communicate with one or more display generation components and one or more input devices, and comprises: means for displaying, via the one or more display generation components, a first user interface that includes: a first scrollable region that is scrollable in a first direction; and a plurality of workout suggestions that are selected for inclusion in the first user interface based on a workout history of a user of the computer system, including a first workout suggestion that is selected for inclusion in the first user interface based on the workout history of the user of the computer system and that, when selected, causes the computer system to initiate a process for playback of a first workout corresponding to the first workout suggestion; means for displaying, within a first portion of the first scrollable region of the first user interface and concurrently with the first workout suggestion, a second workout suggestion different from the first workout suggestion, wherein the second workout suggestion is selected for inclusion in the first user interface based on the workout history of the user of the computer system and, when selected, causes the computer system to initiate a process for playback of a second workout different from the first workout; means for, while displaying the second workout suggestion within the first portion of the first scrollable region of the first user interface, detecting, via the one or more input devices, a first user input; and means for, in response to detecting the first user input: in accordance with a determination that the first user input is directed to the first scrollable region, displaying, concurrently with the first workout suggestion, scrolling of the first scrollable region to display, within the first portion of the first scrollable region, a workout plan recommendation, wherein: the workout plan recommendation is determined based on the workout history of the user of the computer system; and the workout plan recommendation pertains to a multi-workout workout plan.

In some embodiments, a computer program product is disclosed. The computer program product comprises one or more programs configured to be executed by one or more processors of a computer system that is in communication with one or more display generation components and one or more input devices, the one or more programs including instructions for: displaying, via the one or more display generation components, a first user interface that includes: a first scrollable region that is scrollable in a first direction; and a plurality of workout suggestions that are selected for inclusion in the first user interface based on a workout history of a user of the computer system, including a first workout suggestion that is selected for inclusion in the first user interface based on the workout history of the user of the computer system and that, when selected, causes the computer system to initiate a process for playback of a first workout corresponding to the first workout suggestion; displaying, within a first portion of the first scrollable region of the first user interface and concurrently with the first workout suggestion, a second workout suggestion different from the first workout suggestion, wherein the second workout suggestion is selected for inclusion in the first user interface based on the workout history of the user of the computer system and, when selected, causes the computer system to initiate a process for playback of a second workout different from the first workout; while displaying the second workout suggestion within the first portion of the first scrollable region of the first user interface, detecting, via the one or more input devices, a first user input; and in response to detecting the first user input: in accordance with a determination that the first user input is directed to the first scrollable region, displaying, concurrently with the first workout suggestion, scrolling of the first scrollable region to display, within the first portion of the first scrollable region, a workout plan recommendation, wherein: the workout plan recommendation is determined based on the workout history of the user of the computer system; and the workout plan recommendation pertains to a multi-workout workout plan.

In some embodiments, a method is disclosed. The method is performed at a computer system that is in communication with one or more display generation components and one or more input devices, and comprises: concurrently displaying, via the one or more display generation components: a first user interface object that corresponds to a first user interface; and a second user interface object that corresponds to a second user interface different from the first user interface; while concurrently displaying the first user interface object and the second user interface object, detecting, via the one or more input devices, a first user input; and in response to detecting the first user input: in accordance with a determination that the first user input corresponds to the first user interface object, displaying, via the one or more display generation components, the first user interface, wherein the first user interface includes a first plurality of workout suggestions that are selected for inclusion in the first user interface based on a workout history of a user of the computer system, including a first workout suggestion that is selected for inclusion in the first user interface based on the workout history of the user of the computer system and that, when selected, causes the computer system to initiate a process for playback of a first workout corresponding to the first workout suggestion; and in accordance with a determination that the first user input corresponds to selection of the second user interface object, displaying, via the one or more display generation components, the second user interface, wherein the second user interface includes a second plurality of workout suggestions different from the first plurality of workout suggestions, and that are selected for inclusion in the second user interface without regard for the workout history of the user of the computer system, including a second workout suggestion that is selected for inclusion in the second user interface without regard for the workout history of the user of the computer system and that, when selected, causes the computer system to initiate a process for playback of a second workout corresponding to the second workout suggestion.

In some embodiments, a non-transitory computer-readable storage medium is disclosed. The non-transitory computer-readable storage medium stores one or more programs configured to be executed by one or more processors of a computer system that is in communication with one or more display generation components and one or more input devices, the one or more programs including instructions for: concurrently displaying, via the one or more display generation components: a first user interface object that corresponds to a first user interface; and a second user interface object that corresponds to a second user interface different from the first user interface; while concurrently displaying the first user interface object and the second user interface object, detecting, via the one or more input devices, a first user input; and in response to detecting the first user input: in accordance with a determination that the first user input corresponds to the first user interface object, displaying, via the one or more display generation components, the first user interface, wherein the first user interface includes a first plurality of workout suggestions that are selected for inclusion in the first user interface based on a workout history of a user of the computer system, including a first workout suggestion that is selected for inclusion in the first user interface based on the workout history of the user of the computer system and that, when selected, causes the computer system to initiate a process for playback of a first workout corresponding to the first workout suggestion; and in accordance with a determination that the first user input corresponds to selection of the second user interface object, displaying, via the one or more display generation components, the second user interface, wherein the second user interface includes a second plurality of workout suggestions different from the first plurality of workout suggestions, and that are selected for inclusion in the second user interface without regard for the workout history of the user of the computer system, including a second workout suggestion that is selected for inclusion in the second user interface without regard for the workout history of the user of the computer system and that, when selected, causes the computer system to initiate a process for playback of a second workout corresponding to the second workout suggestion.

In some embodiments, a transitory computer-readable storage medium is disclosed. The transitory computer-readable storage medium stores one or more programs configured to be executed by one or more processors of a computer system that is in communication with one or more display generation components and one or more input devices, the one or more programs including instructions for: concurrently displaying, via the one or more display generation components: a first user interface object that corresponds to a first user interface; and a second user interface object that corresponds to a second user interface different from the first user interface; while concurrently displaying the first user interface object and the second user interface object, detecting, via the one or more input devices, a first user input; and in response to detecting the first user input: in accordance with a determination that the first user input corresponds to the first user interface object, displaying, via the one or more display generation components, the first user interface, wherein the first user interface includes a first plurality of workout suggestions that are selected for inclusion in the first user interface based on a workout history of a user of the computer system, including a first workout suggestion that is selected for inclusion in the first user interface based on the workout history of the user of the computer system and that, when selected, causes the computer system to initiate a process for playback of a first workout corresponding to the first workout suggestion; and in accordance with a determination that the first user input corresponds to selection of the second user interface object, displaying, via the one or more display generation components, the second user interface, wherein the second user interface includes a second plurality of workout suggestions different from the first plurality of workout suggestions, and that are selected for inclusion in the second user interface without regard for the workout history of the user of the computer system, including a second workout suggestion that is selected for inclusion in the second user interface without regard for the workout history of the user of the computer system and that, when selected, causes the computer system to initiate a process for playback of a second workout corresponding to the second workout suggestion.

In some embodiments, a computer system is disclosed. The computer system is configured to communicate with one or more display generation components and one or more input devices, and comprises: one or more processors; and memory storing one or more programs configured to be executed by the one or more processors, the one or more programs including instructions for: concurrently displaying, via the one or more display generation components: a first user interface object that corresponds to a first user interface; and a second user interface object that corresponds to a second user interface different from the first user interface; while concurrently displaying the first user interface object and the second user interface object, detecting, via the one or more input devices, a first user input; and in response to detecting the first user input: in accordance with a determination that the first user input corresponds to the first user interface object, displaying, via the one or more display generation components, the first user interface, wherein the first user interface includes a first plurality of workout suggestions that are selected for inclusion in the first user interface based on a workout history of a user of the computer system, including a first workout suggestion that is selected for inclusion in the first user interface based on the workout history of the user of the computer system and that, when selected, causes the computer system to initiate a process for playback of a first workout corresponding to the first workout suggestion; and in accordance with a determination that the first user input corresponds to selection of the second user interface object, displaying, via the one or more display generation components, the second user interface, wherein the second user interface includes a second plurality of workout suggestions different from the first plurality of workout suggestions, and that are selected for inclusion in the second user interface without regard for the workout history of the user of the computer system, including a second workout suggestion that is selected for inclusion in the second user interface without regard for the workout history of the user of the computer system and that, when selected, causes the computer system to initiate a process for playback of a second workout corresponding to the second workout suggestion.

In some embodiments, a computer system is disclosed. The computer system is configured to communicate with one or more display generation components and one or more input devices, and comprises: means for concurrently displaying, via the one or more display generation components: a first user interface object that corresponds to a first user interface; and a second user interface object that corresponds to a second user interface different from the first user interface; means for, while concurrently displaying the first user interface object and the second user interface object, detecting, via the one or more input devices, a first user input; and means for, in response to detecting the first user input: in accordance with a determination that the first user input corresponds to the first user interface object, displaying, via the one or more display generation components, the first user interface, wherein the first user interface includes a first plurality of workout suggestions that are selected for inclusion in the first user interface based on a workout history of a user of the computer system, including a first workout suggestion that is selected for inclusion in the first user interface based on the workout history of the user of the computer system and that, when selected, causes the computer system to initiate a process for playback of a first workout corresponding to the first workout suggestion; and in accordance with a determination that the first user input corresponds to selection of the second user interface object, displaying, via the one or more display generation components, the second user interface, wherein the second user interface includes a second plurality of workout suggestions different from the first plurality of workout suggestions, and that are selected for inclusion in the second user interface without regard for the workout history of the user of the computer system, including a second workout suggestion that is selected for inclusion in the second user interface without regard for the workout history of the user of the computer system and that, when selected, causes the computer system to initiate a process for playback of a second workout corresponding to the second workout suggestion.

In some embodiments, a computer program product is disclosed. The computer program product comprises one or more programs configured to be executed by one or more processors of a computer system that is in communication with one or more display generation components and one or more input devices, the one or more programs including instructions for: concurrently displaying, via the one or more display generation components: a first user interface object that corresponds to a first user interface; and a second user interface object that corresponds to a second user interface different from the first user interface; while concurrently displaying the first user interface object and the second user interface object, detecting, via the one or more input devices, a first user input; and in response to detecting the first user input: in accordance with a determination that the first user input corresponds to the first user interface object, displaying, via the one or more display generation components, the first user interface, wherein the first user interface includes a first plurality of workout suggestions that are selected for inclusion in the first user interface based on a workout history of a user of the computer system, including a first workout suggestion that is selected for inclusion in the first user interface based on the workout history of the user of the computer system and that, when selected, causes the computer system to initiate a process for playback of a first workout corresponding to the first workout suggestion; and in accordance with a determination that the first user input corresponds to selection of the second user interface object, displaying, via the one or more display generation components, the second user interface, wherein the second user interface includes a second plurality of workout suggestions different from the first plurality of workout suggestions, and that are selected for inclusion in the second user interface without regard for the workout history of the user of the computer system, including a second workout suggestion that is selected for inclusion in the second user interface without regard for the workout history of the user of the computer system and that, when selected, causes the computer system to initiate a process for playback of a second workout corresponding to the second workout suggestion.

In some embodiments, a method is disclosed. The method is performed at a computer system that is in communication with one or more display generation components and one or more input devices, and comprises: detecting, via the one or more input devices, a first user input corresponding to a user request to display a first user interface of a first workout application; and in response to detecting the first user input, displaying, via the one or more display generation components, the first user interface of the first workout application, wherein the first user interface includes a plurality of workout suggestions, and further wherein: in accordance with a determination that a user of the computer system has completed a threshold number of workouts in the first workout application, the first user interface includes a first type of workout suggestion that includes a first set of workout suggestions that are selected for inclusion in the first user interface based on a workout history of a user of the computer system in the first workout application; and in accordance with a determination that the user of the computer system has not completed the threshold number of workouts in the first workout application and has completed one or more workouts in one or more other workout applications different from the first workout application: the first user interface does not include the first type of workout suggestion; and the first user interface includes a second set of workout suggestions that are selected for inclusion in the first user interface based on a workout history of the user in the one or more other workout applications different from the first workout application.

In some embodiments, a non-transitory computer-readable storage medium is disclosed. The non-transitory computer-readable storage medium stores one or more programs configured to be executed by one or more processors of a computer system that is in communication with one or more display generation components and one or more input devices, the one or more programs including instructions for: detecting, via the one or more input devices, a first user input corresponding to a user request to display a first user interface of a first workout application; and in response to detecting the first user input, displaying, via the one or more display generation components, the first user interface of the first workout application, wherein the first user interface includes a plurality of workout suggestions, and further wherein: in accordance with a determination that a user of the computer system has completed a threshold number of workouts in the first workout application, the first user interface includes a first type of workout suggestion that includes a first set of workout suggestions that are selected for inclusion in the first user interface based on a workout history of a user of the computer system in the first workout application; and in accordance with a determination that the user of the computer system has not completed the threshold number of workouts in the first workout application and has completed one or more workouts in one or more other workout applications different from the first workout application: the first user interface does not include the first type of workout suggestion; and the first user interface includes a second set of workout suggestions that are selected for inclusion in the first user interface based on a workout history of the user in the one or more other workout applications different from the first workout application.

In some embodiments, a transitory computer-readable storage medium is disclosed. The transitory computer-readable storage medium stores one or more programs configured to be executed by one or more processors of a computer system that is in communication with one or more display generation components and one or more input devices, the one or more programs including instructions for: detecting, via the one or more input devices, a first user input corresponding to a user request to display a first user interface of a first workout application; and in response to detecting the first user input, displaying, via the one or more display generation components, the first user interface of the first workout application, wherein the first user interface includes a plurality of workout suggestions, and further wherein: in accordance with a determination that a user of the computer system has completed a threshold number of workouts in the first workout application, the first user interface includes a first type of workout suggestion that includes a first set of workout suggestions that are selected for inclusion in the first user interface based on a workout history of a user of the computer system in the first workout application; and in accordance with a determination that the user of the computer system has not completed the threshold number of workouts in the first workout application and has completed one or more workouts in one or more other workout applications different from the first workout application: the first user interface does not include the first type of workout suggestion; and the first user interface includes a second set of workout suggestions that are selected for inclusion in the first user interface based on a workout history of the user in the one or more other workout applications different from the first workout application.

In some embodiments, a computer system is disclosed. The computer system is configured to communicate with one or more display generation components and one or more input devices, and comprises: one or more processors; and memory storing one or more programs configured to be executed by the one or more processors, the one or more programs including instructions for: detecting, via the one or more input devices, a first user input corresponding to a user request to display a first user interface of a first workout application; and in response to detecting the first user input, displaying, via the one or more display generation components, the first user interface of the first workout application, wherein the first user interface includes a plurality of workout suggestions, and further wherein: in accordance with a determination that a user of the computer system has completed a threshold number of workouts in the first workout application, the first user interface includes a first type of workout suggestion that includes a first set of workout suggestions that are selected for inclusion in the first user interface based on a workout history of a user of the computer system in the first workout application; and in accordance with a determination that the user of the computer system has not completed the threshold number of workouts in the first workout application and has completed one or more workouts in one or more other workout applications different from the first workout application: the first user interface does not include the first type of workout suggestion; and the first user interface includes a second set of workout suggestions that are selected for inclusion in the first user interface based on a workout history of the user in the one or more other workout applications different from the first workout application.

In some embodiments, a computer system is disclosed. The computer system is configured to communicate with one or more display generation components and one or more input devices, and comprises: means for detecting, via the one or more input devices, a first user input corresponding to a user request to display a first user interface of a first workout application; and means for, in response to detecting the first user input, displaying, via the one or more display generation components, the first user interface of the first workout application, wherein the first user interface includes a plurality of workout suggestions, and further wherein: in accordance with a determination that a user of the computer system has completed a threshold number of workouts in the first workout application, the first user interface includes a first type of workout suggestion that includes a first set of workout suggestions that are selected for inclusion in the first user interface based on a workout history of a user of the computer system in the first workout application; and in accordance with a determination that the user of the computer system has not completed the threshold number of workouts in the first workout application and has completed one or more workouts in one or more other workout applications different from the first workout application: the first user interface does not include the first type of workout suggestion; and the first user interface includes a second set of workout suggestions that are selected for inclusion in the first user interface based on a workout history of the user in the one or more other workout applications different from the first workout application.

In some embodiments, a computer program product is disclosed. The computer program product comprises one or more programs configured to be executed by one or more processors of a computer system that is in communication with one or more display generation components and one or more input devices, the one or more programs including instructions for: detecting, via the one or more input devices, a first user input corresponding to a user request to display a first user interface of a first workout application; and in response to detecting the first user input, displaying, via the one or more display generation components, the first user interface of the first workout application, wherein the first user interface includes a plurality of workout suggestions, and further wherein: in accordance with a determination that a user of the computer system has completed a threshold number of workouts in the first workout application, the first user interface includes a first type of workout suggestion that includes a first set of workout suggestions that are selected for inclusion in the first user interface based on a workout history of a user of the computer system in the first workout application; and in accordance with a determination that the user of the computer system has not completed the threshold number of workouts in the first workout application and has completed one or more workouts in one or more other workout applications different from the first workout application: the first user interface does not include the first type of workout suggestion; and the first user interface includes a second set of workout suggestions that are selected for inclusion in the first user interface based on a workout history of the user in the one or more other workout applications different from the first workout application.

In some embodiments, a method is disclosed. The method is performed at a computer system that is in communication with one or more display generation components and one or more input devices, and comprises: detecting, via the one or more input devices, a user request to display a workout sharing user interface; in response to detecting the user request to display the workout sharing user interface, displaying, via the one or more display generation components, the workout sharing user interface, wherein the workout sharing user interface includes: a representation of a first workout achievement by a first remote user different from a user of the computer system, wherein the representation of the first workout achievement includes a first response object that, when selected, causes the computer system to display a first set of response options for responding to the first workout achievement by the first remote user; and a representation of a second workout achievement by the first remote user different from the representation of the first workout achievement by the first remote user, wherein the representation of the second workout achievement includes a second response object that, when selected, causes the computer system to display a second set of response options for responding to the second workout achievement by the first remote user; while displaying the workout sharing user interface, detecting, via the one or more input devices, a selection input; and in response to detecting the selection input: in accordance with a determination that the selection input is directed to the first response object, displaying, via the one or more display generation components, the first set of response options for responding to the first workout achievement by the first remote user, including: a first response option that, when selected, initiates a process for transmitting a first response to the first remote user in response to the first workout achievement; and a second response option that, when selected, initiates a process for transmitting a second response different from the first response to the first remote user in response to the first workout achievement; and in accordance with a determination that the selection input is directed to the second response object, displaying, via the one or more display generation components, the second set of response options for responding to the second workout achievement by the first remote user, including: a third response option that, when selected, initiates a process for transmitting a third response to the first remote user in response to the second workout achievement; and a fourth response option that, when selected, initiates a process for transmitting a fourth response different from the third response to the first remote user in response to the second workout achievement.

In some embodiments, a non-transitory computer-readable storage medium is disclosed. The non-transitory computer-readable storage medium stores one or more programs configured to be executed by one or more processors of a computer system that is in communication with one or more display generation components and one or more input devices, the one or more programs including instructions for: detecting, via the one or more input devices, a user request to display a workout sharing user interface; in response to detecting the user request to display the workout sharing user interface, displaying, via the one or more display generation components, the workout sharing user interface, wherein the workout sharing user interface includes: a representation of a first workout achievement by a first remote user different from a user of the computer system, wherein the representation of the first workout achievement includes a first response object that, when selected, causes the computer system to display a first set of response options for responding to the first workout achievement by the first remote user; and a representation of a second workout achievement by the first remote user different from the representation of the first workout achievement by the first remote user, wherein the representation of the second workout achievement includes a second response object that, when selected, causes the computer system to display a second set of response options for responding to the second workout achievement by the first remote user; while displaying the workout sharing user interface, detecting, via the one or more input devices, a selection input; and in response to detecting the selection input: in accordance with a determination that the selection input is directed to the first response object, displaying, via the one or more display generation components, the first set of response options for responding to the first workout achievement by the first remote user, including: a first response option that, when selected, initiates a process for transmitting a first response to the first remote user in response to the first workout achievement; and a second response option that, when selected, initiates a process for transmitting a second response different from the first response to the first remote user in response to the first workout achievement; and in accordance with a determination that the selection input is directed to the second response object, displaying, via the one or more display generation components, the second set of response options for responding to the second workout achievement by the first remote user, including: a third response option that, when selected, initiates a process for transmitting a third response to the first remote user in response to the second workout achievement; and a fourth response option that, when selected, initiates a process for transmitting a fourth response different from the third response to the first remote user in response to the second workout achievement.

In some embodiments, a transitory computer-readable storage medium is disclosed. The transitory computer-readable storage medium stores one or more programs configured to be executed by one or more processors of a computer system that is in communication with one or more display generation components and one or more input devices, the one or more programs including instructions for: detecting, via the one or more input devices, a user request to display a workout sharing user interface; in response to detecting the user request to display the workout sharing user interface, displaying, via the one or more display generation components, the workout sharing user interface, wherein the workout sharing user interface includes: a representation of a first workout achievement by a first remote user different from a user of the computer system, wherein the representation of the first workout achievement includes a first response object that, when selected, causes the computer system to display a first set of response options for responding to the first workout achievement by the first remote user; and a representation of a second workout achievement by the first remote user different from the representation of the first workout achievement by the first remote user, wherein the representation of the second workout achievement includes a second response object that, when selected, causes the computer system to display a second set of response options for responding to the second workout achievement by the first remote user; while displaying the workout sharing user interface, detecting, via the one or more input devices, a selection input; and in response to detecting the selection input: in accordance with a determination that the selection input is directed to the first response object, displaying, via the one or more display generation components, the first set of response options for responding to the first workout achievement by the first remote user, including: a first response option that, when selected, initiates a process for transmitting a first response to the first remote user in response to the first workout achievement; and a second response option that, when selected, initiates a process for transmitting a second response different from the first response to the first remote user in response to the first workout achievement; and in accordance with a determination that the selection input is directed to the second response object, displaying, via the one or more display generation components, the second set of response options for responding to the second workout achievement by the first remote user, including: a third response option that, when selected, initiates a process for transmitting a third response to the first remote user in response to the second workout achievement; and a fourth response option that, when selected, initiates a process for transmitting a fourth response different from the third response to the first remote user in response to the second workout achievement.

In some embodiments, a computer system is disclosed. The computer system is configured to communicate with one or more display generation components and one or more input devices, and comprises: one or more processors; and memory storing one or more programs configured to be executed by the one or more processors, the one or more programs including instructions for: detecting, via the one or more input devices, a user request to display a workout sharing user interface; in response to detecting the user request to display the workout sharing user interface, displaying, via the one or more display generation components, the workout sharing user interface, wherein the workout sharing user interface includes: a representation of a first workout achievement by a first remote user different from a user of the computer system, wherein the representation of the first workout achievement includes a first response object that, when selected, causes the computer system to display a first set of response options for responding to the first workout achievement by the first remote user; and a representation of a second workout achievement by the first remote user different from the representation of the first workout achievement by the first remote user, wherein the representation of the second workout achievement includes a second response object that, when selected, causes the computer system to display a second set of response options for responding to the second workout achievement by the first remote user; while displaying the workout sharing user interface, detecting, via the one or more input devices, a selection input; and in response to detecting the selection input: in accordance with a determination that the selection input is directed to the first response object, displaying, via the one or more display generation components, the first set of response options for responding to the first workout achievement by the first remote user, including: a first response option that, when selected, initiates a process for transmitting a first response to the first remote user in response to the first workout achievement; and a second response option that, when selected, initiates a process for transmitting a second response different from the first response to the first remote user in response to the first workout achievement; and in accordance with a determination that the selection input is directed to the second response object, displaying, via the one or more display generation components, the second set of response options for responding to the second workout achievement by the first remote user, including: a third response option that, when selected, initiates a process for transmitting a third response to the first remote user in response to the second workout achievement; and a fourth response option that, when selected, initiates a process for transmitting a fourth response different from the third response to the first remote user in response to the second workout achievement.

In some embodiments, a computer system is disclosed. The computer system is configured to communicate with one or more display generation components and one or more input devices, and comprises: means for detecting, via the one or more input devices, a user request to display a workout sharing user interface; means for, in response to detecting the user request to display the workout sharing user interface, displaying, via the one or more display generation components, the workout sharing user interface, wherein the workout sharing user interface includes: a representation of a first workout achievement by a first remote user different from a user of the computer system, wherein the representation of the first workout achievement includes a first response object that, when selected, causes the computer system to display a first set of response options for responding to the first workout achievement by the first remote user; and a representation of a second workout achievement by the first remote user different from the representation of the first workout achievement by the first remote user, wherein the representation of the second workout achievement includes a second response object that, when selected, causes the computer system to display a second set of response options for responding to the second workout achievement by the first remote user; means for, while displaying the workout sharing user interface, detecting, via the one or more input devices, a selection input; and means for, in response to detecting the selection input: in accordance with a determination that the selection input is directed to the first response object, displaying, via the one or more display generation components, the first set of response options for responding to the first workout achievement by the first remote user, including: a first response option that, when selected, initiates a process for transmitting a first response to the first remote user in response to the first workout achievement; and a second response option that, when selected, initiates a process for transmitting a second response different from the first response to the first remote user in response to the first workout achievement; and in accordance with a determination that the selection input is directed to the second response object, displaying, via the one or more display generation components, the second set of response options for responding to the second workout achievement by the first remote user, including: a third response option that, when selected, initiates a process for transmitting a third response to the first remote user in response to the second workout achievement; and a fourth response option that, when selected, initiates a process for transmitting a fourth response different from the third response to the first remote user in response to the second workout achievement.

In some embodiments, a computer program product is disclosed. The computer program product comprises one or more programs configured to be executed by one or more processors of a computer system that is in communication with one or more display generation components and one or more input devices, the one or more programs including instructions for: detecting, via the one or more input devices, a user request to display a workout sharing user interface; in response to detecting the user request to display the workout sharing user interface, displaying, via the one or more display generation components, the workout sharing user interface, wherein the workout sharing user interface includes: a representation of a first workout achievement by a first remote user different from a user of the computer system, wherein the representation of the first workout achievement includes a first response object that, when selected, causes the computer system to display a first set of response options for responding to the first workout achievement by the first remote user; and a representation of a second workout achievement by the first remote user different from the representation of the first workout achievement by the first remote user, wherein the representation of the second workout achievement includes a second response object that, when selected, causes the computer system to display a second set of response options for responding to the second workout achievement by the first remote user; while displaying the workout sharing user interface, detecting, via the one or more input devices, a selection input; and in response to detecting the selection input: in accordance with a determination that the selection input is directed to the first response object, displaying, via the one or more display generation components, the first set of response options for responding to the first workout achievement by the first remote user, including: a first response option that, when selected, initiates a process for transmitting a first response to the first remote user in response to the first workout achievement; and a second response option that, when selected, initiates a process for transmitting a second response different from the first response to the first remote user in response to the first workout achievement; and in accordance with a determination that the selection input is directed to the second response object, displaying, via the one or more display generation components, the second set of response options for responding to the second workout achievement by the first remote user, including: a third response option that, when selected, initiates a process for transmitting a third response to the first remote user in response to the second workout achievement; and a fourth response option that, when selected, initiates a process for transmitting a fourth response different from the third response to the first remote user in response to the second workout achievement.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

Thus, devices are provided with faster, more efficient methods and interfaces for providing and interacting with workout content, thereby increasing the effectiveness, efficiency, and user satisfaction with such devices. Such methods and interfaces may complement or replace other methods for providing and interacting with workout content.

### DESCRIPTION OF THE FIGURES

For a better understanding of the various described embodiments, reference should be made to the Description of Embodiments below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIG. 3A is a block diagram of an exemplary multifunction device with a display and a touch-sensitive surface in accordance with some embodiments.

FIGS. 3B-3G illustrate the use of Application Programming Interfaces (A PIs) to perform operations.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIG. 5A illustrates a personal electronic device in accordance with some embodiments.

FIG. 5B is a block diagram illustrating a personal electronic device in accordance with some embodiments.

FIGS. 6A-6R illustrate exemplary user interfaces for presenting workout content, in accordance with some embodiments.

FIG. 7 illustrates a flow diagram depicting a method for presenting workout content, in accordance with some embodiments.

FIG. 8 illustrates a flow diagram depicting a method for presenting workout content, in accordance with some embodiments.

FIG. 9 illustrates a flow diagram depicting a method for presenting workout content, in accordance with some embodiments.

FIGS. 10A-10M illustrate exemplary user interfaces for interacting with workout content, in accordance with some embodiments.

FIG. 11 illustrates a flow diagram depicting a method for interacting with workout content, in accordance with some embodiments.

### DESCRIPTION OF EMBODIMENTS

The following description sets forth exemplary methods, parameters, and the like. It should be recognized, however, that such description is not intended as a limitation on the scope of the present disclosure but is instead provided as a description of exemplary embodiments.

There is a need for electronic devices that provide efficient methods and interfaces for providing and interacting with workout content. Such techniques can reduce the cognitive burden on a user who accesses workout content, thereby enhancing productivity. Further, such techniques can reduce processor and battery power otherwise wasted on redundant user inputs.

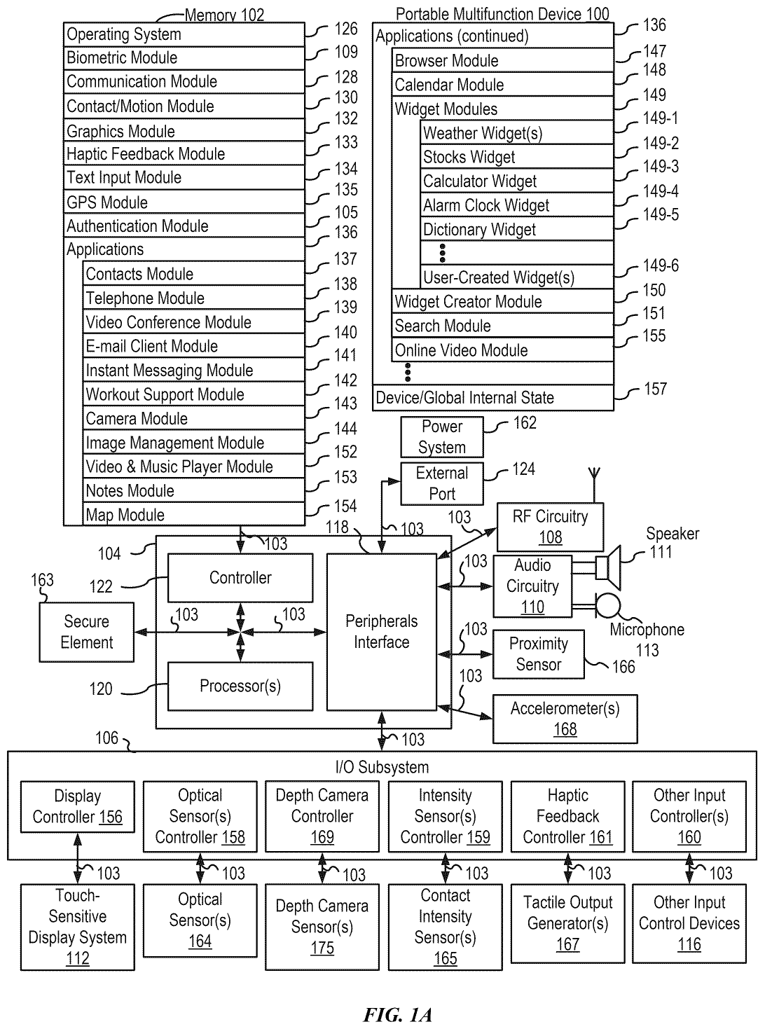

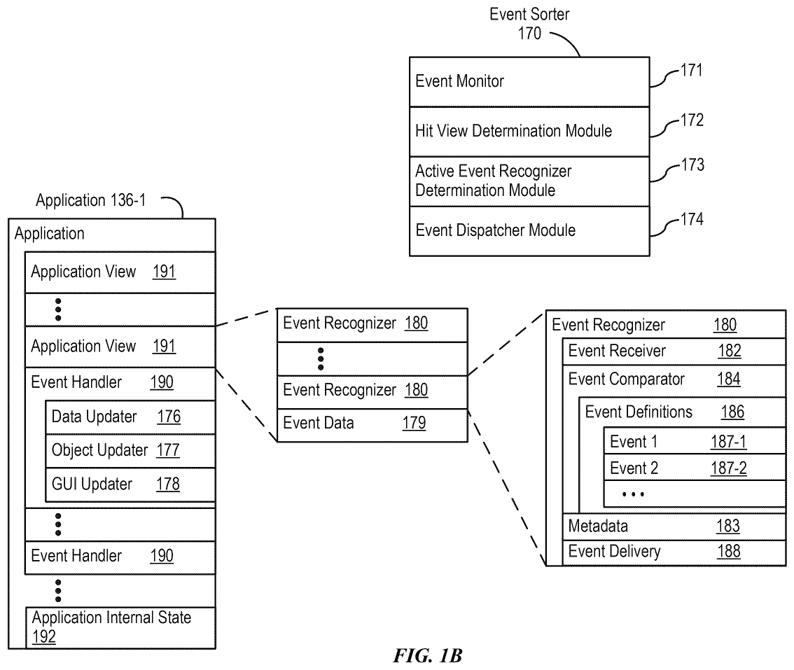

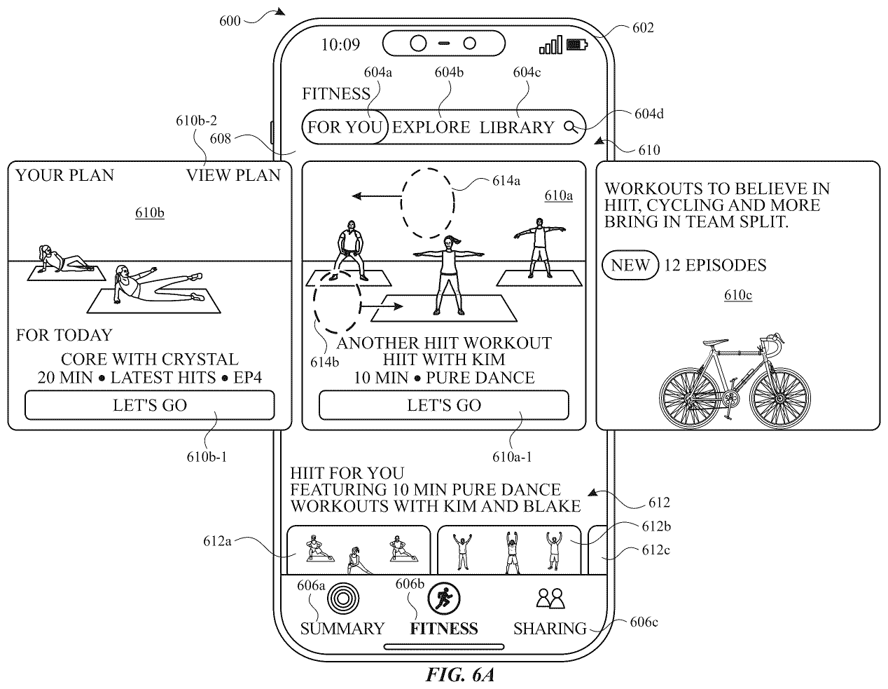

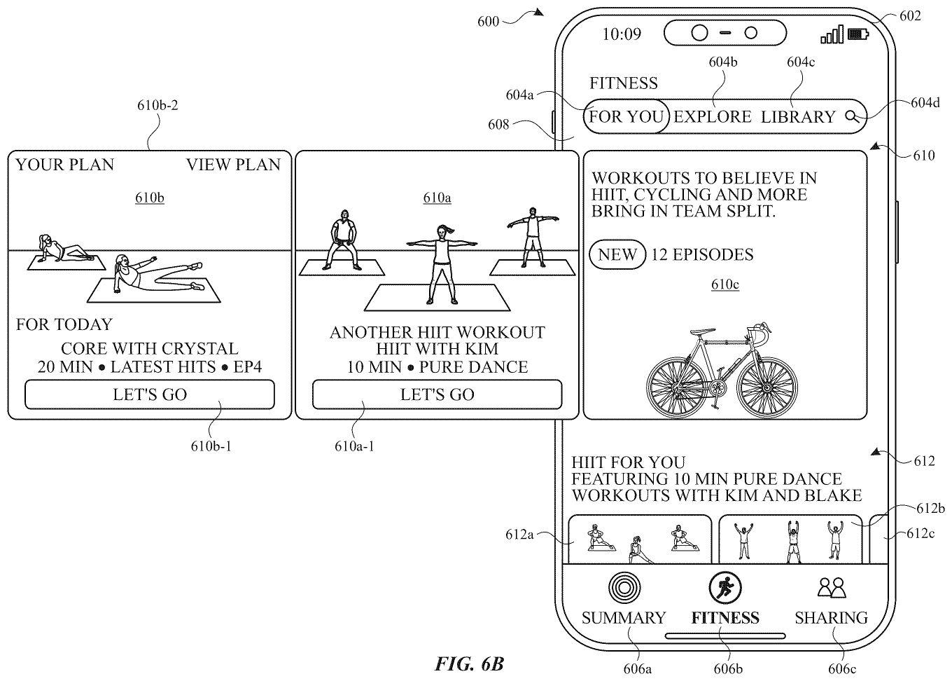

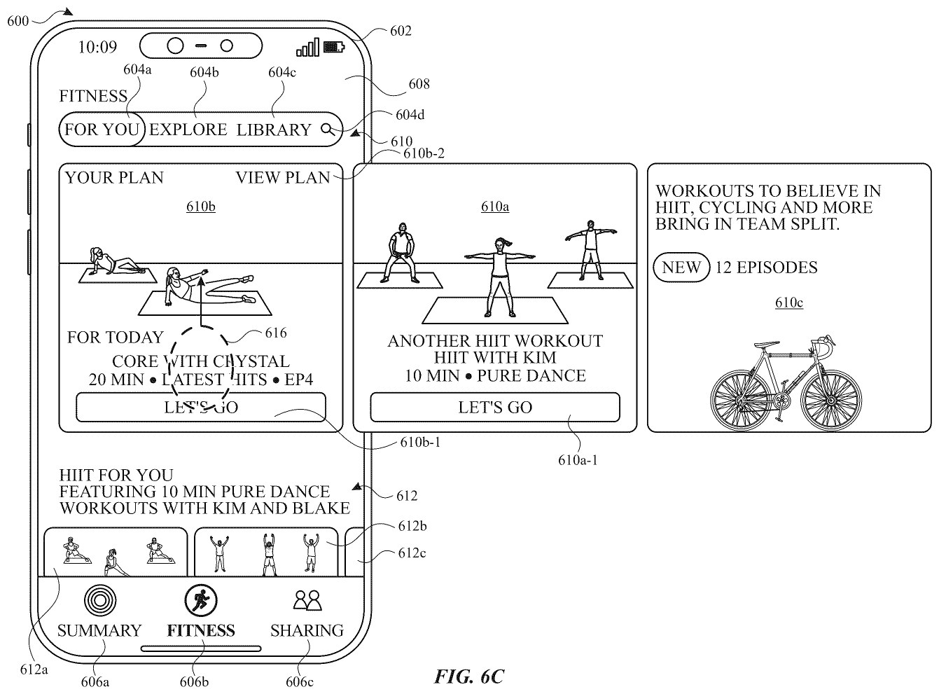

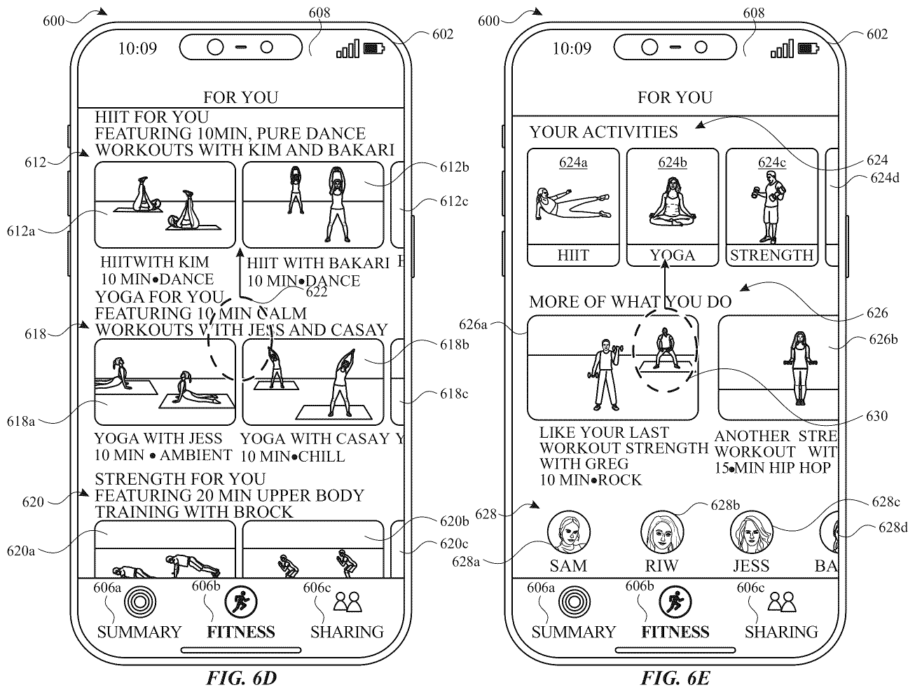

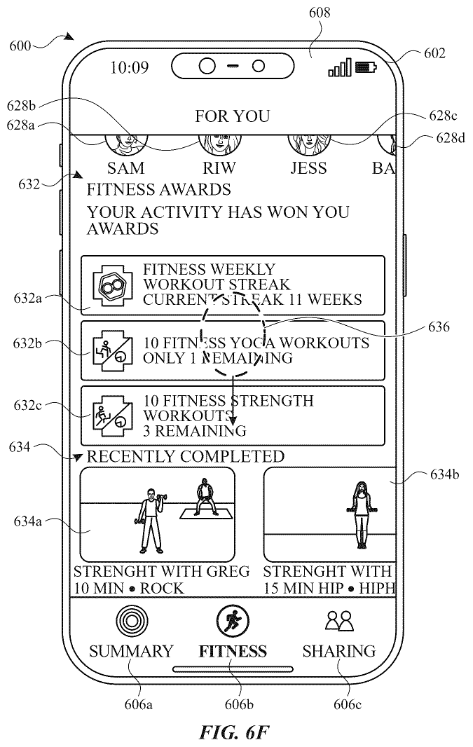

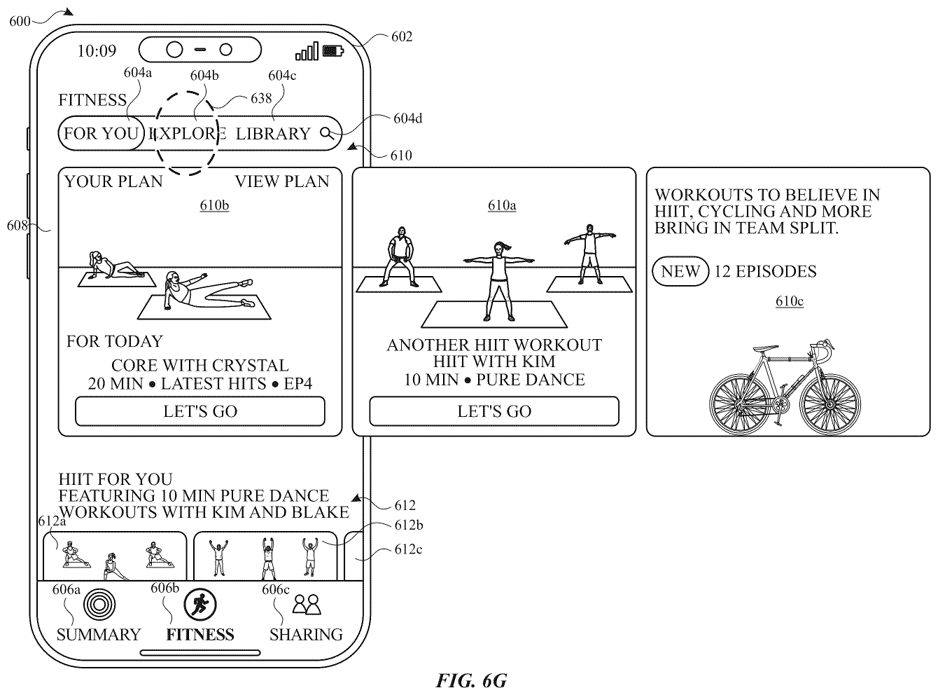

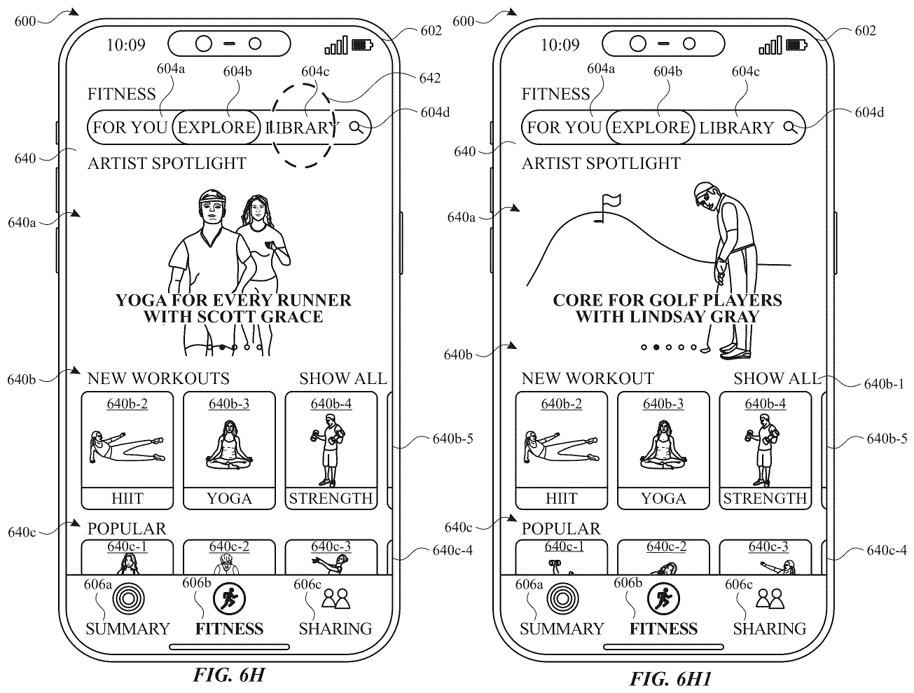

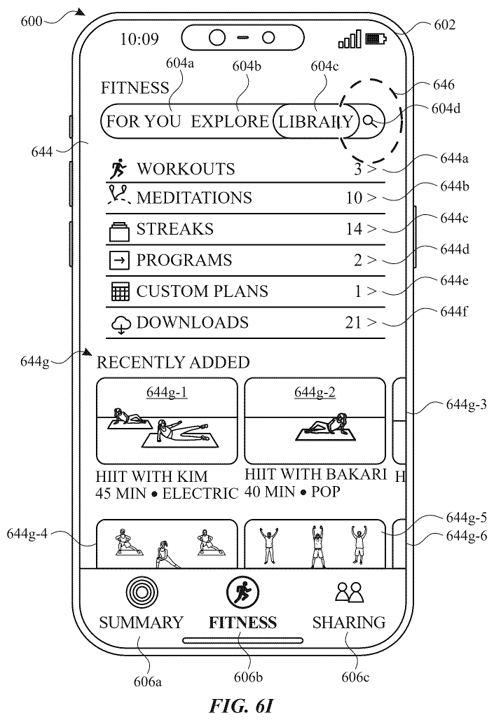

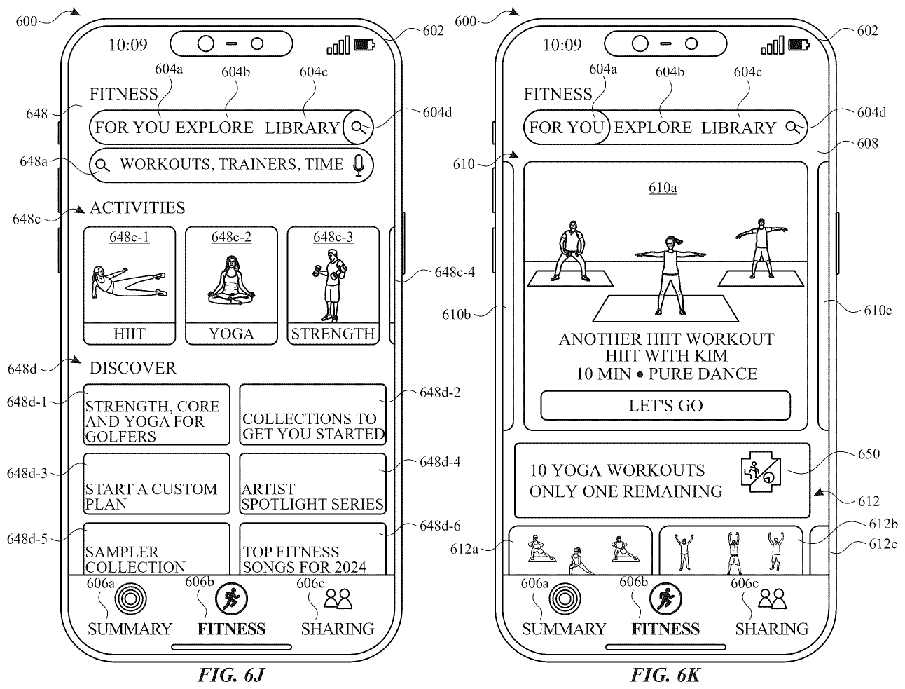

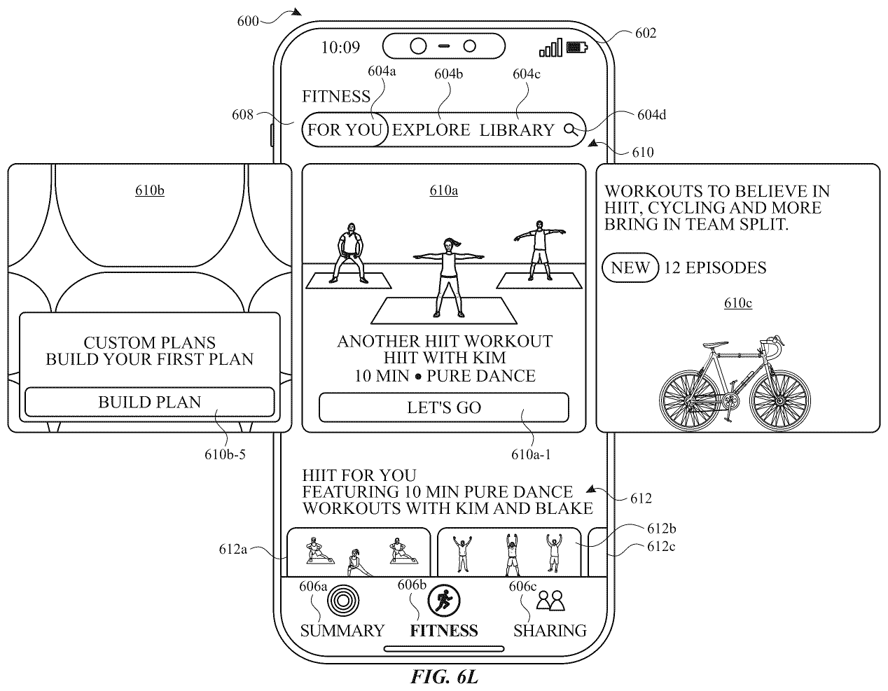

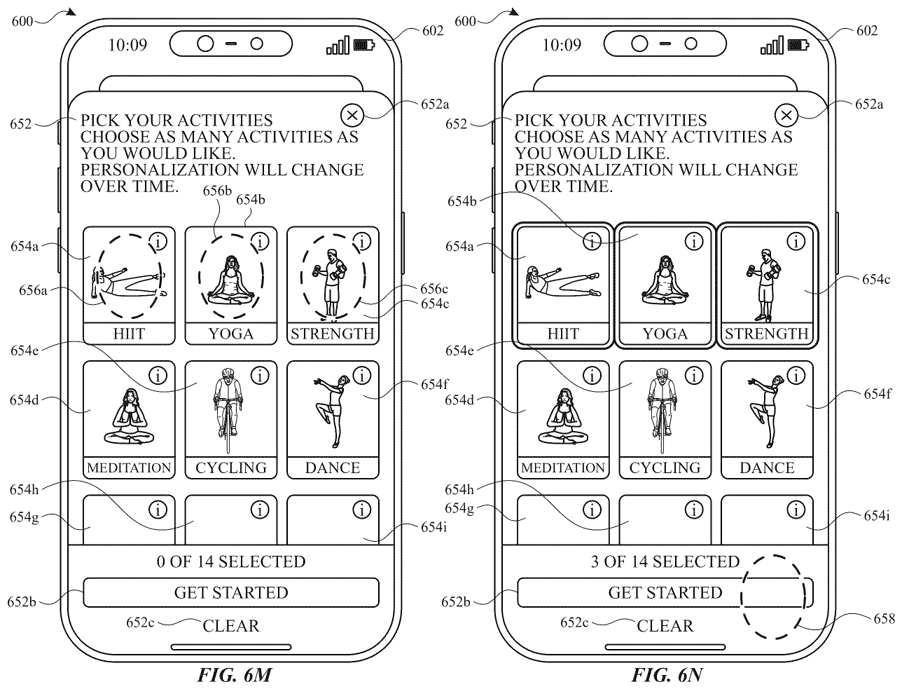

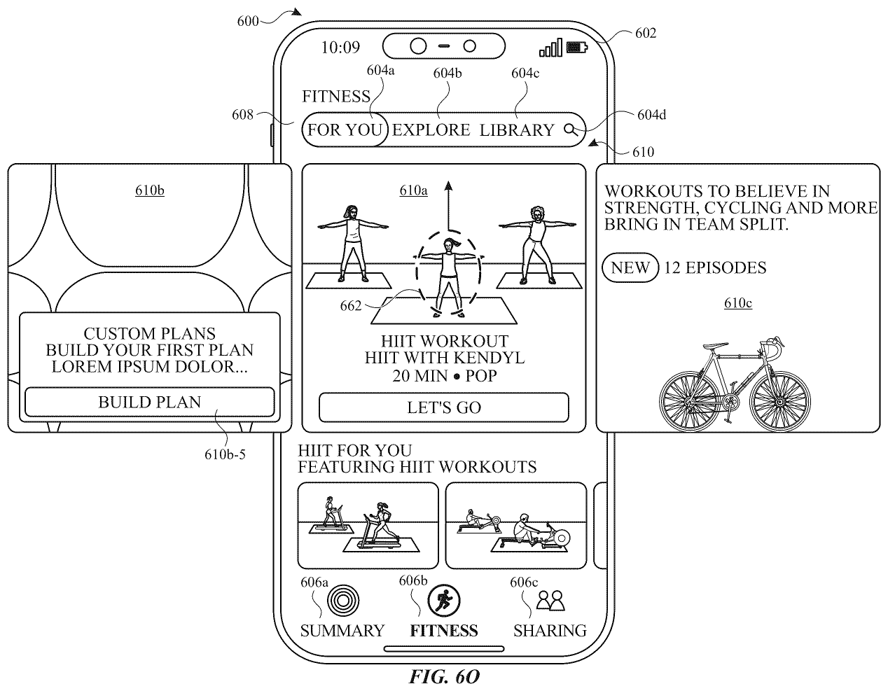

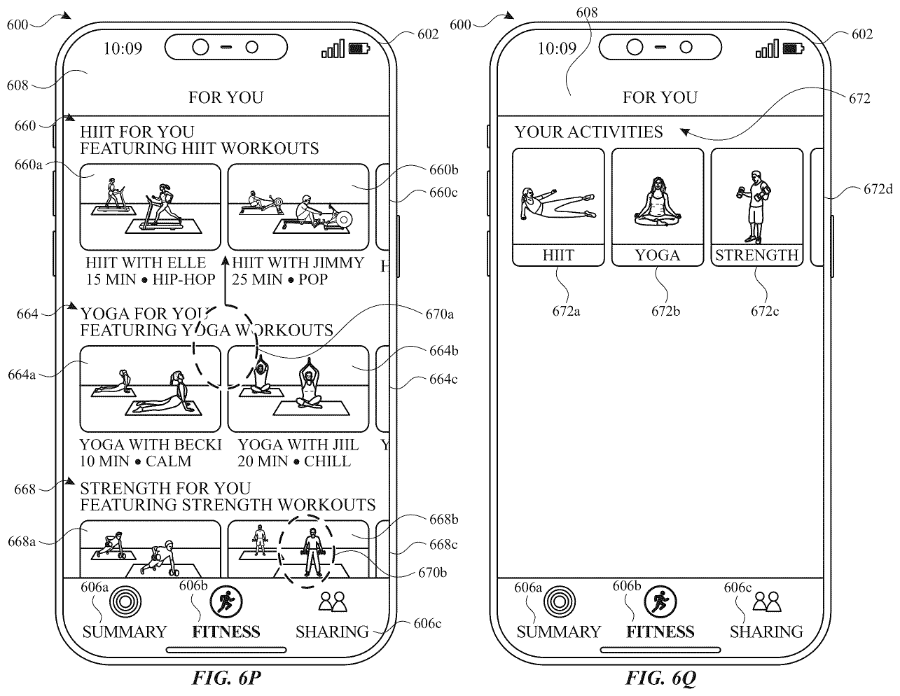

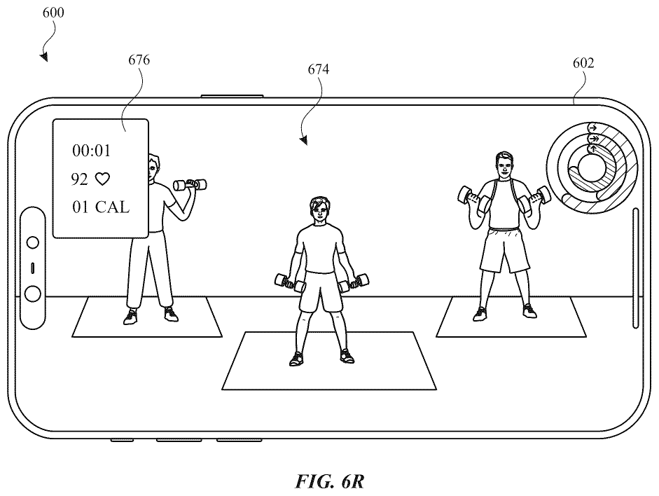

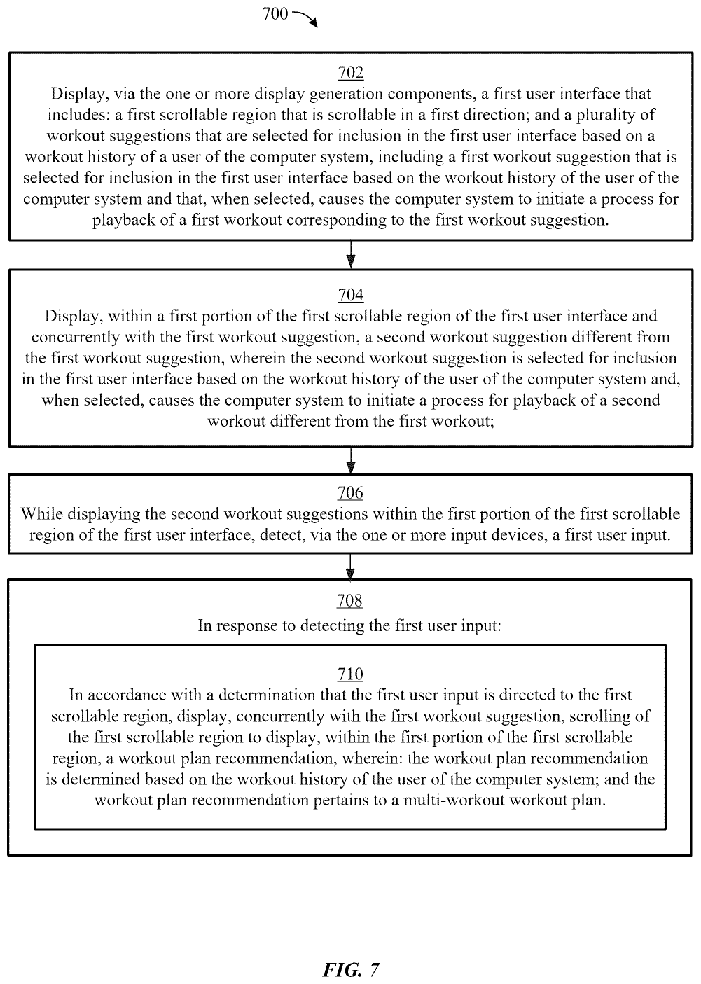

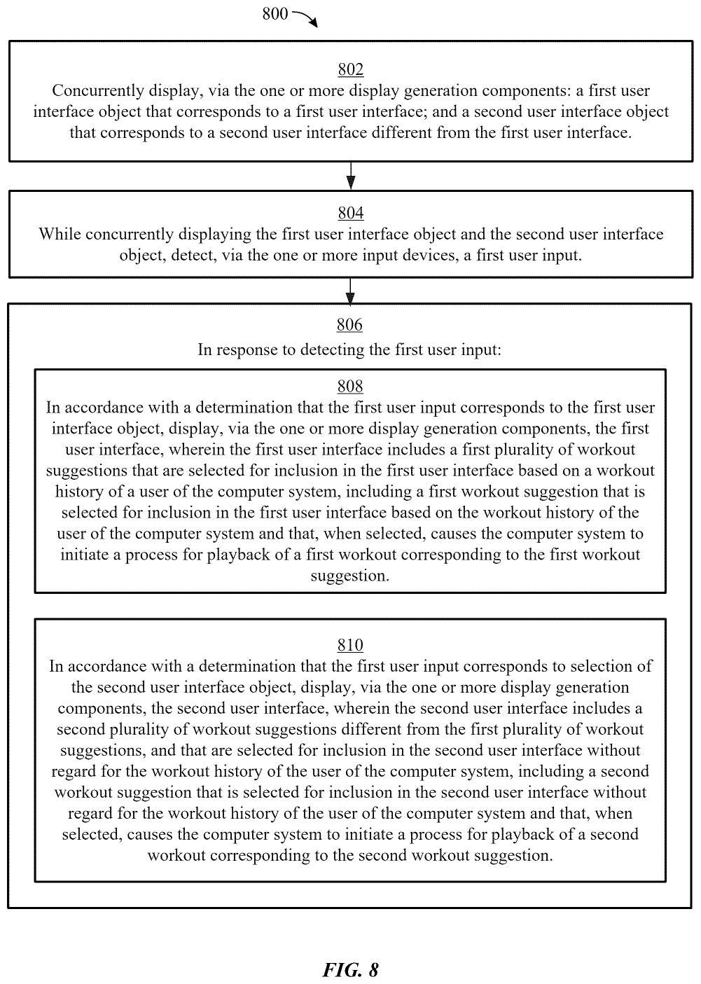

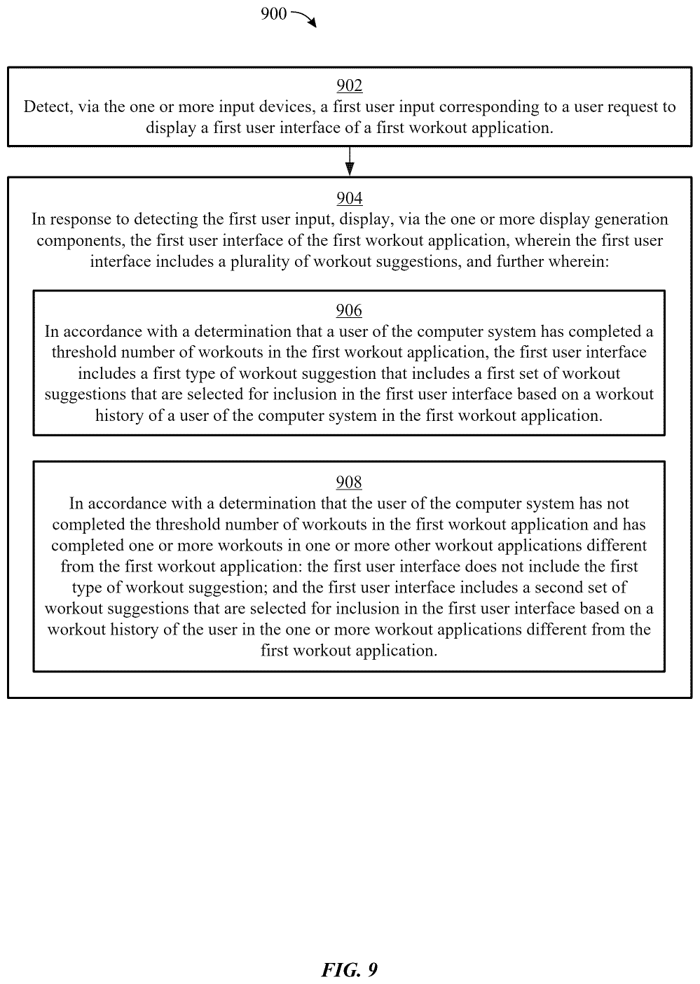

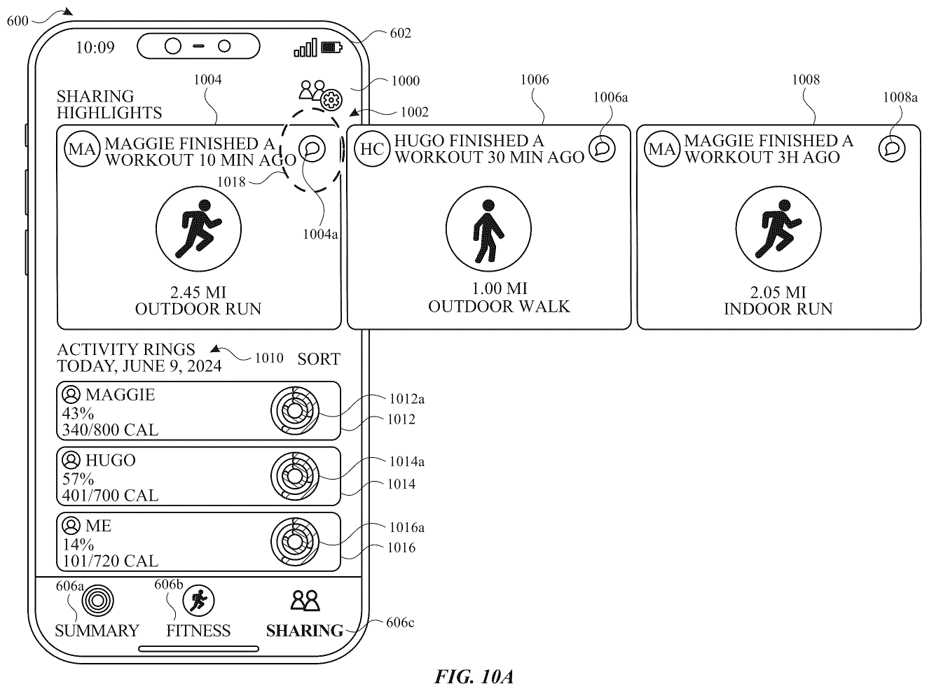

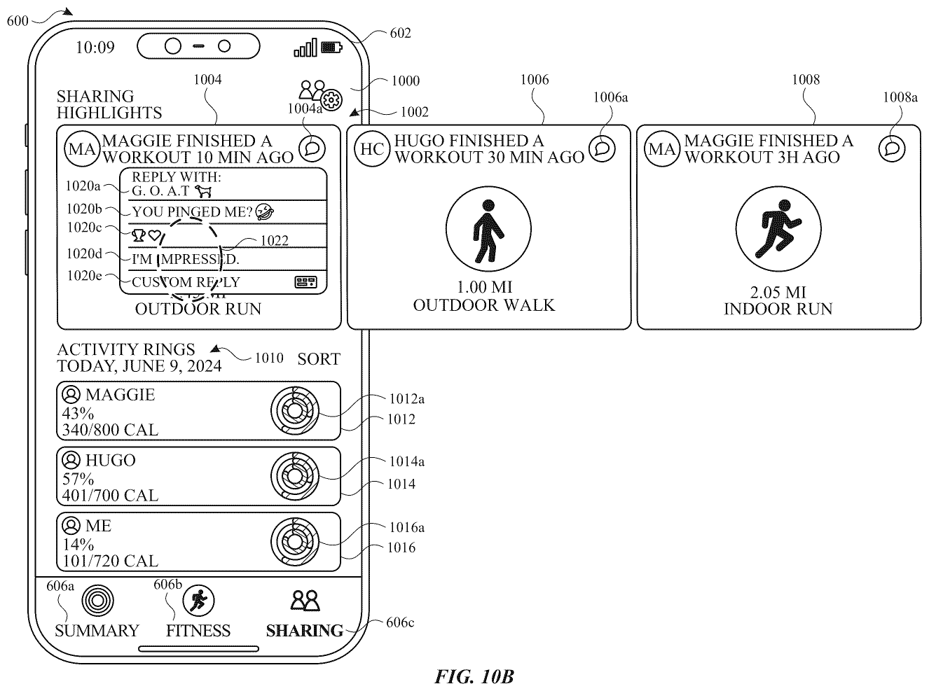

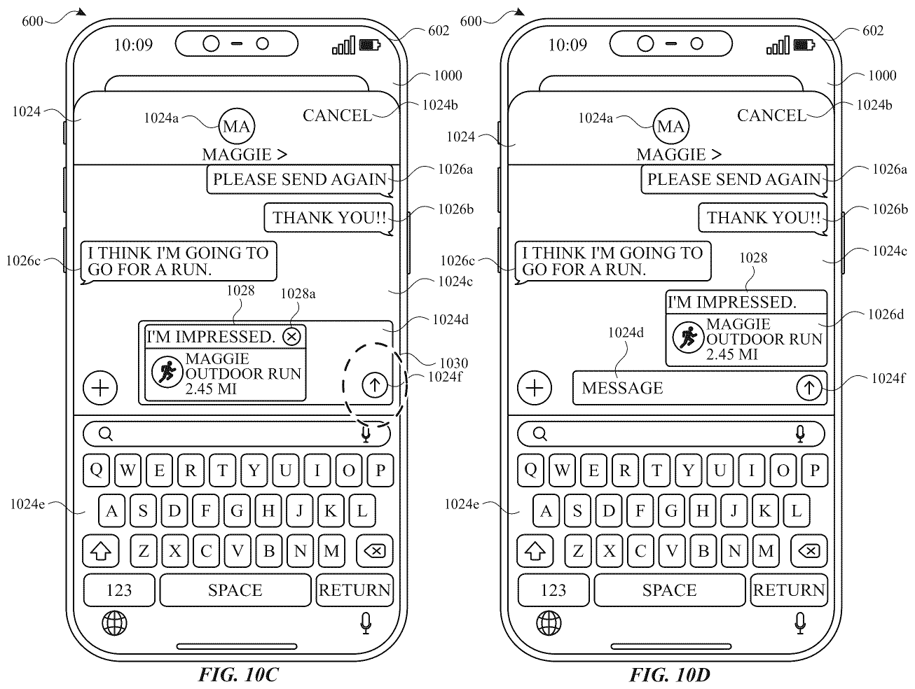

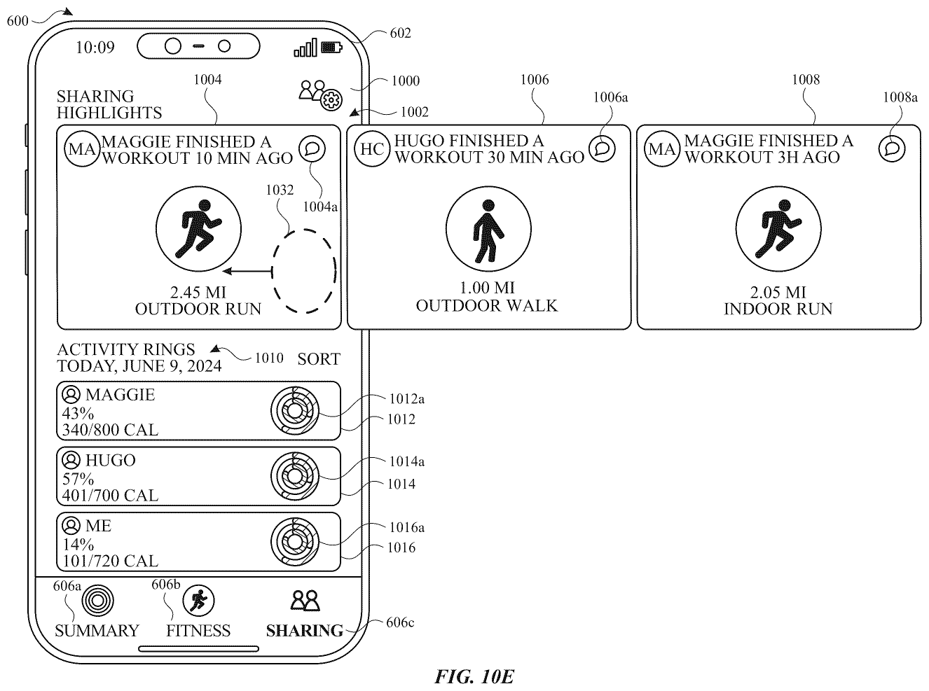

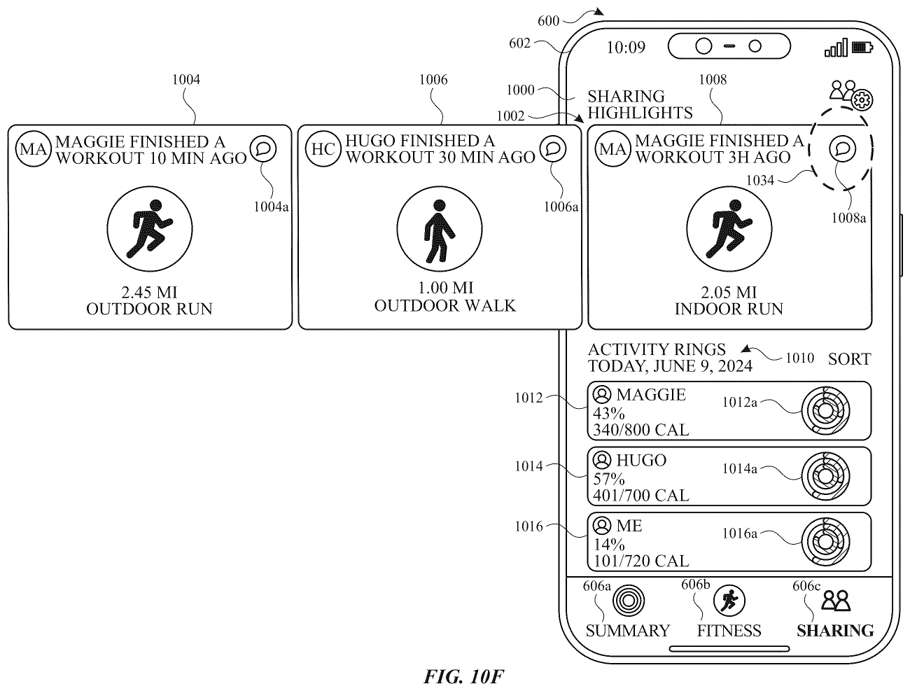

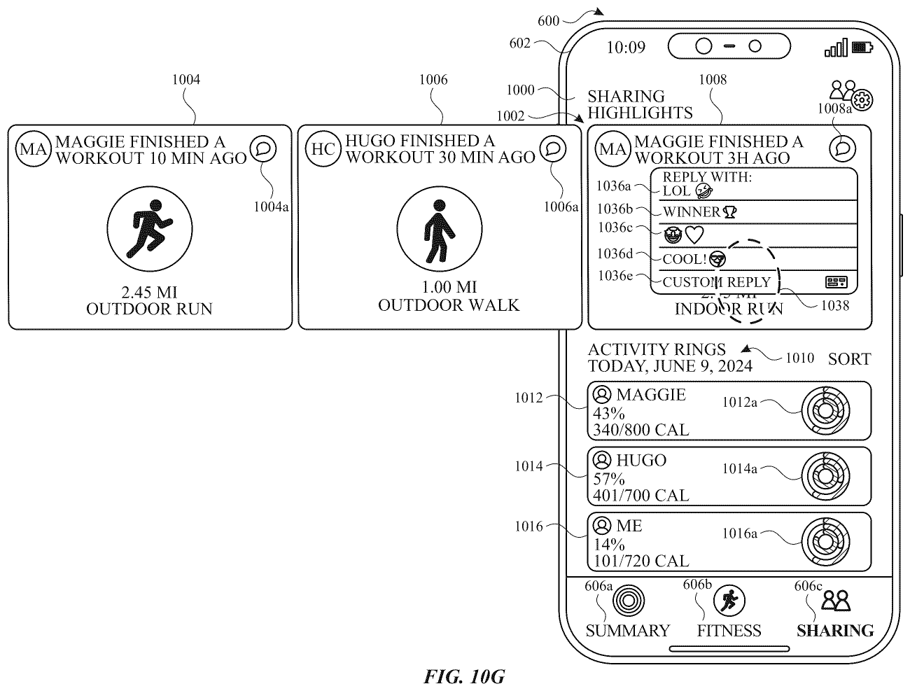

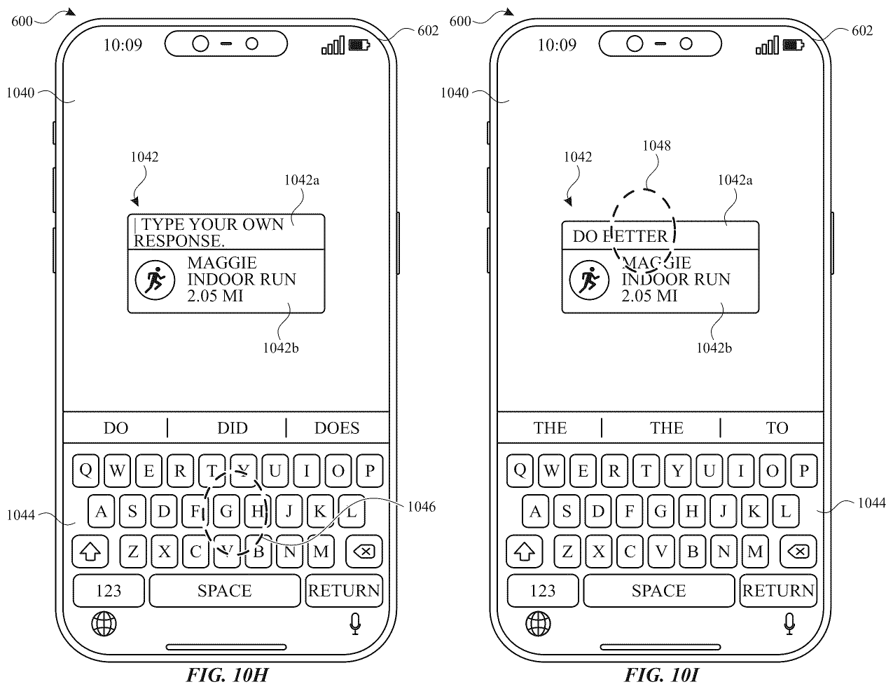

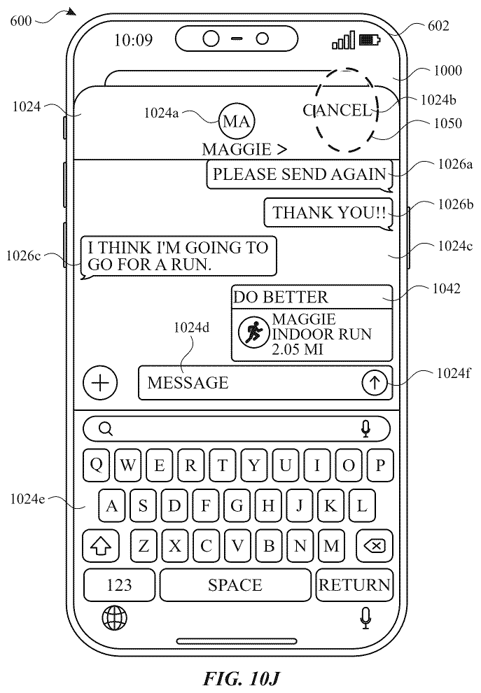

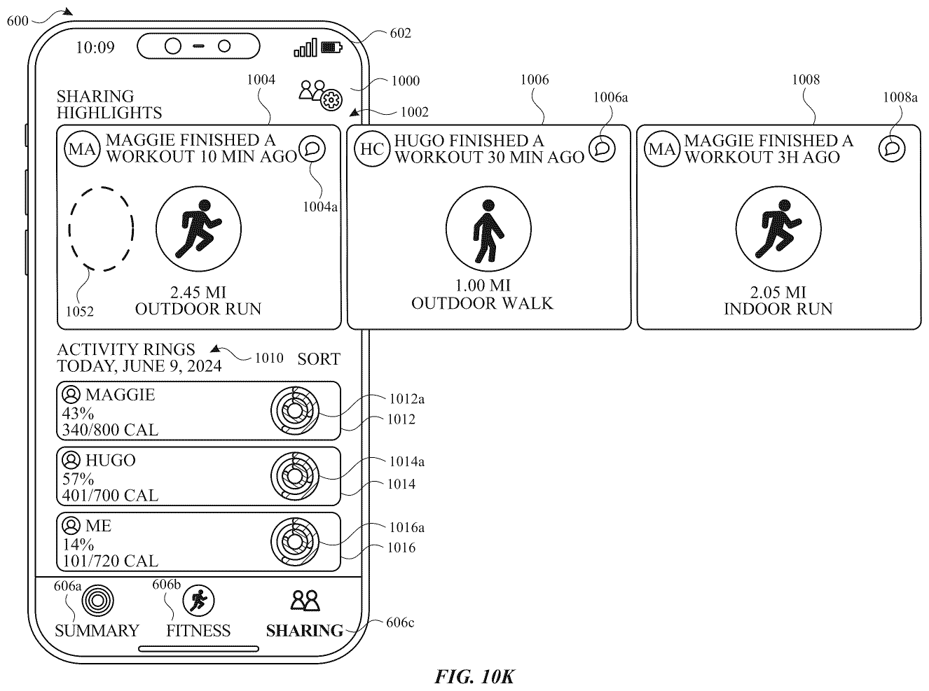

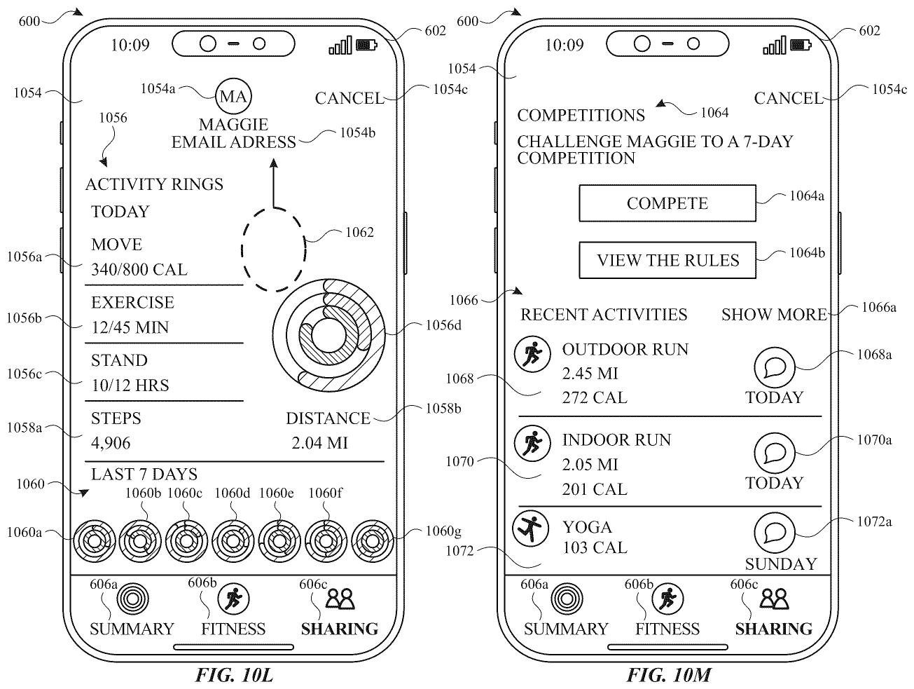

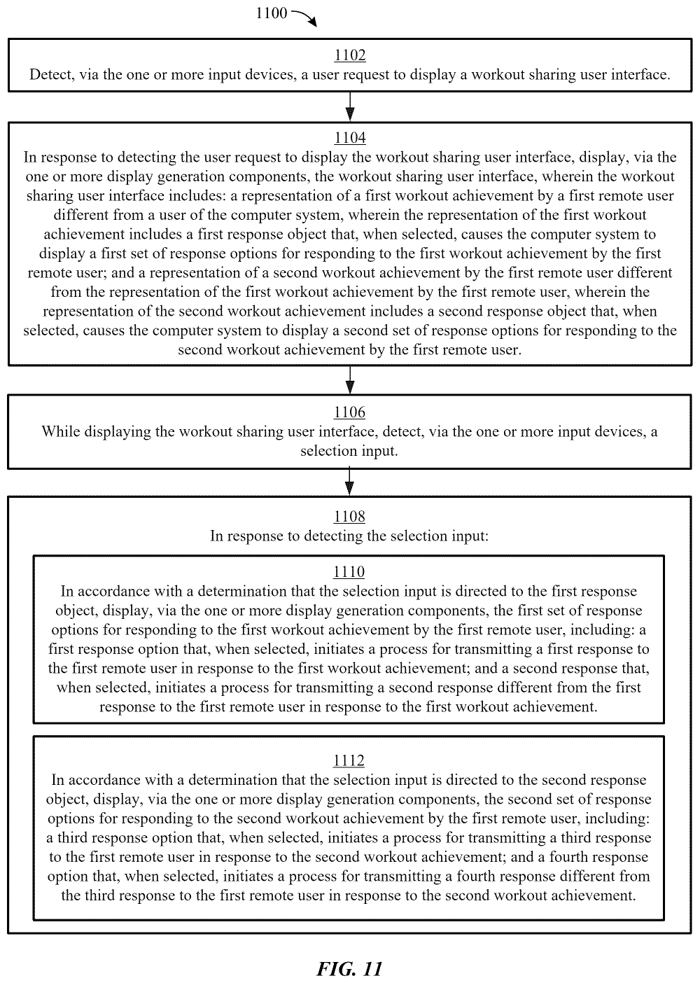

Below, FIGS. 1A-1B, 2, 3A-3G, 4A-4B, and 5A-5B provide a description of exemplary devices for performing the techniques for providing and interacting with workout content. FIGS. 6A-6R illustrate exemplary user interfaces for presenting workout content. FIG. 7 is a flow diagram illustrating methods of presenting workout content in accordance with some embodiments. FIG. 8 is a flow diagram illustrating methods of presenting workout content in accordance with some embodiments. FIG. 9 is a flow diagram illustrating methods of presenting workout content in accordance with some embodiments. The user interfaces in FIGS. 6A-6R are used to illustrate the processes described below, including the processes in FIG. 7, FIG. 8, and FIG. 9. FIGS. 10A-10M illustrate exemplary user interfaces for interacting with workout content. FIG. 11 is a flow diagram illustrating methods of interacting with workout content in accordance with some embodiments. The user interfaces in FIGS. 10A-10M are used to illustrate the processes described below, including the processes in FIG. 11.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, and/or additional techniques. These techniques also reduce power usage and improve battery life of the device by enabling the user to use the device more quickly and efficiently.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

Although the following description uses terms “first,” “second,” etc. to describe various elements, these elements should not be limited by the terms. In some embodiments, these terms are used to distinguish one element from another. For example, a first touch could be termed a second touch, and, similarly, a second touch could be termed a first touch, without departing from the scope of the various described embodiments. In some embodiments, the first touch and the second touch are two separate references to the same touch. In some embodiments, the first touch and the second touch are both touches, but they are not the same touch.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch screen displays and/or touchpads), are, optionally, used. It should also be understood that, in some embodiments, the device is not a portable communications device, but is a desktop computer with a touch-sensitive surface (e.g., a touch screen display and/or a touchpad). In some embodiments, the electronic device is a computer system that is in communication (e.g., via wireless communication, via wired communication) with a display generation component (e.g., a display device such as a head-mounted display (HM D), a display, a projector, a touch-sensitive display, or other device or component that presents visual content to a user, for example on or in the display generation component itself or produced from the display generation component and visible elsewhere). The display generation component is configured to provide visual output, such as display via a CRT display, display via an LED display, or display via image projection. In some embodiments, the display generation component is integrated with the computer system. In some embodiments, the display generation component is separate from the computer system. As used herein, “displaying” content includes causing to display the content (e.g., video data rendered or decoded by display controller 156) by transmitting, via a wired or wireless connection, data (e.g., image data or video data) to an integrated or external display generation component to visually produce the content.

In the discussion that follows, an electronic device that includes a display and a touch-sensitive surface is described. It should be understood, however, that the electronic device optionally includes one or more other physical user-interface devices, such as a physical keyboard, a mouse, and/or a joystick.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

Attention is now directed toward embodiments of portable devices with touch-sensitive displays. FIG. 1A is a block diagram illustrating portable multifunction device 100 with touch-sensitive display system 112 in accordance with some embodiments. Touch-sensitive display 112 is sometimes called a “touch screen” for convenience and is sometimes known as or called a “touch-sensitive display system.” Device 100 includes memory 102 (which optionally includes one or more computer-readable storage mediums), memory controller 122, one or more processing units (CPUs) 120, peripherals interface 118, RF circuitry 108, audio circuitry 110, speaker 111, microphone 113, input/output (I/O) subsystem 106, other input control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure, and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application-specific integrated circuits.

Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs (such as computer programs (e.g., including instructions)) and/or sets of instructions stored in memory 102 to perform various functions for device 100 and to process data. In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VoIP), Wi-MAX, a protocol for e-mail (e.g., Internet message access protocol (IM A P) and/or post office protocol (POP)), instant messaging (e.g., extensible messaging and presence protocol (X M PP), Session Initiation Protocol for Instant Messaging and Presence Leveraging Extensions (SIM PLE), Instant Messaging and Presence Service (IM PS)), and/or Short Message Service (SM S), or any other suitable communication protocol, including communication protocols not yet developed as of the filing date of this document.

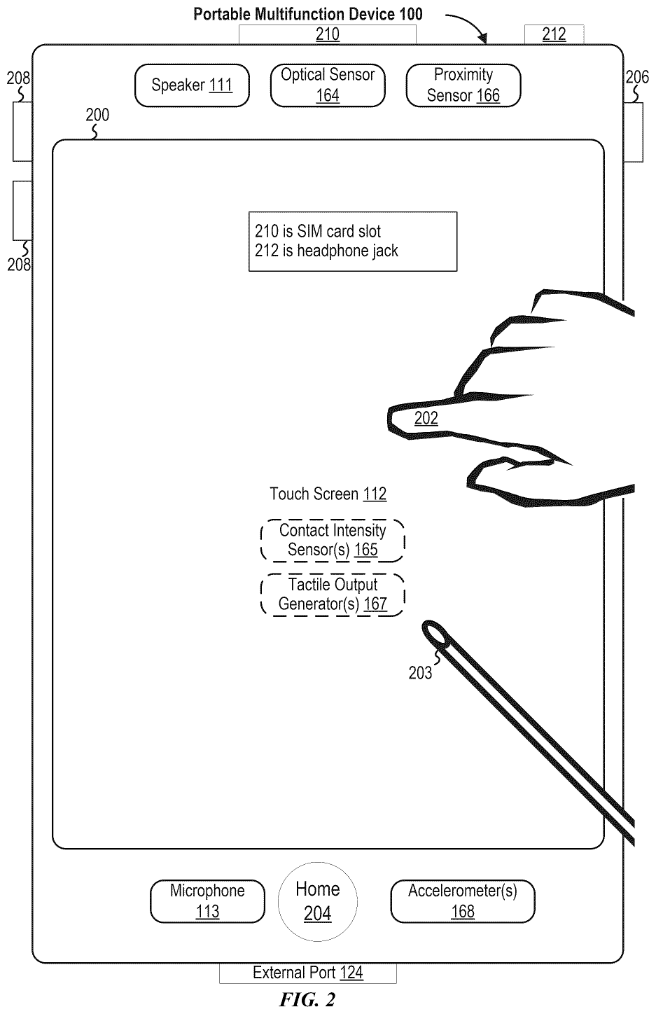

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, depth camera controller 169, intensity sensor controller 159, haptic feedback controller 161, and one or more input controllers 160 for other input or control devices. The one or more input controllers 160 receive/send electrical signals from/to other input control devices 116. The other input control devices 116 optionally include physical buttons (e.g., push buttons, rocker buttons, etc.), dials, slider switches, joysticks, click wheels, and so forth. In some embodiments, input controller(s) 160 are, optionally, coupled to any (or none) of the following: a keyboard, an infrared port, a USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2). In some embodiments, the electronic device is a computer system that is in communication (e.g., via wireless communication, via wired communication) with one or more input devices. In some embodiments, the one or more input devices include a touch-sensitive surface (e.g., a trackpad, as part of a touch-sensitive display). In some embodiments, the one or more input devices include one or more camera sensors (e.g., one or more optical sensors 164 and/or one or more depth camera sensors 175), such as for tracking a user's gestures (e.g., hand gestures and/or air gestures) as input. In some embodiments, the one or more input devices are integrated with the computer system. In some embodiments, the one or more input devices are separate from the computer system. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

A quick press of the push button optionally disengages a lock of touch screen 112 or optionally begins a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch screen 112 is used to implement virtual or soft buttons and one or more soft keyboards.

Touch-sensitive display 112 provides an input interface and an output interface between the device and a user. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output optionally corresponds to user-interface objects.

Touch screen 112 has a touch-sensitive surface, sensor, or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages, or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone® and iPod Touch® from Apple Inc. of Cupertino, California.

A touch-sensitive display in some embodiments of touch screen 112 is, optionally, analogous to the multi-touch sensitive touchpads described in the following U.S. Pat. No. 6,323,846 (Westerman et al.), U.S. Pat. No. 6,570,557 (Westerman et al.), and/or U.S. Pat. No. 6,677,932 (W esterman), and/or U.S. Patent Publication 2002/0015024A 1, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes secure element 163 for securely storing information. In some embodiments, secure element 163 is a hardware component (e.g., a secure microcontroller chip) configured to securely store data or an algorithm. In some embodiments, secure element 163 provides (e.g., releases) secure information (e.g., payment information (e.g., an account number and/or a transaction-specific dynamic security code), identification information (e.g., credentials of a state-approved digital identification), and/or authentication information (e.g., data generated using a cryptography engine and/or by performing asymmetric cryptography operations)). In some embodiments, secure element 163 provides (or releases) the secure information in response to device 100 receiving authorization, such as a user authentication (e.g., fingerprint authentication; passcode authentication; detecting double-press of a hardware button when device 100 is in an unlocked state, and optionally, while device 100 has been continuously on a user's wrist since device 100 was unlocked by providing authentication credentials to device 100, where the continuous presence of device 100 on the user's wrist is determined by periodically checking that the device is in contact with the user's skin). For example, device 100 detects a fingerprint at a fingerprint sensor (e.g., a fingerprint sensor integrated into a button) of device 100. Device 100 determines whether the detected fingerprint is consistent with an enrolled fingerprint. In accordance with a determination that the fingerprint is consistent with the enrolled fingerprint, secure element 163 provides (e.g., releases) the secure information. In accordance with a determination that the fingerprint is not consistent with the enrolled fingerprint, secure element 163 forgoes providing (e.g., releasing) the secure information.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CM OS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more depth camera sensors 175. FIG. 1A shows a depth camera sensor coupled to depth camera controller 169 in I/O subsystem 106. Depth camera sensor 175 receives data from the environment to create a three dimensional model of an object (e.g., a face) within a scene from a viewpoint (e.g., a depth camera sensor). In some embodiments, in conjunction with imaging module 143 (also called a camera module), depth camera sensor 175 is optionally used to determine a depth map of different portions of an image captured by the imaging module 143. In some embodiments, a depth camera sensor is located on the front of device 100 so that the user's image with depth information is, optionally, obtained for video conferencing while the user views the other video conference participants on the touch screen display and to capture selfies with depth map data. In some embodiments, the depth camera sensor 175 is located on the back of device, or on the back and the front of the device 100. In some embodiments, the position of depth camera sensor 175 can be changed by the user (e.g., by rotating the lens and the sensor in the device housing) so that a depth camera sensor 175 is used along with the touch screen display for both video conferencing and still and/or video image acquisition.

In some embodiments, a depth map (e.g., depth map image) contains information (e.g., values) that relates to the distance of objects in a scene from a viewpoint (e.g., a camera, an optical sensor, a depth camera sensor). In one embodiment of a depth map, each depth pixel defines the position in the viewpoint's Z-axis where its corresponding two-dimensional pixel is located. In some embodiments, a depth map is composed of pixels wherein each pixel is defined by a value (e.g., 0-255). For example, the “0” value represents pixels that are located at the most distant place in a “three dimensional” scene and the “255” value represents pixels that are located closest to a viewpoint (e.g., a camera, an optical sensor, a depth camera sensor) in the “three dimensional” scene. In other embodiments, a depth map represents the distance between an object in a scene and the plane of the viewpoint. In some embodiments, the depth map includes information about the relative depth of various features of an object of interest in view of the depth camera (e.g., the relative depth of eyes, nose, mouth, ears of a user's face). In some embodiments, the depth map includes information that enables the device to determine contours of the object of interest in a z direction.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112, which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112, which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer and a GPS (or GLONASS or other global navigation system) receiver for obtaining information concerning the location and orientation (e.g., portrait or landscape) of device 100.

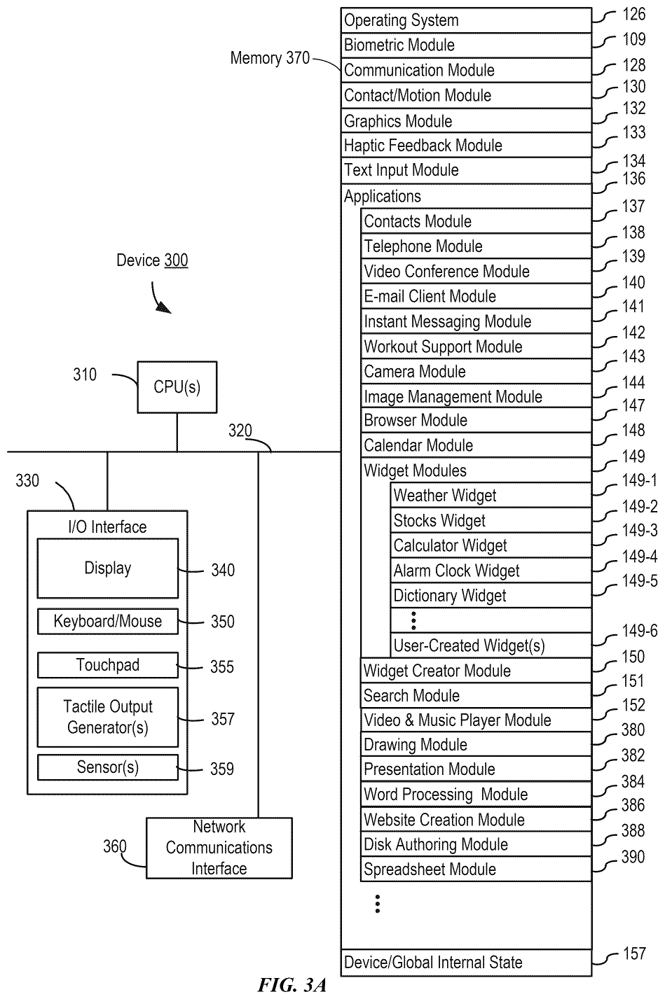

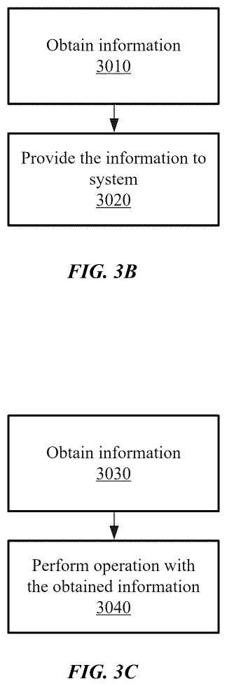

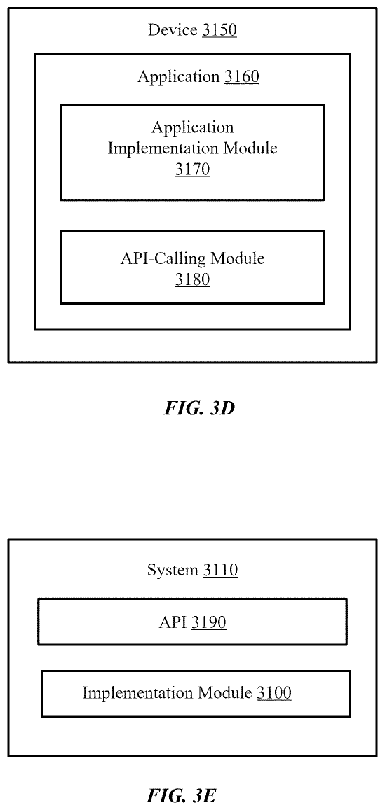

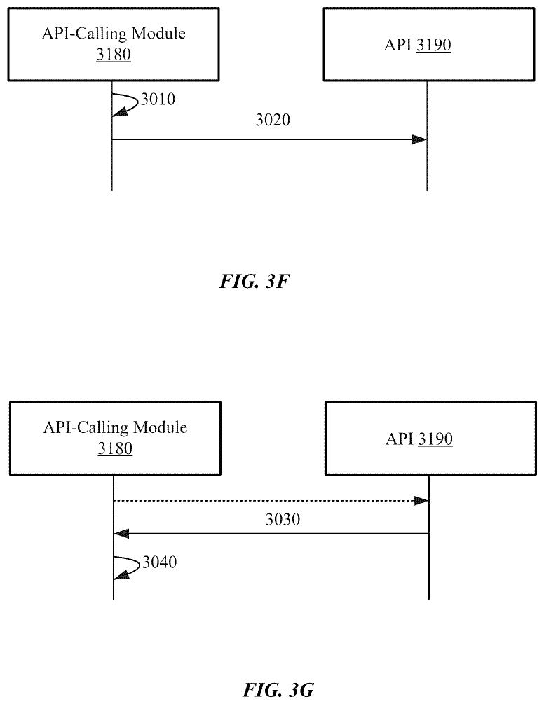

In some embodiments, the software components stored in memory 102 include operating system 126, biometric module 109, communication module (or set of instructions) 128, contact/motion module (or set of instructions) 130, graphics module (or set of instructions) 132, text input module (or set of instructions) 134, Global Positioning System (GPS) module (or set of instructions) 135, authentication module 105, and applications (or sets of instructions) 136. Furthermore, in some embodiments, memory 102 (FIG. 1A) or 370 (FIG. 3A) stores device/global internal state 157, as shown in FIGS. 1A and 3A. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, IOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE®, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with, the 30-pin connector used on iPod® (trademark of Apple Inc.) devices.

Biometric module 109 optionally stores information about one or more enrolled biometric features (e.g., fingerprint feature information, facial recognition feature information, eye and/or iris feature information) for use to verify whether received biometric information matches the enrolled biometric features. In some embodiments, the information stored about the one or more enrolled biometric features includes data that enables the comparison between the stored information and received biometric information without including enough information to reproduce the enrolled biometric features. In some embodiments, biometric module 109 stores the information about the enrolled biometric features in association with a user account of device 100. In some embodiments, biometric module 109 compares the received biometric information to an enrolled biometric feature to determine whether the received biometric information matches the enrolled biometric feature.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments, at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations, a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast, or other visual property) of graphics that are displayed. As used herein, the term “graphics” includes any object that can be displayed to a user, including, without limitation, text, web pages, icons (such as user-interface objects including soft keys), digital images, videos, animations, and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts module 137, e-mail client module 140, IM module 141, browser module 147, and any other application that needs text input).

GPS module 135 determines the location of the device and provides this information for use in various applications (e.g., to telephone module 138 for use in location-based dialing; to camera module 143 as picture/video metadata; and to applications that provide location-based services such as weather widgets, local yellow page widgets, and map/navigation widgets).

Authentication module 105 determines whether a requested operation (e.g., requested by an application of applications 136) is authorized to be performed. In some embodiments, authentication module 105 receives for an operation to be perform that optionally requires authentication. Authentication module 105 determines whether the operation is authorized to be performed, such as based on a series of factors, including the lock status of device 100, the location of device 100, whether a security delay has elapsed, whether received biometric information matches enrolled biometric features, and/or other factors. Once authentication module 105 determines that the operation is authorized to be performed, authentication module 105 triggers performance of the operation.

Applications 136 optionally include the following modules (or sets of instructions), or a subset or superset thereof:
Contacts module 137 (sometimes called an address book or contact list);
Telephone module 138;
Video conference module 139;
E-mail client module 140;
Instant messaging (IM) module 141;
Workout support module 142;
Camera module 143 for still and/or video images;
Image management module 144;
Video player module;
Music player module;
Browser module 147;
Calendar module 148;
Widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
Widget creator module 150 for making user-created widgets 149-6;
Search module 151;
Video and music player module 152, which merges video player module and music player module;
Notes module 153;
Map module 154; and/or
Online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone module 138, video conference module 139, e-mail client module 140, or IM module 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SM S) or Multimedia Message Service (M M S) protocol for telephony-based instant messages or using XM PP, SIMPLE, or IM PS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SM S or M M S) and Internet-based messages (e.g., messages sent using X M PP, SIM PLE, or IM PS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to-do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript® file. In some embodiments, a widget includes an XML (Extensible Markup Language) file and a JavaScript® file (e.g., Yahoo!® Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs (such as computer programs (e.g., including instructions)), procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3A) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (e.g., 187-1 and/or 187-2) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definitions 186 include a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen 112 in accordance with some embodiments. The touch screen optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward), and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also include one or more physical buttons, such as “home” or menu button 204. As described previously, menu button 204 is, optionally, used to navigate to any application 136 in a set of applications that are, optionally, executed on device 100. Alternatively, in some embodiments, the menu button is implemented as a soft key in a GUI displayed on touch screen 112.

In some embodiments, device 100 includes touch screen 112, menu button 204, push button 206 for powering the device on/off and locking the device, volume adjustment button(s) 208, subscriber identity module (SIM) card slot 210, headset jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3A is a block diagram of an exemplary multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPUs) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM, or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above-identified elements in FIG. 3A is, optionally, stored in one or more of the previously mentioned memory devices. Each of the above-identified modules corresponds to a set of instructions for performing a function described above. The above-identified modules or computer programs (e.g., sets of instructions or including instructions) need not be implemented as separate software programs (such as computer programs (e.g., including instructions)), procedures, or modules, and thus various subsets of these modules are, optionally, combined or otherwise rearranged in various embodiments. In some embodiments, memory 370 optionally stores a subset of the modules and data structures identified above. Furthermore, memory 370 optionally stores additional modules and data structures not described above.

Implementations within the scope of the present disclosure can be partially or entirely realized using a tangible computer-readable storage medium (or multiple tangible computer-readable storage media of one or more types) encoding one or more computer-readable instructions. It should be recognized that computer-readable instructions can be organized in any format, including applications, widgets, processes, software, and/or components.

Implementations within the scope of the present disclosure include a computer-readable storage medium that encodes instructions organized as an application (e.g., application 3160) that, when executed by one or more processing units, control an electronic device (e.g., device 3150) to perform the method of FIG. 3B, the method of FIG. 3C, and/or one or more other processes and/or methods described herein.

It should be recognized that application 3160 (shown in FIG. 3D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 3160 is an application that is pre-installed on device 3150 at purchase (e.g., a first-party application). In some embodiments, application 3160 is an application that is provided to device 3150 via an operating system update file (e.g., a first-party application or a second-party application). In some embodiments, application 3160 is an application that is provided via an application store. In some embodiments, the application store can be an application store that is pre-installed on device 3150 at purchase (e.g., a first-party application store). In some embodiments, the application store is a third-party application store (e.g., an application store that is provided by another application store, downloaded via a network, and/or read from a storage device).

Referring to FIG. 3B and FIG. 3F, application 3160 obtains information (e.g., 3010). In some embodiments, at 3010, information is obtained from at least one hardware component of device 3150. In some embodiments, at 3010, information is obtained from at least one software module of device 3150. In some embodiments, at 3010, information is obtained from at least one hardware component external to device 3150 (e.g., a peripheral device, an accessory device, and/or a server). In some embodiments, the information obtained at 3010 includes positional information, time information, notification information, user information, environment information, electronic device state information, weather information, media information, historical information, event information, hardware information, and/or motion information. In some embodiments, in response to and/or after obtaining the information at 3010, application 3160 provides the information to a system (e.g., 3020).

In some embodiments, the system (e.g., 3110 shown in FIG. 3E) is an operating system hosted on device 3150. In some embodiments, the system (e.g., 3110 shown in FIG. 3E) is an external device (e.g., a server, a peripheral device, an accessory, and/or a personal computing device) that includes an operating system.

Referring to FIG. 3C and FIG. 3G, application 3160 obtains information (e.g., 3030). In some embodiments, the information obtained at 3030 includes positional information, time information, notification information, user information, environment information electronic device state information, weather information, media information, historical information, event information, hardware information, and/or motion information. In response to and/or after obtaining the information at 3030, application 3160 performs an operation with the information (e.g., 3040). In some embodiments, the operation performed at 3040 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 3110 based on the information.

In some embodiments, one or more steps of the method of FIG. 3B and/or the method of FIG. 3C is performed in response to a trigger. In some embodiments, the trigger includes detection of an event, a notification received from system 3110, a user input, and/or a response to a call to an A PI provided by system 3110.

In some embodiments, the instructions of application 3160, when executed, control device 3150 to perform the method of FIG. 3B and/or the method of FIG. 3C by calling an application programming interface (A PI) (e.g., A PI 3190) provided by system 3110. In some embodiments, application 3160 performs at least a portion of the method of FIG. 3B and/or the method of FIG. 3C without calling API 3190.

In some embodiments, one or more steps of the method of FIG. 3B and/or the method of FIG. 3C includes calling an API (e.g., API 3190) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 3D, device 3150 is illustrated. In some embodiments, device 3150 is a personal computing device, a smart phone, a smart watch, a fitness tracker, a head mounted display (HM D) device, a media device, a communal device, a speaker, a television, and/or a tablet. As illustrated in FIG. 3D, device 3150 includes application 3160 and an operating system (e.g., system 3110 shown in FIG. 3E). Application 3160 includes application implementation module 3170 and A PI-calling module 3180. System 3110 includes A PI 3190 and implementation module 3100. It should be recognized that device 3150, application 3160, and/or system 3110 can include more, fewer, and/or different components than illustrated in FIGS. 3D and 3E.

In some embodiments, application implementation module 3170 includes a set of one or more instructions corresponding to one or more operations performed by application 3160. For example, when application 3160 is a messaging application, application implementation module 3170 can include operations to receive and send messages. In some embodiments, application implementation module 3170 communicates with A PI-calling module 3180 to communicate with system 3110 via API 3190 (shown in FIG. 3E).

In some embodiments, A PI 3190 is a software module (e.g., a collection of computer-readable instructions) that provides an interface that allows a different module (e.g., A PI-calling module 3180) to access and/or use one or more functions, methods, procedures, data structures, classes, and/or other services provided by implementation module 3100 of system 3110. For example, A PI-calling module 3180 can access a feature of implementation module 3100 through one or more API calls or invocations (e.g., embodied by a function or a method call) exposed by API 3190 (e.g., a software and/or hardware module that can receive A PI calls, respond to A PI calls, and/or send A PI calls) and can pass data and/or control information using one or more parameters via the API calls or invocations. In some embodiments, A PI 3190 allows application 3160 to use a service provided by a Software Development Kit (SDK) library. In some embodiments, application 3160 incorporates a call to a function or method provided by the SDK library and provided by A PI 3190 or uses data types or objects defined in the SDK library and provided by A PI 3190. In some embodiments, A PI-calling module 3180 makes an API call via A PI 3190 to access and use a feature of implementation module 3100 that is specified by A PI 3190. In such embodiments, implementation module 3100 can return a value via API 3190 to A PI-calling module 3180 in response to the API call. The value can report to application 3160 the capabilities or state of a hardware component of device 3150, including those related to aspects such as input capabilities and state, output capabilities and state, processing capability, power state, storage capacity and state, and/or communications capability. In some embodiments, A PI 3190 is implemented in part by firmware, microcode, or other low level logic that executes in part on the hardware component.

In some embodiments, A PI 3190 allows a developer of A PI-calling module 3180 (which can be a third-party developer) to leverage a feature provided by implementation module 3100. In such embodiments, there can be one or more A PI-calling modules (e.g., including API-calling module 3180) that communicate with implementation module 3100. In some embodiments, A PI 3190 allows multiple A PI-calling modules written in different programming languages to communicate with implementation module 3100 (e.g., API 3190 can include features for translating calls and returns between implementation module 3100 and A PI-calling module 3180) while API 3190 is implemented in terms of a specific programming language. In some embodiments, A PI-calling module 3180 calls A Pls from different providers such as a set of A Pls from an OS provider, another set of A Pls from a plug-in provider, and/or another set of A Pls from another provider (e.g., the provider of a software library) or creator of the another set of A PIs.

Examples of A PI 3190 can include one or more of: a pairing API (e.g., for establishing secure connection, e.g., with an accessory), a device detection API (e.g., for locating nearby devices, e.g., media devices and/or smartphone), a payment API, a UIK it A PI (e.g., for generating user interfaces), a location detection A PI, a locator A PI, a maps API, a health sensor A PI, a sensor A PI, a messaging A PI, a push notification A PI, a streaming A PI, a collaboration A PI, a video conferencing A PI, an application store A PI, an advertising services A PI, a web browser A PI (e.g., WebKit API), a vehicle A PI, a networking API, a WiFi API, a Bluetooth A PI, an NFC API, a UWB API, a fitness A PI, a smart home A PI, contact transfer A PI, photos API, camera A PI, and/or image processing A PI. In some embodiments, the sensor A PI is an API for accessing data associated with a sensor of device 3150. For example, the sensor A PI can provide access to raw sensor data. For another example, the sensor A PI can provide data derived (and/or generated) from the raw sensor data. In some embodiments, the sensor data includes temperature data, image data, video data, audio data, heart rate data, IM U (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor, and/or biometric sensor.

In some embodiments, implementation module 3100 is a system (e.g., operating system and/or server system) software module (e.g., a collection of computer-readable instructions) that is constructed to perform an operation in response to receiving an API call via API 3190. In some embodiments, implementation module 3100 is constructed to provide an A PI response (via A PI 3190) as a result of processing an A PI call. By way of example, implementation module 3100 and A PI-calling module 3180 can each be any one of an operating system, a library, a device driver, an API, an application program, or other module. It should be understood that implementation module 3100 and A PI-calling module 3180 can be the same or different type of module from each other. In some embodiments, implementation module 3100 is embodied at least in part in firmware, microcode, or hardware logic.

In some embodiments, implementation module 3100 returns a value through API 3190 in response to an A PI call from A PI-calling module 3180. While API 3190 defines the syntax and result of an API call (e.g., how to invoke the A PI call and what the A PI call does), A PI 3190 might not reveal how implementation module 3100 accomplishes the function specified by the A PI call. Various API calls are transferred via the one or more application programming interfaces between A PI-calling module 3180 and implementation module 3100. Transferring the API calls can include issuing, initiating, invoking, calling, receiving, returning, and/or responding to the function calls or messages. In other words, transferring can describe actions by either of A PI-calling module 3180 or implementation module 3100. In some embodiments, a function call or other invocation of API 3190 sends and/or receives one or more parameters through a parameter list or other structure.

In some embodiments, implementation module 3100 provides more than one API, each providing a different view of or with different aspects of functionality implemented by implementation module 3100. For example, one API of implementation module 3100 can provide a first set of functions and can be exposed to third-party developers, and another API of implementation module 3100 can be hidden (e.g., not exposed) and provide a subset of the first set of functions and also provide another set of functions, such as testing or debugging functions which are not in the first set of functions. In some embodiments, implementation module 3100 calls one or more other components via an underlying A PI and thus is both an API-calling module and an implementation module. It should be recognized that implementation module 3100 can include additional functions, methods, classes, data structures, and/or other features that are not specified through A PI 3190 and are not available to A PI-calling module 3180. It should also be recognized that A PI-calling module 3180 can be on the same system as implementation module 3100 or can be located remotely and access implementation module 3100 using A PI 3190 over a network. In some embodiments, implementation module 3100, A PI 3190, and/or A PI-calling module 3180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (A PI) is an interface between a first software process and a second software process that specifies a format for communication between the first software process and the second software process. Limited A Pls (e.g., private A Pls or partner A Pls) are A PIs that are accessible to a limited set of software processes (e.g., only software processes within an operating system or only software processes that are approved to access the limited A Pls). Public A PIs that are accessible to a wider set of software processes. Some A Pls enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some A Pls enable software processes to communicate about and/or set a state of one or more output generation components (e.g., one or more audio output generation components, one or more display generation components, and/or one or more tactile output generation components). Some A Pls enable particular capabilities (e.g., scrolling, handwriting, text entry, image editing, and/or image creation) to be accessed, performed, and/or used by a software process (e.g., generating outputs for use by a software process based on input from the software process). Some A PIs enable content from a software process to be inserted into a template and displayed in a user interface that has a layout and/or behaviors that are specified by the template.

M any software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. Many of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more A PIs (e.g., via multiple different A Pls). For example, when an input is detected the direct sensor data is frequently processed into one or more input events that are provided (e.g., via an A PI) to a receiving software process that makes some determination based on the input events, and then sends (e.g., via an API) information to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an A PI) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls between steps of interacting with the computer system (e.g., between different software components of the computer system or between a software component of the computer system and a software component of one or more remote computer systems).

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

In some embodiments, the application is an application that is pre-installed on the first computer system at purchase (e.g., a first-party application). In some embodiments, the application is an application that is provided to the first computer system via an operating system update file (e.g., a first-party application). In some embodiments, the application is an application that is provided via an application store. In some embodiments, the application store is pre-installed on the first computer system at purchase (e.g., a first-party application store) and allows download of one or more applications. In some embodiments, the application store is a third-party application store (e.g., an application store that is provided by another device, downloaded via a network, and/or read from a storage device). In some embodiments, the application is a third-party application (e.g., an app that is provided by an application store, downloaded via a network, and/or read from a storage device). In some embodiments, the application controls the first computer system to perform method 700 (FIG. 7), method 800 (FIG. 8), method 900 (FIG. 9), and/or method 1100 (FIG. 11) by calling an application programming interface (A PI) provided by the system process using one or more parameters.

In some embodiments, exemplary A PIs provided by the system process include one or more of: a pairing API (e.g., for establishing secure connection, e.g., with an accessory), a device detection A PI (e.g., for locating nearby devices, e.g., media devices and/or smartphone), a payment API, a UIK it A PI (e.g., for generating user interfaces), a location detection API, a locator A PI, a maps API, a health sensor A PI, a sensor A PI, a messaging A PI, a push notification API, a streaming A PI, a collaboration A PI, a video conferencing API, an application store A PI, an advertising services A PI, a web browser A PI (e.g., WebK it A PI), a vehicle API, a networking API, a WiFi API, a Bluetooth A PI, an NFC API, a UWB API, a fitness API, a smart home A PI, contact transfer A PI, a photos A PI, a camera A PI, and/or an image processing A PI.

In some embodiments, at least one A PI is a software module (e.g., a collection of computer-readable instructions) that provides an interface that allows a different module (e.g., A PI-calling module 3180) to access and use one or more functions, methods, procedures, data structures, classes, and/or other services provided by an implementation module of the system process. The API can define one or more parameters that are passed between the A PI-calling module and the implementation module. In some embodiments, A PI 3190 defines a first A PI call that can be provided by A PI-calling module 3180. The implementation module is a system software module (e.g., a collection of computer-readable instructions) that is constructed to perform an operation in response to receiving an API call via the API. In some embodiments, the implementation module is constructed to provide an A PI response (via the A PI) as a result of processing an API call. In some embodiments, the implementation module is included in the device (e.g., 3150) that runs the application. In some embodiments, the implementation module is included in an electronic device that is separate from the device that runs the application.

Attention is now directed towards embodiments of user interfaces that are, optionally, implemented on, for example, portable multifunction device 100.

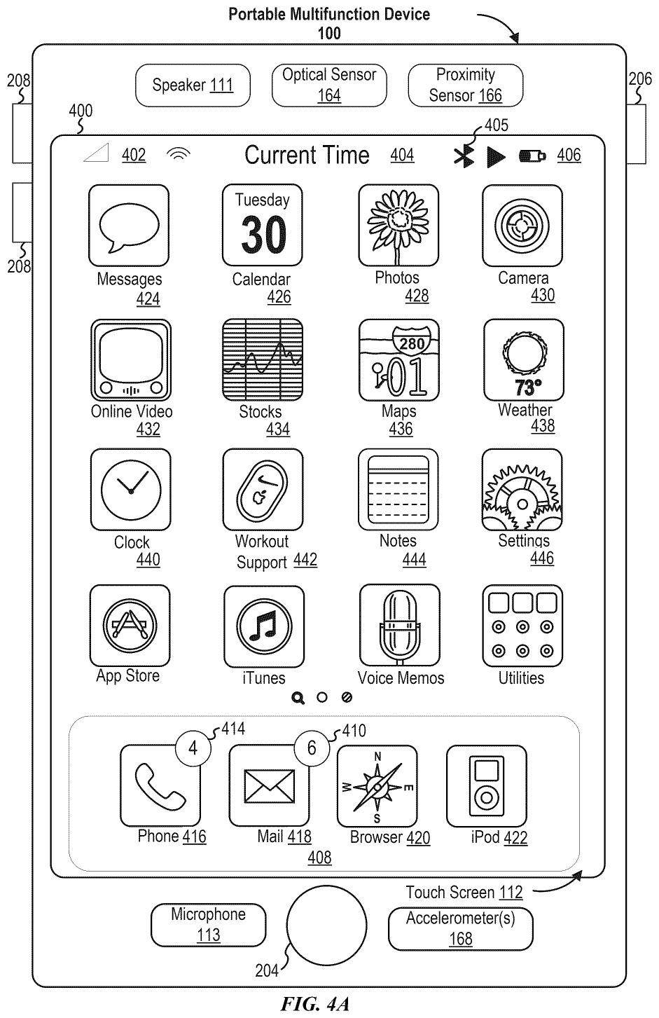

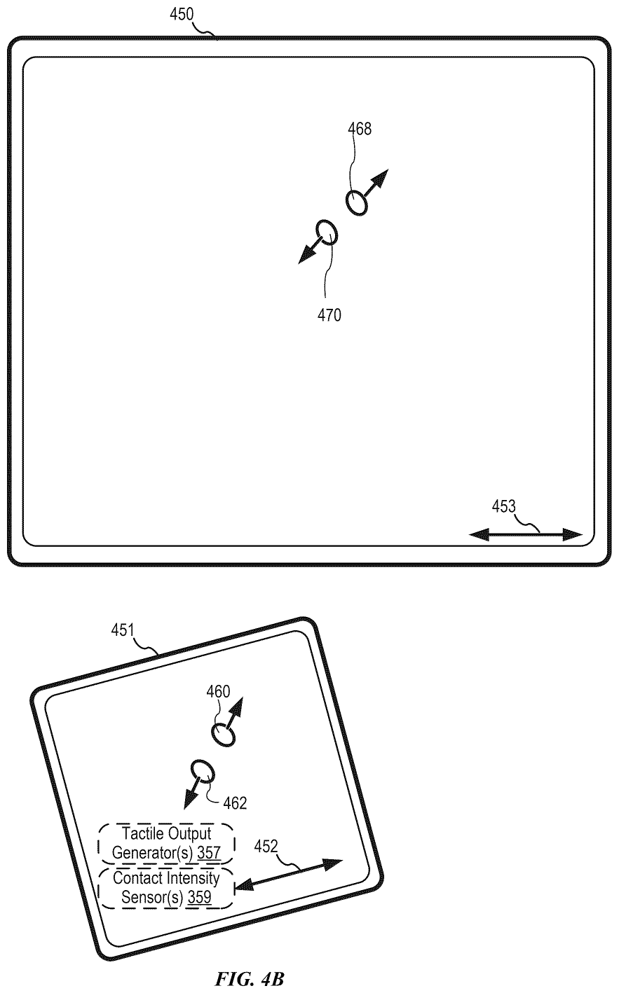

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for IM module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3A) with a touch-sensitive surface 451 (e.g., a tablet or touchpad 355, FIG. 3A) that is separate from the display 450 (e.g., touch screen display 112). Device 300 also, optionally, includes one or more contact intensity sensors (e.g., one or more of sensors 359) for detecting intensity of contacts on touch-sensitive surface 451 and/or one or more tactile output generators 357 for generating tactile outputs for a user of device 300.

Although some of the examples that follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., touch sensitive surface 451 in FIG. 4B) has a primary axis (e.g., 452 in FIG. 4B) that corresponds to a primary axis (e.g., 453 in FIG. 4B) on the display (e.g., display 450). In accordance with these embodiments, the device detects contacts (e.g., contact 460 and contact 462 in FIG. 4B) with the touch-sensitive surface 451 at locations that correspond to respective locations on the display (e.g., in FIG. 4B, contact 460 corresponds to 468 and contact 462 corresponds to 470). In this way, user inputs (e.g., contacts 460 and 462, and movements thereof) detected by the device on the touch-sensitive surface (e.g., touch sensitive surface 451 in FIG. 4B) are used by the device to manipulate the user interface on the display (e.g., display 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

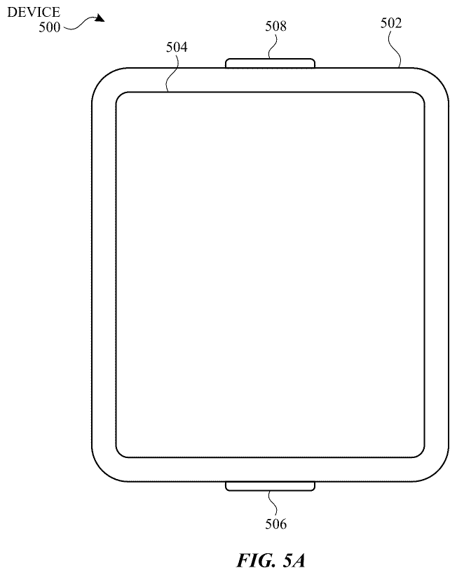

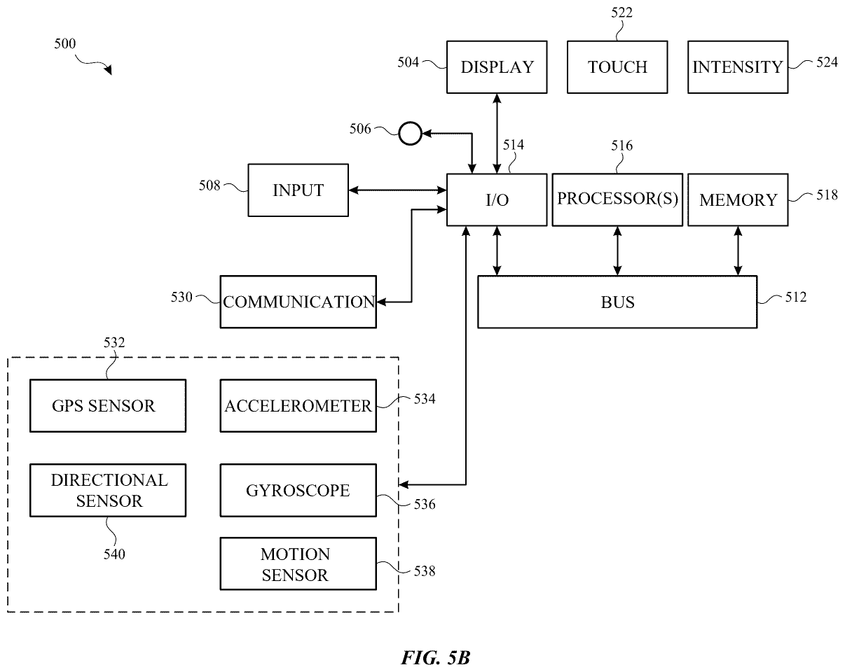

FIG. 5A illustrates exemplary personal electronic device 500. Device 500 includes body 502. In some embodiments, device 500 can include some or all of the features described with respect to devices 100 and 300 (e.g., FIGS. 1A-4B). In some embodiments, device 500 has touch-sensitive display screen 504, hereafter touch screen 504. Alternatively, or in addition to touch screen 504, device 500 has a display and a touch-sensitive surface. As with devices 100 and 300, in some embodiments, touch screen 504 (or the touch-sensitive surface) optionally includes one or more intensity sensors for detecting intensity of contacts (e.g., touches) being applied. The one or more intensity sensors of touch screen 504 (or the touch-sensitive surface) can provide output data that represents the intensity of touches. The user interface of device 500 can respond to touches based on their intensity, meaning that touches of different intensities can invoke different user interface operations on device 500.

Exemplary techniques for detecting and processing touch intensity are found, for example, in related applications: International Patent Application Serial No. PCT/US2013/040061, titled “Device, Method, and Graphical User Interface for Displaying User Interface Objects Corresponding to an application,” filed May 8, 2013, published as WIPO Publication No. WO/2013/169849, and International Patent Application Serial No. PCT/US2013/069483, titled “Device, Method, and Graphical User Interface for Transitioning Between Touch Input to Display Output Relationships,” filed Nov. 11, 2013, published as WIPO Publication No. WO/2014/105276, each of which is hereby incorporated by reference in their entirety.

In some embodiments, device 500 has one or more input mechanisms 506 and 508. Input mechanisms 506 and 508, if included, can be physical. Examples of physical input mechanisms include push buttons and rotatable mechanisms. In some embodiments, device 500 has one or more attachment mechanisms. Such attachment mechanisms, if included, can permit attachment of device 500 with, for example, hats, eyewear, earrings, necklaces, shirts, jackets, bracelets, watch straps, chains, trousers, belts, shoes, purses, backpacks, and so forth. These attachment mechanisms permit device 500 to be worn by a user.

FIG. 5B depicts exemplary personal electronic device 500. In some embodiments, device 500 can include some or all of the components described with respect to FIGS. 1A, 1B, and 3A. Device 500 has bus 512 that operatively couples I/O section 514 with one or more computer processors 516 and memory 518. I/O section 514 can be connected to display screen 504, which can have touch-sensitive component 522 and, optionally, intensity sensor 524 (e.g., contact intensity sensor). In addition, I/O section 514 can be connected with communication unit 530 for receiving application and operating system data, using Wi-Fi, Bluetooth, near field communication (NFC), cellular, and/or other wireless communication techniques. Device 500 can include input mechanisms 506 and/or 508. Input mechanism 506 is, optionally, a rotatable input device or a depressible and rotatable input device, for example. Input mechanism 508 is, optionally, a button, in some examples.

Input mechanism 508 is, optionally, a microphone, in some examples. Personal electronic device 500 optionally includes various sensors, such as GPS sensor 532, accelerometer 534, directional sensor 540 (e.g., compass), gyroscope 536, motion sensor 538, and/or a combination thereof, all of which can be operatively connected to I/O section 514.

Memory 518 of personal electronic device 500 can include one or more non-transitory computer-readable storage mediums, for storing computer-executable instructions, which, when executed by one or more computer processors 516, for example, can cause the computer processors to perform the techniques described below, including processes 700-900 and 1100 (FIGS. 7, 8, 9, and 11). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray® technologies, as well as persistent solid-state memory such as flash, solid-state drives, and the like. Personal electronic device 500 is not limited to the components and configuration of FIG. 5B, but can include other or additional components in multiple configurations.

As used here, the term “affordance” refers to a user-interactive graphical user interface object that is, optionally, displayed on the display screen of devices 100, 300, and/or 500 (FIGS. 1A, 3A, and 5A-5B). For example, an image (e.g., icon), a button, and text (e.g., hyperlink) each optionally constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 355 in FIG. 3A or touch-sensitive surface 451 in FIG. 4B) while the cursor is over a particular user interface element (e.g., a button, window, slider, or other user interface element), the particular user interface element is adjusted in accordance with the detected input. In some implementations that include a touch screen display (e.g., touch-sensitive display system 112 in FIG. 1A or touch screen 112 in FIG. 4A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

As used herein, an “installed application” refers to a software application that has been downloaded onto an electronic device (e.g., devices 100, 300, and/or 500) and is ready to be launched (e.g., become opened) on the device. In some embodiments, a downloaded application becomes an installed application by way of an installation program that extracts program portions from a downloaded package and integrates the extracted portions with the operating system of the computer system.

As used herein, the terms “open application” or “executing application” refer to a software application with retained state information (e.g., as part of device/global internal state 157 and/or application internal state 192). An open or executing application is, optionally, any one of the following types of applications:
an active application, which is currently displayed on a display screen of the device that the application is being used on;
a background application (or background processes), which is not currently displayed, but one or more processes for the application are being processed by one or more processors; and
a suspended or hibernated application, which is not running, but has state information that is stored in memory (volatile and non-volatile, respectively) and that can be used to resume execution of the application.

As used herein, the term “closed application” refers to software applications without retained state information (e.g., state information for closed applications is not stored in a memory of the device). Accordingly, closing an application includes stopping and/or removing application processes for the application and removing state information for the application from the memory of the device. Generally, opening a second application while in a first application does not close the first application. When the second application is displayed and the first application ceases to be displayed, the first application becomes a background application.

In some embodiments, the computer system is in a locked state or an unlocked state. In the locked state, the computer system is powered on and operational but is prevented from performing a predefined set of operations in response to user input. The predefined set of operations optionally includes navigation between user interfaces, activation or deactivation of a predefined set of functions, and activation or deactivation of certain applications. The locked state can be used to prevent unintentional or unauthorized use of some functionality of the computer system or activation or deactivation of some functions on the computer system. In some embodiments, in the unlocked state, the computer system is powered on and operational and is not prevented from performing at least a portion of the predefined set of operations that cannot be performed while in the locked state. When the computer system is in the locked state, the computer system is said to be locked. When the computer system is in the unlocked state, the computer is said to be unlocked. In some embodiments, the computer system in the locked state optionally responds to a limited set of user inputs, including input that corresponds to an attempt to transition the computer system to the unlocked state or input that corresponds to powering the computer system off.

Attention is now directed towards embodiments of user interfaces (“UI”) and associated processes that are implemented on an electronic device, such as portable multifunction device 100, device 300, or device 500.

FIGS. 6A-6R illustrate exemplary user interfaces for presenting workout content, in accordance with some embodiments. The user interfaces in these figures are used to illustrate the processes described below, including the processes in FIG. 7, FIG. 8, and FIG. 9.

FIG. 6A illustrates computer system 600, which is a smart phone with touch-sensitive display 602. At FIG. 6A, computer system 600 displays options 604a-604d. Options 604a-604d, when selected, cause computer system 600 to display different user interfaces. In some embodiments, option 604a, when selected, causes computer system 600 to display a first workout selection user interface (e.g., a “For You” workout selection user interface) (e.g., user interface 608). Option 604b, when selected, causes computer system 600 to display a second workout selection user interface different from the first workout selection user interface (e.g., an “Explore” workout selection user interface) (e.g., user interface 640, described in greater detail below with reference to FIG. 6H). In some embodiments, the first workout selection user interface (e.g., user interface 608) displays a variety of workout recommendations that are customized for the user of the computer system (e.g., selected based on a workout history of the user of the computer system). In some embodiments, the second workout selection user interface (e.g., user interface 640) displays workout recommendations that are not customized specifically for the user of the computer system (e.g., that do not take into account the workout history of the user of the computer system). For example, in some embodiments, the second workout selection user interface is editorially determined and/or designed by a third party without consideration of the workout history of the user of computer system 600.

Option 604c, when selected, causes computer system to display a library user interface (e.g., user interface 644, described in greater detail below with reference to FIG. 6I). Option 604d, when selected, causes computer system to display a search user interface (e.g., user interface 648, described in greater detail below with reference to FIG. 6J). Each of these options and user interfaces will be described in greater detail below.

At FIG. 6A, computer system 600 also displays options 606a-606c. Option 606a, when selected, causes computer system 600 to display a fitness summary user interface that displays physical activity metrics of the user of the computer system (e.g., calories burned, steps taken, distance walked, and/or heart rate). Option 606b, when selected, causes computer system 600 to display a workout selection user interface (e.g., user interface 608 and/or user interface 640). Option 606b is currently selected in FIG. 6A, as indicated by option 606b being displayed in a darker color and with thicker lines than options 606a and 606c. Option 606c, when selected, causes computer system 600 to display a workout sharing user interface (e.g., user interface 1000, described in greater detail below with reference to FIG. 10A).

At FIG. 6A, computer system 600 displays user interface 608. In some embodiments, user interface 608 is a workout selection user interface that displays a plurality of workout recommendations for a user of computer system 600. In some embodiments, some or all of the workout recommendations presented in user interface 608 are selected for inclusion in user interface 608 based on a workout history of the user of computer system 600, as will be described in greater detail below. User interface 608 includes scrollable region 610. In the depicted embodiments, scrollable region 610 is scrollable in a horizontal direction, and user interface 608 is also scrollable in a vertical direction. In FIG. 6A, scrollable region 610 includes workout recommendation 610a, workout plan recommendation 610b, and workout series recommendation 610c.

Workout recommendation 610a corresponds to a first workout (e.g., a ten minute HIIT workout with instructor Kim to Pure Dance music). Workout recommendation 610a includes option 610a-1 which, when selected, causes computer system 600 to initiate playback of the first workout (e.g., initiate playback of video content of the workout (e.g., video content of one or more instructors demonstrating the workout and/or providing instructions for the workout) and/or initiate playback of audio content of the workout (e.g., audio content that includes music corresponding to the workout (e.g., Pure Dance music) and/or spoken instructions for performing the workout)). In some embodiments, workout recommendation 610a is automatically selected for inclusion in scrollable region 610 and/or user interface 608 based on a workout history of the user of computer system 600. For example, in some embodiments, the workout history of the user indicates that the user has previously completed one or more 10 minute workouts; one or more HIIT workouts; one or more workouts taught by instructor Kim; one or more workouts set to Pure Dance music; and/or any combination of the foregoing.

Workout plan recommendation 610b corresponds to a second workout (e.g., a 20 minute core workout with instructor Crystal, set to “Latest Hits” music). The second workout is part of a multi-workout workout plan for the user of computer system 600. In some embodiments, a user is able to generate their own multi-workout workout plan by specifying one or more parameters for the workout plan, and computer system 600 and/or another computer system automatically selects workouts for the user according to the user-specified parameters for the workout plan. For example, in some embodiments, the user specifies one or more of: the days of the week the user would like to work out (e.g., Monday, Tuesday, Wednesday, etc.); how long the user would like to workout (e.g., for every workout or for each selected day of the week) (e.g., 10 minutes, 15 minutes, 20 minutes, 30 minutes; and/or 10 minutes on Mondays, 30 minutes on Wednesdays, and/or 20 minutes on Fridays); workout modalities (e.g., workout types) (e.g., strength training, running, cycling, swimming, strength training, yoga, HIIT, core, and/or Pilates); trainers (e.g., instructors and/or teachers); and/or music types (e.g., music genres) (e.g., pop, latest hits, rock, classical, 80s, 90s, 2000s, hip hop, R & B, rap, and/or grunge). Once the user has specified the parameters for the multi-workout workout plan, in some embodiments, computer system 600 and/or another computer system selects workouts for the multi-workout workout plan according to the user-specified parameters. In FIG. 6A, the user of computer system 600 has a current and/or ongoing multi-workout workout plan, and workout plan recommendation 610b corresponds to a next workout in the multi-workout workout plan. Workout plan recommendation 610b includes options 610b-1 and 610b-2. Option 610b-1, when selected, causes computer system 600 to initiate playback of the next workout in the multi-workout workout plan (e.g., the 20-minute core workout with Crystal). Option 610b-2, when selected, causes computer system 600 to display a workout plan user interface corresponding to the user's multi-workout workout plan. In some embodiments, the workout plan user interface displays one or more workouts (e.g., representations, thumbnails, and/or platters of one or more workouts) of the multi-workout workout plan that the user has completed; and/or displays one or more upcoming workouts (e.g., representations, thumbnails, and/or platters of one or more upcoming workouts) in the multi-workout workout plan that the user has not yet completed.

Workout series recommendation 610c corresponds to a multi-workout workout series (e.g., pre-set and/or a pre-defined multi-workout workout series). In some embodiments, workout series recommendation 610c, when selected, causes computer system 600 to display a user interface corresponding to the multi-workout workout series. In some embodiments, the user interface corresponding to the multi-workout workout series displays representations of the one or more workouts that are in the multi-workout workout series.

Below scrollable region 610, user interface 608 includes section 612. Section 612 includes workout recommendations 612a-612c. In some embodiments, section 612 is also scrollable in a horizontal direction to reveal additional workout recommendations in section 612. Section 612 includes a plurality of workout recommendations that are selected based on selection criteria. The selection criteria for section 612 is workouts that are HIIT workouts, of 10 minute duration, set to Pure Dance music, and taught by instructor Kim or instructor Blake (e.g., as indicated by the title of section 612). Workout recommendations 612a, 612b, 612c are selected for inclusion in section 612 based on these selection criteria (e.g., workout recommendations 612a, 612b, 612c satisfy these selection criteria). In some embodiments, the selection criteria are automatically determined (e.g., by computer system 600 and/or another computer system) (e.g., using an AI model and/or a generative AI model) based on a workout history of the user of computer system 600. For example, in some embodiments, the workout history of the user indicates that the user has previously completed one or more 10 minute workouts; one or more HIIT workouts; one or more workouts taught by instructor Kim or instructor Blake; one or more workouts set to Pure Dance music; and/or any combination of the foregoing. As such, section 612 presents various workout recommendations that are automatically selected based on the workout history of the user.

As discussed above, in the depicted embodiments, scrollable region 610 is scrollable in a horizontal direction. In FIG. 6A, workout recommendation 610a is displayed in scrollable region 610, while workout plan recommendation 610b and workout series recommendation 610c are not displayed (or only partially displayed). FIG. 6A depicts two example scenarios in which computer system 600 detects two different user inputs: user input 614a, which is a swipe left input within scrollable region 610, and user input 614b, which is a swipe right input within scrollable region 610. Each of these scenarios and user inputs will be discussed below.

At FIG. 6B, in response to user input 614a, computer system 600 displays scrolling of scrollable region 610 to the left so that workout recommendation 610a is no longer displayed (or only partially displayed) and workout series recommendation 610c is displayed within scrollable region 610.

At FIG. 6C, in response to user input 614b, computer system 600 displays scrolling of scrollable region 610 to the right so that workout recommendation 610a is no longer displayed (or only partially displayed) and workout plan recommendation 610b is displayed within scrollable region 610. At FIG. 6C, computer system 600 detects user input 616, which is a swipe up user input.

At FIG. 6D, in response to user input 616, computer system 600 displays scrolling of user interface 608 such that in FIG. 6D, options 604a-604d are no longer displayed (e.g., have moved off the top of display 602), and section 612 is more fully displayed. In FIG. 6D, computer system 600 now displays sections 618 and 620 of user interface 608.

Section 618 includes workout recommendations 618a-618c. In some embodiments, section 618 is also scrollable in a horizontal direction to reveal additional workout recommendations in section 618. Section 618 includes a plurality of workout recommendations that are selected based on selection criteria that are different from the selection criteria of section 612. The selection criteria for section 618 is workouts that are yoga workouts, of 10 minute duration, and taught by instructor Jess or instructor Casay (e.g., as indicated by the title of section 618). Workout recommendations 618a-618c are selected for inclusion in section 618 based on these selection criteria (e.g., workout recommendations 618a-618c satisfy these selection criteria). In some embodiments, the selection criteria are automatically determined (e.g., by computer system 600 and/or another computer system) (e.g., using an AI model and/or a generative AI model) based on a workout history of the user of computer system 600. For example, in some embodiments, the workout history of the user indicates that the user has previously completed one or more 10 minute workouts; one or more yoga workouts; one or more workouts taught by instructor J ess or instructor Casay; and/or any combination of the foregoing. As such, section 618 presents various workout recommendations that are automatically selected based on the workout history of the user.

Section 620 includes workout recommendations 620a-620c. In some embodiments, section 620 is also scrollable in a horizontal direction to reveal additional workout recommendations in section 620. Section 620 includes a plurality of workout recommendations that are selected based on selection criteria that are different from the selection criteria of section 612 and section 618. The selection criteria for section 620 is workouts that are strength workouts of 20 minute duration, and taught by instructor Brock (e.g., as indicated by the title of section 620). Workout recommendations 620a-620c are selected for inclusion in section 620 based on these selection criteria (e.g., workout recommendations 620a-620c satisfy these selection criteria). In some embodiments, the selection criteria are automatically determined (e.g., by computer system 600 and/or another computer system) (e.g., using an AI model and/or a generative AI model) based on a workout history of the user of computer system 600. For example, in some embodiments, the workout history of the user indicates that the user has previously completed one or more 20 minute workouts; one or more strength training workouts; one or more workouts taught by instructor Brock; and/or any combination of the foregoing. As such, section 620 presents various workout recommendations that are automatically selected based on the workout history of the user.

At FIG. 6D, computer system 600 detects user input 622, which is a swipe up input.

At FIG. 6E, in response to user input 622, computer system 600 displays scrolling of user interface 608 such that in FIG. 6E, sections 612, 618, 620 are no longer displayed (e.g., having moved off the top of display 602), and now sections 624, 626, and 628 of user interface 608 are displayed.

Section 624 includes modality options 624a-624d. Each modality option 624a-624d corresponds to a different workout modality and/or a different workout type. For example, option 624a corresponds to HIIT workouts, option 624b corresponds to Yoga workouts, and option 624c corresponds to Strength workouts. In some embodiments, option 624a, when selected, displays one or more HIIT workout recommendations (e.g., without displaying workout recommendations of other workout types); option 624b, when selected, displays one or more Yoga workout recommendations (e.g., without displaying workout recommendations of other workout types); and option 624c, when selected, displays one or more strength workout recommendations (e.g., without displaying workout recommendations of other workout types). In some embodiments, modality options in section 624 are ordered and/or arranged based on the workout history of the user of computer system 600. For example, in some embodiments, HIIT option 624a is positioned in a leftmost position of section 624 based on the user having completed more HIIT workouts than any other type of workout, and yoga option 624b is positioned in the next leftmost position of section 624 based on the user having completed more yoga workouts than any other type of workout except HIIT workouts, and so forth.

Section 626 includes workout recommendations 626a and 626b. In some embodiments, section 626 displays one or more workout recommendations that are determined to be similar to other workouts recently completed by the user of computer system 600. For example, in some embodiments, the user of computer system 600 recently completed a 10 minute strength workout with instructor Greg and, based on this workout history, computer system 600 (or another computer system) selects workout recommendation 626a (another 10 minute strength workout with instructor Greg) for inclusion in section 626.

Section 628 includes trainer recommendations 628a-628d. Each trainer recommendation 628a-628d corresponds to a different trainer and/or instructor. For example, trainer recommendation 628a corresponds to trainer Sam, trainer recommendation 628b corresponds to trainer Riw, trainer recommendation 628c corresponds to trainer Jess, and trainer recommendation 628c corresponds to trainer Barry. In some embodiments, trainer recommendation 628a, when selected, causes computer system 600 to display one or more workout recommendations of workouts that are taught by trainer Sam (e.g., without displaying workout recommendations that are taught by another trainer); trainer recommendation 628b, when selected, causes computer system 600 to display one or more workout recommendations of workouts that are taught by trainer Riw (e.g., without displaying workout recommendations that are taught by another trainer); trainer recommendation 628c, when selected, causes computer system 600 to display one or more workout recommendations of workouts that are taught by trainer Jess (e.g., without displaying workout recommendations that are taught by another trainer); and trainer recommendation 628d, when selected, causes computer system 600 to display one or more workout recommendations of workouts that are taught by trainer Barry (e.g., without displaying workout recommendations that are taught by another trainer). In some embodiments, trainer recommendations in section 628 are ordered and/or arranged based on the workout history of the user of computer system 600. For example, in some embodiments, trainer recommendation 628a is positioned in a leftmost position of section 628 based on the user having completed more workouts taught by Sam than any other instructor, and trainer recommendation 628b is positioned in the next leftmost position of section 628 based on the user having completed more workouts taught by Riw than any other instructor other than Sam, and so forth.

At FIG. 6E, computer system 600 detects user input 630, which is an upward swipe user input.

At FIG. 6F, in response to user input 630, computer system 600 displays scrolling of user interface 608 such that in FIG. 6F, sections 624 and 626 are no longer displayed, and now sections 632 and 634 of user interface 608 are displayed.

Section 632 is an awards section that includes representations 632a-632c. Representation 632a is representative of a first workout achievement, e.g., a weekly workout streak, and indicates that the user has an active and/or ongoing 11-week streak in which they have completed a threshold number of workouts (e.g., least one workout for 11 consecutive weeks). Representation 632b is representative of a second workout achievement. In the depicted scenario, the second workout achievement is completing ten yoga workouts. In FIG. 6F, the user has completed nine yoga workouts and, accordingly, representation 632b indicates that the user must complete one more yoga workout to achieve the second workout achievement. In some embodiments, representation 632b, when selected, causes computer system 600 to display one or more workout recommendations that would help the user achieve the second workout achievement (e.g., one or more yoga workout recommendations that would help the user achieve ten yoga workouts) (e.g., without displaying workout recommendations that would not help the user achieve the second workout achievement (e.g., without displaying workout recommendations of other workout modalities)). Representation 632c is representative of a third workout achievement of tent strength workouts. In FIG. 6F, the user has completed seven strength workouts and, accordingly, representation 632c indicates that the user must complete three more strength workouts to achieve the third workout achievement. In some embodiments, representation 632c, when selected, causes computer system 600 to display one or more workout recommendations that would help the user achieve the third workout achievement (e.g., one or more strength workout recommendations that would help the user achieve and/or get closer to ten strength workouts) (e.g., without displaying workout recommendations that would not help the user achieve the third workout achievement (e.g., without displaying workout recommendations of other workout modalities)).

At FIG. 6F, computer system 600 detects user input 636, which is a downward swipe user input.

At FIG. 6G, in response to user input 636, computer system 600 displays scrolling of user interface 608 such that computer system now displays options 604a-604d, scrollable region 610, and section 612. At FIG. 6G, computer system 600 detects user input 638, which is a touch input (e.g., a tap input) corresponding to selection of option 604b.

At FIG. 6H, in response to user input 638, computer system 600 displays user interface 640. In some embodiments, whereas user interface 608 displayed workout recommendations for the user based on the workout history of the user, user interface 640 displays workout recommendations that are selected for display without consideration of the workout history of the user. For example, in some embodiments, user interface 640 is a user interface that is the same for a plurality of different users (e.g., all of users of a workout services and/or workout application). In FIG. 6H, user interface 640 includes artist spotlight section 640a, new workouts section 640b, and popular workouts section 640c. In some embodiments, artist spotlight section 640a highlights and/or identifies a particular musical artist, and displays one or more workout recommendations that are associated with the musical artist. For example, in FIG. 6H, artist spotlight section 640a displays a workout recommendation, which is a yoga workout that is set to the music of artist Scott Grace. In some embodiments, the workout recommendation and/or artist spotlight section 640a, when selected, causes computer system 600 to initiate playback of the workout “Yoga For Every Runner With Scott Grace.”

New workouts section 640b includes option 640b-2, 640b-3, and option 640b-4. In some embodiments, new workouts section 640b is scrollable horizontally to reveal additional options in new workout section 640b. In some embodiments, options in new workouts section 640b are selectable to cause computer system 600 to display one or more workout recommendations of new workouts (e.g., workouts that have been released and/or published within a threshold duration of time and/or the most recently released and/or published workouts) that correspond to the selected workout type. For example, option 640b-2, when selected, causes computer system 600 to display one or more HIIT workout recommendations that were recently released, and option 640b-3, when selected, causes computer system 600 to display one or more yoga workout recommendations that were recently released. In some embodiments, the order of options 640b-2, 640b-3, 640b-4 in section 640b is determined without consideration for the workout history of the user of computer system 600.

Popular workouts section 640c includes options 640c-1, 640c-2, 640c-3, and 640c-4. In some embodiments, popular workouts section 640c is scrollable horizontally to reveal additional options in popular workout section 640c. In some embodiments, options in popular workouts section 640c are selectable to cause computer system 600 to display one or more workout recommendations of popular workouts (e.g., workouts that have been selected the most times and/or a threshold number of times by users of a fitness service) that correspond to the selected workout type. For example, option 640c-1, when selected, causes computer system 600 to display one or more HIIT workout recommendations that are popular on the fitness service and/or application, and option 640c-2, when selected, causes computer system 600 to display one or more cycling workout recommendations that are popular on the fitness service and/or application. In some embodiments, the order of options 640c-1, 640c-2, 640c-3, and/or 640c-4 in section 640c is determined without consideration for the workout history of the user of computer system 600.

In some embodiments, user interface 640 is updated and/or changed periodically. FIG. 6H1 depicts user interface 640 at a second time after the scenario shown in FIG. 6H. In FIG. 6H1, user interface 640 still includes artist spotlight section 640a, but artist spotlight section 640a now spotlights a different musical artist (e.g., Lindsay Gray), and displays a workout recommendation for a different workout recommendation.

Returning to FIG. 6H, computer system 600 detects user input 642, which is a touch input (e.g., a tap input) corresponding to selection of option 604c.

At FIG. 6I, in response to user input 642, computer system 600 displays library user interface 644. Library user interface 644 includes representations 644a-644f that are representative of one or more folders and/or collections. In some embodiments, the user of computer system 600 is able to save workouts to various folders, including a workouts folder (e.g., represented by representation 644a), a meditations folder (e.g., represented by representation 644b), and a downloads folder (e.g., represented by representation 644f). In some embodiments, representation 644a, when selected, causes computer system 600 to display the workouts saved into the workouts folder by the user (e.g., display thumbnails and/or user interface objects that are selectable to initiate playback of the workouts saved by the user into the workouts folder). In some embodiments, representation 644b, when selected, causes computer system 600 to display the meditation workouts saved into the meditations folder by the user (e.g., display thumbnails and/or user interface objects that are selectable to initiate playback of the meditations workouts saved by the user into the meditations folder). In some embodiments, representation 644f, when selected, causes computer system 600 to display the workouts saved into the downloads folder by the user (e.g., display thumbnails and/or user interface objects that are selectable to initiate playback of the workouts saved by the user into the downloads folder).

In some embodiments, representation 644d, when selected, causes computer system 600 to display one or more multi-workout programs that the user has saved and/or completed workouts in (e.g., such as the 12 episode workout program represented by plan recommendation 610c). In some embodiments, representation 644e, when selected, causes computer system 600 to display a user interface corresponding to a multi-workout workout plan that is currently active for the user.

User interface 644 also includes recently added section 644g, which includes workout representations 644g-1 through 644g-6 that are representative of different workouts that have recently been saved by the user into one or more folders. In some embodiments, workout recommendations 644g-1 through 644g-6, when selected, cause computer system 600 to initiate playback of a corresponding workout. At FIG. 6I, computer system 600 detects user input 646, which is a touch input (e.g., a tap input) corresponding to selection of option 604d.

At FIG. 6J, in response to user input 646, computer system 600 displays search user interface 648. Search user interface 648 includes search field 648a, into which the user can enter one or more search terms to search for workouts that match the entered search terms. Search user interface 648 also includes section 648c, which includes options 648c-1 through 648c-4. In some embodiments, section 648c is scrollable horizontally to reveal additional options in section 648c. In some embodiments, options in section 648c are selectable to cause computer system 600 to display one or more workout recommendations that correspond to the selected workout type. For example, option 648c-1, when selected, causes computer system 600 to display one or more HIIT workout recommendations, and option 6t48c-1, when selected, causes computer system 600 to display one or more yoga workout recommendations.

User interface 604 also includes discover section 648d. Discover section 648d includes options 648d-1 through 648d-6. Options in discover section 648d provide the user with various avenues to surface additional workout recommendations to the user. For example, in some embodiments, option 648-1, when selected, causes computer system 600 to display a first set of workout recommendations that include strength, core, and yoga workouts for golfers. Option 648d-2, when selected, causes computer system 600 to display one or more pre-made and/or pre-set workout collections that the user can start. Option 648d-3, when selected, causes computer system 600 to initiate a process for generating a new multi-workout workout plan. Option 648d-4, when selected, causes computer system 600 to display one or more workout recommendations corresponding to a current spotlighted music artist. Option 648d-5, when selected, causes computer system 600 to display a second set of workout recommendations that have been aggregated into a collection labeled “sampler collection. Option 648d-6, when selected, causes computer system 600 to display a third set of workout recommendations that are set to a collection of songs that have been identified as the “top fitness songs for 2024.” In this way, search user interface 648 allows a user to search for workouts (e.g., via search field 648a), but also to access different sets of workout recommendations by selecting one of the options in section 648d.

At FIG. 6K depicts an example scenario in which computer system 600 detects that fitness notification criteria are satisfied. For example, in some embodiments, fitness notification criteria are satisfied when the user is within a threshold number of workouts from achieving a workout achievement (e.g., within 1 workout, 2 workouts, or 3 workouts from achieving a workout achievement) and/or within a completion threshold of achieving a workout achievement (e.g., the user has completed 80% or more of 90% or more of a workout achievement). At FIG. 6F, the user has requested to display user interface 608, and computer system 600 detects that the user is within 1 workout of completing the 10 yoga workouts workout achievement. Based on this determination, computer system 600 displays user interface 608 with notification 650, which informs the user that the user is 1 workout away from achieving the 10 yoga workouts workout achievement. In some embodiments, notification 650, when selected, causes computer system 600 to display one or more workout recommendations that would help the user complete the 10 yoga workouts workout achievement (e.g., one or more yoga workout recommendations) (e.g., without displaying workout recommendation that would not help the user complete the workout achievement).

At FIG. 6L, computer system displays user interface 608, which was discussed above. As discussed previously, in some embodiments, scrollable region 610 of user interface 608 includes workout plan recommendation 610b that pertains to a multi-workout workout plan. In some embodiments, when the user has started a multi-workout workout plan and/or has an active multi-workout workout plan, workout plan recommendation 610b displays the next workout in the multi-workout workout plan. In some embodiments, when the user does not have an active and/or started multi-workout workout plan, plan recommendation 610b displays a recommendation to create and/or start a new multi-workout workout plan. At FIG. 6L, the user does not have an active and/or started multi-workout workout plan, and plan recommendation 610b displays option 610b-5 that, when selected, causes computer system 600 to initiate a process for creating a new multi-workout workout plan. In some embodiments, the process for creating a new multi-workout workout plan includes displaying one or more user interfaces in which the user is presented with options for defining one or more parameters of the multi-workout workout plan (e.g., workout modalities, workout days, workout frequency, workout duration, workout trainers, and/or music types), as previously discussed above.

As discussed above, in some embodiments, user interface 608 displays one or more workout recommendations for the user based on the user's workout history. However, in some embodiments, computer system 600 does not have workout history information for the user (e.g., if the user is a new user and/or the user has not completed any workouts in the fitness application and/or the fitness service). In some embodiments, when the user is a new user and/or does not have a workout history, computer system 600 provides an onboarding process for the user to define the user's workout interests. At FIG. 6M, computer system 600 displays user interface 652. User interface 652 includes workout modality options 654a-654i, and asks the user to select one or more workout modalities that are of interest to the user. User interface 652 also includes options 652a-652c. Option 652a, when selected, causes computer system 600 to cease display of user interface 652. Option 652b, when selected, causes computer system 600 to save the user's selections of preferred workout modalities. Option 652c, when selected, causes computer system 600 to clear the user's selections in user interface 652. At FIG. 6M, computer system 600 detects user inputs 656a-656c corresponding to selection of options 654a-654c. At FIG. 6N, in response to user inputs 656a-656c, computer system 600 displays options 654a-654c with indications that these options are selected (e.g., a border around each option 654a-654c). At FIG. 6N, while options 654a-654c are selected, computer system 600 detects user input 658 corresponding to selection of option 652b.

At FIG. 6O, in response to user input 658, computer system 600 displays user interface 608. As discussed above, when the user of computer system 600 has a workout history (e.g., within the fitness application and/or the fitness service), computer system 600 is able to display workout recommendations based on that workout history. For example, these workout recommendations can take into account the user's favorite instructors, workout types, workout durations, and/or music types based on the user's history in the fitness application and/or service. However, in FIGS. 6O-6P, the workout information corresponding to the user is more limited and, accordingly, the recommendations are less complex and/or less granular. For example, in some embodiments, when only the onboarding information from FIGS. 6M-6N is available, computer system 600 displays workout recommendations based on the onboarding information. At FIG. 6O, computer system 600 detects user input 662, which is a swipe up user input. At FIG. 6N, in response to user input 662, computer system 600 displays scrolling of user interface 608 and displays sections 660, 664, and 668 of user interface 608. Section 660 includes one or more HIIT workout recommendations 660a-660c based on user selection of HIIT in FIGS. 6M-6N. Workout recommendations 660a-660c have a variety of different trainers, durations, and music types. In some embodiments, section 660 is scrollable (e.g., horizontally) to reveal additional HIIT workout recommendations.

Section 664 includes one or more yoga workout recommendations 664a-664c based on user selection of yoga in FIGS. 6M-6N. Workout recommendations 664a-664c have a variety of different trainers, durations, and music types. In some embodiments, section 664 is scrollable (e.g., horizontally) to reveal additional yoga workout recommendations.

Section 668 includes one or more strength workout recommendations 668a-668c based on user selection of strength in FIGS. 6M-6N. Workout recommendations 668a-668c have a variety of different trainers, durations, and music types. In some embodiments, section 668 is scrollable (e.g., horizontally) to reveal additional strength workout recommendations. At FIG. 6P, computer system 600 detects user input 670a, which is a swipe up user input. At FIG. 6Q, in response to user input 670a, computer system 600 displays scrolling of user interface 608 and displays section 672. Section 672 includes workout modality options 672a-672d corresponding to different workout modalities. In some embodiments, the workout modality options in section 672 are ordered based on the onboarding inputs from the user in FIGS. 6M-6N. For example, options 672a-672c, corresponding to HIIT, yoga, and strength, respectively, are shown as the first three options based on user selection of HIIT, yoga, and strength in FIGS. 6M-6N.

It can be seen, in FIGS. 6O-6Q, that user interface 608 does not include certain sections that were included in FIGS. 6A-6F. For example, in FIGS. 6O-6Q, user interface 608 does not include “more of what you do” section 626, trainers section 628, awards section 632, or recently completed section 634. In various embodiments, these sections are omitted from user interface 608 based on a determination that computer system 600 does not have sufficient workout history for the user within the fitness application (e.g., the fitness application that displays user interface 608) and/or the user has not completed a threshold number of workouts within the fitness application.

In some embodiments, whereas computer system 600 may not have workout history information for the user within the fitness application and/or fitness service that displays user interface 608, computer system 600 has workout history information from the user from one or more other workout applications. In some embodiments, this workout history information from the one or more other workout applications can be used by the fitness application to populate user interface 608, similar to what is shown in FIGS. 6O-6Q. For example, in some embodiments, section 660 (and/or workout recommendations 660a-660c) is included in user interface 608 based on the workout history of the user in other applications indicating that the user has completed one or more HIIT workouts in other applications; section 664 (and/or workout recommendations 664a-664c) is included in user interface 608 based on the workout history of the user in other applications indicating that the user has completed one or more yoga workouts in other applications; section 668 (and/or workout recommendations 668a-668c) is included in user interface 608 based on the workout history of the user in other applications indicating that the user has completed one or more strength workouts in other applications. In some embodiments, when computer system 600 has workout history information for the user in one or more other applications, but the user has not completed the threshold number of workouts in the fitness application that displays user interface 608, computer system 600 does not display and/or include certain portions of user interface 608 (e.g., “more of what you do” section 626, trainers section 628, awards section 632, or recently completed section 634) until the user completes the threshold number of workouts in the fitness application. In various embodiments, these sections are omitted from user interface 608 based on a determination that computer system 600 does not have sufficient workout history for the user within the fitness application (e.g., the fitness application that displays user interface 608) and/or the user has not completed a threshold number of workouts within the fitness application.

Returning to FIG. 6P, computer system 600 detects user input 670b corresponding to selection of workout recommendation 668b. At FIG. 6R, in response to user input 670b, computer system 600 initiates playback of a strength training workout corresponding to workout recommendation 668b and initiates a workout session for the user. In some embodiments, initiating playback of the workout comprises displaying visual content 674 of the workout, and displaying workout metrics 676 that are indicative of the user's physical activity as the user performs the workout (e.g., the duration of the workout session, the user's heartrate, and/or the number of calories burned by the user during the workout session).

FIG. 7 is a flow diagram illustrating a method for presenting workout content using a computer system in accordance with some embodiments. Method 700 is performed at a computer system (e.g., 100, 300, 500, and/or 600) (e.g., a smart phone, a smart watch, a tablet, a laptop, a desktop, a wearable device, wrist-worn device, and/or head-mounted device) that is in communication with one or more display generation components (e.g., 602) (e.g., a display, a touch-sensitive display, and/or a display controller) and one or more input devices (e.g., 602) (e.g., a touch-sensitive surface, a touch-sensitive display, a button, a rotatable input mechanism, a depressible and rotatable input mechanism, a camera, an accelerometer, an inertial measurement unit (IMU), a heartrate sensor, a body temperature sensor, and/or a blood-oxygen level sensor). Some operations in method 700 are, optionally, combined, the orders of some operations are, optionally, changed, and some operations are, optionally, omitted.

As described below, method 700 provides an intuitive way for presenting workout content. The method reduces the cognitive burden on a user for accessing workout content, thereby creating a more efficient human-machine interface. For battery-operated computing devices, enabling a user to access workout content faster and more efficiently conserves power and increases the time between battery charges.

In some embodiments, the computer system (e.g., 600) displays (702), via the one or more display generation components (e.g., 602), a first user interface (e.g., 608) that includes (e.g., in some embodiments, include concurrently displaying): a first scrollable region (e.g., 610) that is scrollable in a first direction (e.g., horizontally or vertically); and a plurality of workout suggestions (e.g., 612a-612c) that are selected for inclusion in the first user interface based on a workout history of a user of the computer system (e.g., one or more workout suggestions that are selected to match one or more of: a workout type, a workout duration, a workout trainer, and/or a workout music type of one or more workouts previously completed by the user of the computer system), including a first workout suggestion (e.g., 612a-612c) that is selected for inclusion in the first user interface based on the workout history of the user of the computer system and that, when selected, causes the computer system to initiate a process for playback of a first workout corresponding to the first workout suggestion; In some embodiments, a workout suggestion corresponds to (e.g., represents) a workout (e.g., audio and/or video content that guides a user to perform a physical activity). In some embodiments, selecting a workout suggestion initiates a process for playback of a workout corresponding to the workout suggestion. In some embodiments, the first user interface is scrollable in a second direction different from (e.g., perpendicular to) the first direction (e.g., vertically or horizontally). The computer system displays (704), within a first portion of the first scrollable region of the first user interface and concurrently with the first workout suggestion, a second workout suggestion (e.g., 610a) different from the first workout suggestion, wherein the second workout suggestion is selected for inclusion in the first user interface based on the workout history of the user of the computer system and, when selected, causes the computer system to initiate a process for playback of a second workout different from the first workout. While displaying the second workout suggestion within the first portion of the first scrollable region of the first user interface, the computer system detects (706), via the one or more input devices, a first user input (e.g., 614b) (e.g., one or more user inputs) (e.g., one or more touch inputs, one or more hardware control inputs, one or more button presses, one or more rotational inputs, one or more gesture inputs, and/or one or more spoken inputs). In response to detecting the first user input (708): in accordance with a determination that the first user input is directed to the first scrollable region (e.g., 610), the computer system displays (710), concurrently with the first workout suggestion (e.g., 612a-612c), scrolling of the first scrollable region to display, within the first portion of the first scrollable region, a workout plan recommendation (e.g., 610b) (e.g., to display replacement of the second workout suggestion with the workout plan recommendation in the first portion of the first scrollable region), wherein: the workout plan recommendation is determined based on the workout history of the user of the computer system; and the workout plan recommendation pertains to a multi-workout workout plan (e.g., a workout plan that includes a plurality of workouts and, in some embodiments, an arranged sequence of a plurality of workouts). In some embodiments, the workout plan recommendation suggests a next workout in an existing and/or active workout plan for the user of the computer system (e.g., in some embodiments, in accordance with a determination that the user of the computer system is associated with an active and/or ongoing workout plan, the workout plan recommendation suggests a next workout in the active and/or ongoing workout plan). In some embodiments, in accordance with a determination that the user of the computer system is not currently associated with an active and/or ongoing workout plan, the workout plan recommendation suggests that the user start and/or create a multi-workout workout plan. Displaying various workout suggestions for selection by a user allows a user to access various workouts with fewer user inputs. Additionally, displaying a workout suggestion and a workout plan recommendation within a scrollable region of the first user interface allows the user to access these recommendations while conserving limited display space. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, while displaying the second workout suggestion (e.g., 610a) within the first portion of the first scrollable region (e.g., 610) of the first user interface (e.g., 608), the computer system detects, via the one or more input devices, a second user input (e.g., 614a) (e.g., one or more user inputs) (e.g., one or more touch inputs, one or more hardware control inputs, one or more button presses, one or more rotational inputs, one or more gesture inputs, and/or one or more spoken inputs) that is different from the first user input (e.g., 614b) (e.g., different in magnitude and/or direction from the second user input). In response to detecting the second user input: in accordance with a determination that the second user input is directed to the first scrollable region, the computer system displays, concurrently with the first workout suggestion (e.g., 612a-612c), scrolling of the first scrollable region to display, within the first portion of the first scrollable region, a third workout suggestion (e.g., 610c) that is different from the first workout suggestion and the second workout suggestion, wherein the third workout suggestion is selected for inclusion in the first user interface without regard for the workout history of the user of the computer system (e.g., without considering and/or without factoring in the workout history of the user of the computer system) and, when selected, causes the computer system to initiate a process for playback of a third workout different from the first workout and the second workout (e.g., in some embodiments, region 610c displays a workout suggestion, and/or in some embodiments, recommendation 610c, when selected, cause computer system 600 to initiate playback of a first workout of the 12 episode workout series). Displaying various workout suggestions for selection by a user allows a user to access various workouts with fewer user inputs. Additionally, displaying a second workout suggestion, a third workout suggestion, and a workout plan recommendation within a scrollable region of the first user interface allows the user to access these recommendations while conserving limited display space. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, displaying the workout plan recommendation within the first portion of the first scrollable region comprises: in accordance with a determination that the user of the computer system is participating in a first multi-workout workout plan (e.g., a current multi-workout workout plan, an active multi-workout workout plan, and/or an ongoing multi-workout workout plan), displaying a fourth workout suggestion (610b in FIGS. 6A-6C), wherein the fourth workout suggestion corresponds to a fourth workout, and the fourth workout suggestion is selected for inclusion in the first scrollable region based on the fourth workout being selected as a next workout in the first multi-workout workout plan (e.g., according to parameters and/or selection criteria of the first multi-workout workout plan), and wherein the fourth workout suggestion, when selected, causes the computer system to initiate a process for playback of the fourth workout; and in accordance with a determination that the user of the computer system is not participating in a multi-workout workout plan (e.g., the user of the computer system has not created a multi-workout workout plan and/or has not provided parameters and/or selection criteria for a multi-workout workout plan), displaying a plan creation recommendation (e.g., 610b in FIG. 6L and/or FIG. 6O) that recommends that the user create a multi-workout workout plan, wherein the plan creation recommendation, when selected, causes the computer system to initiate a process for creating a new multi-workout workout plan (e.g., defining, providing parameters for, and/or providing selection criteria for a multi-workout workout plan). Displaying, within the first scrollable region, a workout suggestion corresponding to a next workout in the user's current multi-workout workout plan provides the user with an indication of a current state of the computer system (e.g., the system has selected the workout suggestion as a next workout in the workout plan) and allows the user to access the next workout with fewer inputs. Displaying, within the first scrollable region, a plan creation recommendation when the user is not participating in a workout plan provides the user with an indication of a current state of the computer system (e.g., the computer system does not currently have record of an active workout plan for the user, but is able to create a workout plan for the user), and also allows the user to create a workout plan with fewer inputs. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, while displaying the fourth workout suggestion within the first portion of the first scrollable region (e.g., 610b in FIG. 6C), the computer system detects, via the one or more input devices, a selection input (e.g., one or more user inputs) (e.g., one or more touch inputs, one or more hardware control inputs, one or more button presses, one or more rotational inputs, one or more gesture inputs, and/or one or more spoken inputs) corresponding to selection of the fourth workout suggestion. In response to detecting the selection input corresponding to selection of the fourth workout suggestion, the computer system initiates playback of the fourth workout (e.g., displaying visual content and/or outputting audio content corresponding to the fourth workout (e.g., visual content that provides a visual demonstration of and/or visual instructions on how to perform the fourth workout) (e.g., audio content that provides audio instruction of how to perform the fourth workout)). Displaying, within the first scrollable region, a workout suggestion corresponding to a next workout in the user's current multi-workout workout plan provides the user with an indication of a current state of the computer system (e.g., the system has selected the workout suggestion as a next workout in the workout plan) and allows the user to access the next workout with fewer inputs. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, while displaying the plan creation recommendation (e.g., 610b in FIG. 6L) within the first portion of the first scrollable region, the computer system detects, via the one or more input devices, a selection input (e.g., one or more user inputs) (e.g., one or more touch inputs, one or more hardware control inputs, one or more button presses, one or more rotational inputs, one or more gesture inputs, and/or one or more spoken inputs) corresponding to selection of the plan creation recommendation. In response to detecting the selection input corresponding to selection of the plan creation recommendation, the computer system displays, via the one or more display generation components, a plan creation user interface for creating a new multi-workout workout plan, wherein the plan creation user interface includes one or more of: a set of workout modality options (e.g., two or more workout modality options corresponding to two or more workout modalities) that are selectable to define one or more workout modalities to be included in the new multi-workout workout plan; a set of workout frequency options that are selectable to define the frequency of workouts in the new multi-workout workout plan (e.g., a set of workout frequency options that define how many workouts are to be performed per week and/or per month in the multi-workout workout plan); and a set of workout duration options that are selectable to define the duration of workouts to be included in the new multi-workout workout plan (e.g., how many minutes workouts in the multi-workout workout plan should be) (e.g., in some embodiments, selection of platter 610b and/or option 610b-5 in FIG. 6L (and/or when platter 610b is displayed within region 610) causes computer system 600 to display a user interface that allows the user to specify one or more parameters of a new multi-workout workout plan). Displaying, within the first scrollable region, a plan creation recommendation when the user is not participating in a workout plan provides the user with an indication of a current state of the computer system (e.g., the computer system does not currently have record of an active workout plan for the user, but is able to create a workout plan for the user), and also allows the user to create a workout plan with fewer inputs. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, the set of workout frequency options includes a set of workout day options that correspond to the days of the week, including: a first workout day option that corresponds to a first day of the week (e.g., Monday, Tuesday, Wednesday, Thursday, Friday, Saturday, or Sunday); a second workout day option that corresponds to a second day of the week different from the first day of the week; and a third workout day option that corresponds to a third day of the week different from the first day of the week and the second day of the week. In some embodiments, selection of platter 610b and/or option 610b-5 in FIG. 6L (and/or when platter 610b is displayed within region 610) causes computer system 600 to display a user interface that allows the user to specify one or more parameters of a new multi-workout workout plan, including the days of the week that the user would like to schedule workouts in the new multi-workout workout plan. In some embodiments, the workout creation user interface allows the user to specify on which days of the week (e.g., Monday, Tuesday, Wednesday, Thursday, Friday, Saturday and/or Sunday) the user would like to perform a workout in the new multi-workout workout plan. Displaying various options for a user to create and/or define a new multi-workout workout plan allows the user to create a workout plan with fewer inputs. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, the workout history of the user of the computer system includes one or more previously completed workouts that correspond to a first workout type (e.g., a first workout modality and/or a first workout category (e.g., HIIT, strength, yoga, core, upper body, lower body, pilates, kickboxing, and/or cycling)); and the first workout suggestion is selected for inclusion in the first user interface based on the workout history of user of the computer system including one or more previously completed workouts that correspond to the first workout type and the first workout suggestion corresponding to the first workout type (e.g., the first workout suggestion is selected for inclusion in the first user interface based on the first workout suggestion having a workout type that matches the workout type of one or more workouts the user has previously selected and/or completed) (e.g., workout recommendations 612a-612c are selected based on those workouts being HIIT workouts; workout recommendations 618a-618b are selected based on those workouts being yoga workouts; and/or workout recommendations 620a-620c are selected based on those workouts being strength workouts). Displaying workout suggestions based on the workout history of the user allows the user to access a variety of workout suggestions that have a higher likelihood of being of interest to the user. Doing so also allows the user to access workouts with fewer inputs. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, the workout history of the user of the computer system includes one or more previously completed workouts that correspond to a first trainer (e.g., that were taught by and/or demonstrated by a first trainer); and the first workout suggestion is selected for inclusion in the first user interface based on the workout history of the user of the computer system including one or more previously completed workouts that correspond to the first trainer and the first workout suggestion corresponding to the first trainer (e.g., the first workout suggestion is selected for inclusion in the first user interface based on the first workout suggestion having a trainer that matches the trainer of one or more workouts the user has previously selected and/or completed) (e.g., workout recommendations 612a-612c are selected based on those workouts being taught by instructor Kim or instructor Bakari; workout recommendations 618a-618b are selected based on those workouts being taught by instructor Jess or instructor Casay; and/or workout recommendations 620a-620c are selected based on those workouts being taught by instructor Brock). Displaying workout suggestions based on the workout history of the user allows the user to access a variety of workout suggestions that have a higher likelihood of being of interest to the user. Doing so also allows the user to access workouts with fewer inputs. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, the workout history of the user of the computer system includes one or more previously completed workouts that correspond to a first duration (e.g., a length and/or time duration of the workout); and the first workout suggestion is selected for inclusion in the first user interface based on the workout history of the user of the computer system including one or more previously completed workouts that correspond to the first duration and the first workout suggestion corresponding to the first duration (e.g., the first workout suggestion is selected for inclusion in the first user interface based on the first workout suggestion having a duration that matches the duration of one or more workouts the user has previously selected and/or completed) (e.g., workout recommendations 612a-612c are selected based on those workouts being 10 minute workouts; workout recommendations 618a-618b are selected based on those workouts being 10 minute workouts; and/or workout recommendations 620a-620c are selected based on those workouts being 20 minute workouts). Displaying workout suggestions based on the workout history of the user allows the user to access a variety of workout suggestions that have a higher likelihood of being of interest to the user. Doing so also allows the user to access workouts with fewer inputs. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, the workout history of the user of the computer system includes one or more previously completed workouts that correspond to a first music type (e.g., music genre, band, and/or artist) (e.g., a first music type for music being played during the workout); and the first workout suggestion is selected for inclusion in the first user interface based on the workout history of the user of the computer system including one or more previously completed workouts that correspond to the first music type and the first workout suggestion corresponding to the first music type (e.g., the first workout suggestion is selected for inclusion in the first user interface based on the first workout suggestion corresponding to a music type that matches the music type of one or more workouts the user has previously selected and/or completed) (e.g., workout recommendations 612a-612c are selected based on those workouts being set to Pure Dance music). Displaying workout suggestions based on the workout history of the user allows the user to access a variety of workout suggestions that have a higher likelihood of being of interest to the user. Doing so also allows the user to access workouts with fewer inputs. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, the first user interface (e.g., 608) is scrollable in a second direction different from the first direction (e.g., in some embodiments, the first scrollable region is not scrollable in the second direction). In some embodiments, while concurrently displaying the first scrollable region (e.g., 610) and the first workout suggestion (e.g., 612a, 612b, and/or 612c), the computer system detects, via the one or more input devices, a navigation input (e.g., one or more user inputs) (e.g., one or more touch inputs, one or more hardware control inputs, one or more button presses, one or more rotational inputs, one or more gesture inputs, and/or one or more spoken inputs) corresponding to a user request to scroll the first user interface in the second direction (e.g., user input 616). In response to detecting the navigation input: the computer system displays scrolling of the first user interface to display one or more additional sections of the first user interface that were not displayed prior to detecting the navigation input, including a first section that includes a first set of workout suggestions (e.g., one or more workout suggestions) (e.g., FIGS. 6C-6D). Displaying various workout suggestions for selection by a user allows a user to access various workouts with fewer user inputs. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, the first set of workout suggestions (e.g., 612a-612c, 618a-618c, and/or 620a-620c) is selected for inclusion in the first section (e.g., 612, 618, and/or 620) based on a first set of selection criteria pertaining to the workout history of the user (e.g., selected for inclusion in the first section based on one or more of: workout type, trainer, workout duration, and/or music type, wherein the workout type, trainer, workout duration, and/or music type is determined based on previous workouts completed by the user). Displaying various workout suggestions for selection by a user allows a user to access various workouts with fewer user inputs. Displaying workout suggestions based on the workout history of the user increases the likelihood that the user will be presented with workout suggestions that are of interest to the user. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, the one or more additional sections of the first user interface includes a second section (e.g., 612, 618, and/or 620) different from the first section (e.g., 612, 618, and/or 620) and that includes a second set of workout suggestions (e.g., 612a-612c, 618a-618c, and/or 620a-620c) different from the first set of workout suggestions (e.g., 612a-612c, 618a-618c, and/or 620a-620c). In some embodiments, the second set of workout suggestions is selected for inclusion in second first section based on a second set of selection criteria (e.g., selected for inclusion in the second section based on one or more of: workout type, trainer, workout duration, and/or music type, wherein the workout type, trainer, workout duration, and/or music type is determined based on previous workouts completed by the user), wherein the second set of selection criteria is different from the first set of selection criteria (e.g., selection criteria are different for each section 612, 618, and/or 620). Displaying various workout suggestions for selection by a user allows a user to access various workouts with fewer user inputs. Displaying workout suggestions based on the workout history of the user increases the likelihood that the user will be presented with workout suggestions that are of interest to the user. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, the one or more additional sections of the first user interface (e.g., 608) includes a workout types section (e.g., 624), wherein: the workout types section includes a plurality of workout type options (e.g., 624a-624d) corresponding to different workout types (e.g., a plurality of workout modalities and/or a plurality of workout categories (e.g., HIIT, strength, yoga, core, upper body, lower body, pilates, kickboxing, and/or cycling)), including: a first workout type option (e.g., 624a, 624b, 624c, and/or 624d) corresponding to a first workout type, wherein the first workout type option, when selected, causes the computer system to display a first plurality of workout suggestions that correspond to the first workout type; and a second workout type option (e.g., 624a, 624b, 624c, and/or 624d) corresponding to a second workout type different from the first workout type, wherein the second workout type option, when selected, causes the computer system to display a second plurality of workout suggestions that correspond to the second workout type (e.g., a second plurality of workout suggestions different from the first plurality of workout suggestions). Displaying workout type suggestions for selection by a user allows a user to access various workouts with fewer user inputs. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, the plurality of workout type options (e.g., 624a-624d) are displayed in a first order (e.g., in a first sequence and/or in a first display arrangement); and the first order is determined based on the workout history of the user of the computer system. In some embodiments, the workout type options are ordered based on how many workouts the user has previously completed that correspond to each workout type (e.g., the workout type that has been performed by the user the most is displayed first (e.g., at the left and/or at the top), the workout type that has been performed by the user the second most is displayed second (e.g., to the right or below the first workout type), and so forth). Displaying workout type suggestions for selection by a user allows a user to access various workouts with fewer user inputs. Displaying workout type suggestions based on the workout history of the user increases the likelihood that the user will be presented with workout suggestions that are of interest to the user. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, the one or more additional sections of the first user interface includes a trainers section (e.g., 628), wherein: the trainers section includes a plurality of trainer options (e.g., 628a-628d) corresponding to different trainers (e.g., instructors and/or teachers), including: a first trainer option (e.g., 628a, 628b, 628c, and/or 628d) corresponding to a first trainer, wherein the first trainer option, when selected, causes the computer system to display a first plurality of workout suggestions that correspond to the first trainer; and a second trainer option (e.g., 628a, 628b, 628c, and/or 628d) corresponding to a second trainer different from the first trainer, wherein the second trainer option, when selected, causes the computer system to display a second plurality of workout suggestions that correspond to the second trainer (e.g., a second plurality of workout suggestions different from the first plurality of workout suggestions). Displaying trainer suggestions for selection by a user allows a user to access various workouts corresponding to certain trainers with fewer user inputs. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, the plurality of trainer options (e.g., 628a-628d) are displayed in a second order (e.g., in a second sequence and/or in a second display arrangement); and the second order is determined based on the workout history of the user of the computer system. In some embodiments, the trainer options are ordered based on how many workouts the user has previously completed that correspond to each trainer (e.g., the trainer that has taught the most workouts performed by the user is displayed first (e.g., at the left and/or at the top), the trainer that has taught the second most workouts performed by the user is displayed second (e.g., to the right or below the first workout type), and so forth). Displaying trainer suggestions for selection by a user allows a user to access various workouts corresponding to certain trainers with fewer user inputs. Displaying trainer suggestions based on the workout history of the user increases the likelihood that the user will be presented with workout suggestions and/or trainer suggestions that are of interest to the user. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, the one or more additional sections of the first user interface includes an achievements section (e.g., 632) that includes a representation of a first workout achievement (e.g., 632a, 632b, and/or 632c), wherein the first workout achievement corresponds to a first set of workout goals (e.g., the first workout achievement is accomplished and/or satisfied by completing the first set of workout goals). In some embodiments, the achievements section includes a representation of a second workout achievement different from the first workout achievement, wherein the second workout achievement corresponds to a second set of workout goals different from the first set of workout goals. Displaying representations of different workout achievements provides the user with visual feedback about a state of the system (e.g., that the system is tracking the user's advancement towards these workout achievements and/or workout goals).

In some embodiments, the representation of the first workout achievement (e.g., 632a, 632b, and/or 632c), when selected, causes the computer system to display a first set of workout suggestions (e.g., one or more workout suggestions), wherein the first set of workout suggestions is selected based on the first set of workout goals corresponding to the first workout achievement (e.g., workout suggestions are selected for inclusion in the first set of workout suggestions based on a determination that the workout suggestions would progress the user towards accomplishing the first set of workout goals (and, in some embodiments, one or more workout suggestions are excluded from the first set of workout suggestions and/or are not displayed based on a determination that the one or more excluded workout suggestions would not progress the user towards accomplishing the first set of workout goals)). In some embodiments, while displaying the representation of the first workout achievement, the computer system detects one or more user inputs corresponding to selection of the representation of the first workout achievement. In response to detecting the one or more user inputs corresponding to selection of the representation of the first workout achievement, the computer system displays the first set of workout suggestions that are selected based on the first set of workout goals (e.g., without displaying workout suggestions that are not in the first set of workout suggestions). In some embodiments, the achievements section includes a representation of a second workout achievement (e.g., 632a, 632b, and/or 632c) different from the first workout achievement, wherein the second workout achievement corresponds to a second set of workout goals different from the first set of workout goals. In some embodiments, the representation of the second workout achievement, when selected, causes the computer system to display a second set of workout suggestions (e.g., one or more workout suggestions) different from the first set of workout suggestions, wherein the second set of workout suggestions is selected based on the second set of workout goals corresponding to the second workout achievement (e.g., workout suggestions are selected for inclusion in the second set of workout suggestions based on a determination that the workout suggestions would progress the user towards accomplishing the second set of workout goals (and, in some embodiments, one or more workout suggestions are excluded from the second set of workout suggestions and/or are not displayed based on a determination that the one or more excluded workout suggestions would not progress the user towards accomplishing the second set of workout goals)). In some embodiments, while displaying the representation of the second workout achievement, the computer system detects one or more user inputs corresponding to selection of the representation of the second workout achievement. In response to detecting the one or more user inputs corresponding to selection of the representation of the second workout achievement, the computer system displays the second set of workout suggestions that are selected based on the second set of workout goals (e.g., without displaying workout suggestions that are not in the second set of workout suggestions). Displaying representations of different workout achievements provides the user with visual feedback about a state of the system (e.g., that the system is tracking the user's advancement towards these workout achievements and/or workout goals). Furthermore, allowing the user to select a representation of a workout achievement to view workout suggestions corresponding to the workout achievement allows the user to access workout suggestions with fewer user inputs. Doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, the computer system displays concurrently with the first user interface (e.g., 608), a first user interface object (e.g., 604a) (e.g., a first tab and/or first object) and a second user interface object (e.g., 604b) (e.g., a second tab and/or second object) distinct from (e.g., different from and/or separate from) the first user interface object, wherein: the first user interface object corresponds to the first user interface and, when selected, causes the computer system to display the first user interface; and the second user interface object corresponds to a second user interface (e.g., 640) different from the first user interface and, when selected, causes the computer system to display the second user interface (e.g., without displaying the first user interface), wherein the second user interface includes a second plurality of workout suggestions (e.g., 640b-2 through 640b-5 and/or 640c-1 through 640c-4) (e.g., in some embodiments, user interface 640 displays workout recommendations in place of options 640b-2 through 640b-5 and/or options 640c-1 through 640c-4) that are selected for inclusion in the second user interface without regard for the workout history of the user of the computer system (e.g., a second plurality of workout suggestions that are selected for all users of an application and/or for a group of users without regard for their workout histories). Providing the user with different user interface objects that are selectable to display different sets of workout suggestions allows the user to access a greater variety of workout suggestions with fewer user inputs.

Note that details of the processes described above with respect to method 700 (e.g., FIG. 7) are also applicable in an analogous manner to the methods described below. For example, method 800, method 900, and/or method 1100 optionally includes one or more of the characteristics of the various methods described above with reference to method 700. For example, the first user interface recited in method 700 is the first user interface recited in method 800 and/or method 900; and/or the first user interface recited in methods 700-900 and the workout sharing user interface recited in method 1100 are accessible via the same application. For brevity, these details are not repeated below.

FIG. 8 is a flow diagram illustrating a method for presenting workout content using a computer system in accordance with some embodiments. Method 800 is performed at a computer system (e.g., 100, 300, 500, and/or 600) (e.g., a smart phone, a smart watch, a tablet, a laptop, a desktop, a wearable device, wrist-worn device, and/or head-mounted device) that is in communication with one or more display generation components (e.g., 602) (e.g., a display, a touch-sensitive display, and/or a display controller) and one or more input devices (e.g., 602) (e.g., a touch-sensitive surface, a touch-sensitive display, a button, a rotatable input mechanism, a depressible and rotatable input mechanism, a camera, an accelerometer, an inertial measurement unit (IM U), a heartrate sensor, a body temperature sensor, and/or a blood-oxygen level sensor). Some operations in method 800 are, optionally, combined, the orders of some operations are, optionally, changed, and some operations are, optionally, omitted.

As described below, method 800 provides an intuitive way for presenting workout content. The method reduces the cognitive burden on a user for accessing workout content, thereby creating a more efficient human-machine interface. For battery-operated computing devices, enabling a user to access workout content faster and more efficiently conserves power and increases the time between battery charges.

In some embodiments, the computer system (e.g., 600) concurrently displays (802), via the one or more display generation components (e.g., 602): a first user interface object (e.g., 604a) (e.g., a first button, a first tab, and/or a first affordance) that corresponds to a first user interface (e.g., 608) (e.g., a first user interface object that, when selected, causes the computer system to display the first user interface); and a second user interface object (e.g., 604b) (e.g., a second button, a second tab, and/or a second affordance) that corresponds to a second user interface (e.g., 640) different from the first user interface (e.g., a second user interface object that, when selected, causes the computer system to display the second user interface). While concurrently displaying the first user interface object and the second user interface object, the computer system detects (804), via the one or more input devices, a first user input (e.g., one or more user inputs) (e.g., one or more touch inputs, one or more hardware control inputs, one or more button presses, one or more rotational inputs, one or more gesture inputs, and/or one or more spoken inputs), In response to detecting the first user input (806): in accordance with a determination that the first user input corresponds to the first user interface object (e.g., 604a), the computer system displays (808), via the one or more display generation components, the first user interface (e.g., 608) (e.g., without displaying the second user interface), wherein the first user interface includes a first plurality of workout suggestions (e.g., 612a-612c, 618a-618c, and/or 620a-620c) that are selected (e.g., automatically selected by one or more computer systems) for inclusion in the first user interface based on a workout history of a user of the computer system (e.g., one or more workout suggestions that are selected to match one or more of: a workout type, a workout duration, a workout trainer, and/or a workout music type of one or more workouts previously completed by the user of the computer system), including a first workout suggestion that is selected (e.g., automatically selected by one or more computer systems) for inclusion in the first user interface based on the workout history of the user of the computer system and that, when selected, causes the computer system to initiate a process for playback of a first workout corresponding to the first workout suggestion; and in accordance with a determination that the first user input corresponds to selection of the second user interface object, the computer system displays (810), via the one or more display generation components, the second user interface (e.g., 640) (e.g., without displaying the first user interface), wherein the second user interface includes a second plurality of workout suggestions (e.g., 640b-2 through 640b-5 and/or 640c-1 through 640c-4) different from the first plurality of workout suggestions, and that are selected (e.g., automatically selected by one or more computer systems and/or manually selected by one or more people) for inclusion in the second user interface without regard for the workout history of the user of the computer system (e.g., without consideration of the workout history of the user of the computer system and/or that are selected based on criteria that do not include criteria pertaining to the workout history of the user of the computer system), including a second workout suggestion that is selected (e.g., automatically selected by one or more computer systems and/or manually selected by one or more people) for inclusion in the second user interface without regard for the workout history of the user of the computer system and that, when selected, causes the computer system to initiate a process for playback of a second workout corresponding to the second workout suggestion (in some embodiments, options 640b-2 through 640b-5 and/or 640c-1 through 640c-4 represent individual workouts and, when selected, cause computer system 600 to initiate playback of the selected workout (e.g., rather than representing workout modalities and/or multiple workouts, as is shown in FIG. 6H)). In some embodiments, a workout suggestion corresponds to (e.g., represents) a workout (e.g., audio and/or video content that guides a user to perform a physical activity). In some embodiments, selecting a workout suggestion initiates a process for playback of a workout corresponding to the workout suggestion. In some embodiments, the second plurality of workout suggestions is selected by an entity and/or by a computer system without consideration of and/or regard for the workout history of the user. In some embodiments, a workout suggestion corresponds to (e.g., represents) a workout (e.g., audio and/or video content that guides a user to perform a physical activity). In some embodiments, selecting a workout suggestion initiates a process for playback of a workout corresponding to the workout suggestion. In some embodiments, the second user interface does not include the first workout suggestion. In some embodiments, the first user interface does not include the second workout suggestion. In some embodiments, the second user interface does not include any of the first plurality of workout suggestions. In some embodiments, the first user interface does not include any of the second plurality of workout suggestions. In some embodiments, the first user interface does not include any workout suggestions that are selected without regard for the workout history of the user. In some embodiments, the second user interface does not include any workout suggestions that are selected with regard for the workout history of the user of the computer system. Providing the user with different user interface objects that are selectable to display different sets of workout suggestions allows the user to access a greater variety of workout suggestions with fewer user inputs. Doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, the computer system displays, at a first time, the second user interface (e.g., 640 in FIG. 6H), including displaying the second workout suggestion in a first region of the second user interface (e.g., 640a in FIG. 6H); and displays, at a second time, the second user interface (e.g., FIG. 6H1), including displaying a third workout suggestion different from the second workout suggestion in the first region of the second user interface (e.g., 640a in FIG. 6H1), wherein the third workout suggestion is selected for display in the second user interface without regard for the workout history of the user. In some embodiments, the second user interface changes over time such that the second user interface displays different workout suggestions at different times (e.g., on different days or from week to week). Providing the user with different user interface objects that are selectable to display different sets of workout suggestions allows the user to access a greater variety of workout suggestions with fewer user inputs. Doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, the second user interface (e.g., 640) includes a new workouts section (e.g., 640b) that includes a first set of workout suggestions (e.g., one or more workout suggestions), wherein the first set of workout suggestions are selected for inclusion in the new workouts section of the second user interface based on a release date of the first set of workout suggestions (e.g., based on the date on which the first set of workout suggestions is released, published, and/or made publicly available) (e.g., in some embodiments, the first set of workout suggestions represents a set of new workouts that has been released within the last day, the last week, and/or the last month) (e.g., in some embodiments, rather than showing modality options 640b-2 through 640b-5 in section 640b, section 640b displays workout recommendations for new workouts). In some embodiments, the first set of workout suggestions are selected for inclusion in the second user interface based on their release date (e.g., based on the workouts being recently released), and not based on a workout history of the user of the computer system. Providing the user with different user interface objects that are selectable to display different sets of workout suggestions allows the user to access a greater variety of workout suggestions with fewer user inputs. Doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, the second user interface (e.g., 640) includes a popular workouts section (e.g., 640c) that includes a second set of workout suggestions (e.g., one or more workout suggestions), wherein the second set of workout suggestions are selected for inclusion in the popular workouts section of the second user interface based on the number of users (e.g., the number of users of a fitness application and/or service) that have completed the second set of workout suggestions (e.g., in some embodiments, the second set of workout suggestions represents a set of popular workouts that is selected based on a determination that a threshold number of users have selected and/or completed the workouts and/or based on a determination that the second set of workout suggestions are among the x most popular workouts (e.g., on a fitness application and/or a fitness service) (e.g., over the last day, the last week, the last month, the last three months, the last six months, or the last year)) (in some embodiments, rather than showing modality options 640c-1 through 640c-4 in section 640c, section 640 includes popular workout recommendations). In some embodiments, the second set of workout suggestions are selected for inclusion in the second user interface based on their popularity among other users, and not based on a workout history of the user of the computer system. Providing the user with different user interface objects that are selectable to display different sets of workout suggestions allows the user to access a greater variety of workout suggestions with fewer user inputs. Doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, the second user interface (e.g., 640) includes an artist spotlight section (e.g., 640a) that includes a third set of workout suggestions (e.g., one or more workout suggestions), wherein the third set of workout suggestions are selected based on the third set of workout suggestions being associated with a first musical artist (e.g., Scott Grace in FIG. 6H and/or Lindsay Gray in FIG. 6H1) (e.g., a solo artist, a musical group, and/or a band) (e.g., based on a determination that music of the first musical artist is played during each workout of the third set of workout suggestions), wherein the third set of workout suggestions and the first musical artist are selected (e.g., automatically selected by one or more computer systems and/or manually selected by one or more people) without consideration of the workout history of the user of the computer system. In some embodiments, the artist spotlight section highlights a particular musical artist, and presents one or more workout suggestions that are associated with the musical artist (e.g., one or more workouts in which music by the musical artist is played). Providing the user with different user interface objects that are selectable to display different sets of workout suggestions allows the user to access a greater variety of workout suggestions with fewer user inputs. Doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, the first user interface (e.g., 608) includes a first section (e.g., 612, 618, and/or 620) that includes a first set of workout suggestions (e.g., 612a-612c, 618a-618c, and/or 620a-620c), wherein the first set of workout suggestions is selected for inclusion in the first section of the first user interface (e.g., automatically selected by one or more computer systems) based on a first set of selection criteria pertaining to the workout history of the user (e.g., selected for inclusion in the first section of the first user interface based on one or more of: workout type, trainer, workout duration, and/or music type, wherein the workout type, trainer, workout duration, and/or music type is determined based on previous workouts completed by the user). Displaying various workout suggestions for selection by a user allows a user to access various workouts with fewer user inputs. Displaying workout suggestions based on the workout history of the user increases the likelihood that the user will be presented with workout suggestions that are of interest to the user. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, the first user interface (e.g., 608) includes a second section (e.g., 612, 618, and/or 620) that is distinct from the first section (e.g., displayed separately and/or distinguishably from the first section) that includes a second set of workout suggestions (e.g., 612a-612c, 618a-618c, and/or 620a-620c) different from the first set of workout suggestions, wherein the second set of workout suggestions is selected for inclusion in the second section of the first user interface (e.g., automatically selected by one or more computer systems) based on a second set of selection criteria pertaining to the workout history of the user that is different from the first set of selection criteria (e.g., selected for inclusion in the second section of the first user interface based on one or more of: workout type, trainer, workout duration, and/or music type, wherein the workout type, trainer, workout duration, and/or music type is determined based on previous workouts completed by the user). Displaying various workout suggestions for selection by a user allows a user to access various workouts with fewer user inputs. Displaying workout suggestions based on the workout history of the user increases the likelihood that the user will be presented with workout suggestions that are of interest to the user. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, the first user interface (e.g., 608) includes a workout types section (e.g., 624), wherein: the workout types section includes a plurality of workout type options (e.g., 624a-624d) corresponding to different workout types (e.g., a plurality of workout modalities and/or a plurality of workout categories (e.g., HIIT, strength, yoga, core, upper body, lower body, pilates, kickboxing, and/or cycling)), including: a first workout type option (e.g., 624a, 624b, 624c, and/or 624d) corresponding to a first workout type, wherein the first workout type option, when selected, causes the computer system to display a first plurality of workout suggestions that correspond to the first workout type; and a second workout type option (e.g., 624a, 624b, 624c, and/or 624d) corresponding to a second workout type different from the first workout type, wherein the second workout type option, when selected, causes the computer system to display a second plurality of workout suggestions that correspond to the second workout type (e.g., a second plurality of workout suggestions different from the first plurality of workout suggestions). Displaying workout type suggestions for selection by a user allows a user to access various workouts with fewer user inputs. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, the plurality of workout type options (e.g., 624a-624d) are displayed in a first order (e.g., in a first sequence and/or in a first display arrangement); and the first order is determined based on the workout history of the user of the computer system. In some embodiments, the workout type options are ordered based on how many workouts the user has previously completed that correspond to each workout type (e.g., the workout type that has been performed by the user the most is displayed first (e.g., at the left and/or at the top), the workout type that has been performed by the user the second most is displayed second (e.g., to the right or below the first workout type), and so forth). Displaying workout type suggestions for selection by a user allows a user to access various workouts with fewer user inputs. Displaying workout type suggestions based on the workout history of the user increases the likelihood that the user will be presented with workout suggestions that are of interest to the user. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, the first user interface includes a trainers section (e.g., 628), wherein: the trainers section includes a plurality of trainer options (e.g., 628a-628d) corresponding to different trainers (e.g., instructors and/or teachers), including: a first trainer option corresponding to a first trainer, wherein the first trainer option, when selected, causes the computer system to display a first plurality of workout suggestions that correspond to the first trainer; and a second trainer option corresponding to a second trainer different from the first trainer, wherein the second trainer option, when selected, causes the computer system to display a second plurality of workout suggestions that correspond to the second trainer (e.g., a second plurality of workout suggestions different from the first plurality of workout suggestions). Displaying trainer suggestions for selection by a user allows a user to access various workouts corresponding to certain trainers with fewer user inputs. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, the plurality of trainer options (e.g., 628a-628d) are displayed in a second order (e.g., in a second sequence and/or in a second display arrangement); and the second order is determined based on the workout history of the user of the computer system. In some embodiments, the trainer options are ordered based on how many workouts the user has previously completed that correspond to each trainer (e.g., the trainer that has taught the most workouts performed by the user is displayed first (e.g., at the left and/or at the top), the trainer that has taught the second most workouts performed by the user is displayed second (e.g., to the right or below the first workout type), and so forth). Displaying trainer suggestions for selection by a user allows a user to access various workouts corresponding to certain trainers with fewer user inputs. Displaying trainer suggestions based on the workout history of the user increases the likelihood that the user will be presented with workout suggestions and/or trainer suggestions that are of interest to the user. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, the one or more additional sections of the first user interface includes an achievements section (e.g., 632) that includes a representation of a first workout achievement (e.g., 632a, 632b, and/or 632c), wherein the first workout achievement corresponds to a first set of workout goals (e.g., the first workout achievement is accomplished and/or satisfied by completing the first set of workout goals). In some embodiments, the achievements section includes a representation of a second workout achievement different from the first workout achievement, wherein the second workout achievement corresponds to a second set of workout goals different from the first set of workout goals. Displaying representations of different workout achievements provides the user with visual feedback about a state of the system (e.g., that the system is tracking the user's advancement towards these workout achievements and/or workout goals).

In some embodiments, the representation of the first workout achievement (e.g., 632a, 632b, and/or 632c), when selected, causes the computer system to display a first set of workout suggestions (e.g., one or more workout suggestions), wherein the first set of workout suggestions is selected based on the first set of workout goals corresponding to the first workout achievement (e.g., workout suggestions are selected for inclusion in the first set of workout suggestions based on a determination that the workout suggestions would progress the user towards accomplishing the first set of workout goals (and, in some embodiments, one or more workout suggestions are excluded from the first set of workout suggestions and/or are not displayed based on a determination that the one or more excluded workout suggestions would not progress the user towards accomplishing the first set of workout goals)). In some embodiments, while displaying the representation of the first workout achievement, the computer system detects one or more user inputs corresponding to selection of the representation of the first workout achievement. In response to detecting the one or more user inputs corresponding to selection of the representation of the first workout achievement, the computer system displays the first set of workout suggestions that are selected based on the first set of workout goals (e.g., without displaying workout suggestions that are not in the first set of workout suggestions). In some embodiments, the achievements section includes a representation of a second workout achievement different from the first workout achievement, wherein the second workout achievement corresponds to a second set of workout goals different from the first set of workout goals. In some embodiments, the representation of the second workout achievement, when selected, causes the computer system to display a second set of workout suggestions (e.g., one or more workout suggestions) different from the first set of workout suggestions, wherein the second set of workout suggestions is selected based on the second set of workout goals corresponding to the second workout achievement (e.g., workout suggestions are selected for inclusion in the second set of workout suggestions based on a determination that the workout suggestions would progress the user towards accomplishing the second set of workout goals (and, in some embodiments, one or more workout suggestions are excluded from the second set of workout suggestions and/or are not displayed based on a determination that the one or more excluded workout suggestions would not progress the user towards accomplishing the second set of workout goals)). In some embodiments, while displaying the representation of the second workout achievement, the computer system detects one or more user inputs corresponding to selection of the representation of the second workout achievement. In response to detecting the one or more user inputs corresponding to selection of the representation of the second workout achievement, the computer system displays the second set of workout suggestions that are selected based on the second set of workout goals (e.g., without displaying workout suggestions that are not in the second set of workout suggestions). Displaying representations of different workout achievements provides the user with visual feedback about a state of the system (e.g., that the system is tracking the user's advancement towards these workout achievements and/or workout goals). Furthermore, allowing the user to select a representation of a workout achievement to view workout suggestions corresponding to the workout achievement allows the user to access workout suggestions with fewer user inputs. Doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, the first user interface (e.g., 604) includes a first scrollable region (e.g., 610) that is scrollable in a first direction (e.g., horizontally or vertically). In some embodiments, the computer system displays, within a first portion of the first scrollable region of the first user interface and concurrently with the first workout suggestion (e.g., 612a, 612b, and/or 612c), a third workout suggestion (e.g., 610a) different from the first workout suggestion, wherein the third workout suggestion is selected for inclusion in the first user interface based on the workout history of the user of the computer system and, when selected, causes the computer system to initiate a process for playback of a third workout different from the first workout. While displaying the third workout suggestion within the first portion of the first scrollable region of the first user interface, the computer system detects, via the one or more input devices, a second user input (e.g., 614b) (e.g., one or more user inputs) (e.g., one or more touch inputs, one or more hardware control inputs, one or more button presses, one or more rotational inputs, one or more gesture inputs, and/or one or more spoken inputs). In response to detecting the second user input: in accordance with a determination that the second user input is directed to the first scrollable region, the computer system displays, concurrently with the first workout suggestion, scrolling of the first scrollable region to display, within the first portion of the first scrollable region, a workout plan recommendation (e.g., 610b in FIG. 6C) (e.g., to display replacement of the second workout suggestion with the workout plan recommendation in the first portion of the first scrollable region), wherein: the workout plan recommendation is determined based on the workout history of the user of the computer system; and the workout plan recommendation pertains to a multi-workout workout plan (e.g., a workout plan that includes a plurality of workouts and, in some embodiments, an arranged sequence of a plurality of workouts). In some embodiments, the workout plan recommendation suggests a next workout in an existing and/or active workout plan for the user of the computer system (e.g., in some embodiments, in accordance with a determination that the user of the computer system is associated with an active and/or ongoing workout plan, the workout plan recommendation suggests a next workout in the active and/or ongoing workout plan). In some embodiments, in accordance with a determination that the user of the computer system is not currently associated with an active and/or ongoing workout plan, the workout plan recommendation suggests that the user start and/or create a multi-workout workout plan. Displaying various workout suggestions for selection by a user allows a user to access various workouts with fewer user inputs. Additionally, displaying a workout suggestion and a workout plan recommendation within a scrollable region of the first user interface allows the user to access these recommendations while conserving limited display space. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, displaying the workout plan recommendation within the first portion of the first scrollable region comprises: in accordance with a determination that the user of the computer system is participating in a first multi-workout workout plan (e.g., a current multi-workout workout plan, an active multi-workout workout plan, and/or an ongoing multi-workout workout plan), displaying a fourth workout suggestion (e.g., 610b in FIG. 6C), wherein the fourth workout suggestion corresponds to a fourth workout, and the fourth workout suggestion is selected for inclusion in the first scrollable region based on the fourth workout being selected as a next workout in the first multi-workout workout plan (e.g., according to parameters and/or selection criteria of the first multi-workout workout plan), and wherein the fourth workout suggestion, when selected, causes the computer system to initiate a process for playback of the fourth workout; and in accordance with a determination that the user of the computer system is not participating in a multi-workout workout plan (e.g., the user of the computer system has not created a multi-workout workout plan and/or has not provided parameters and/or selection criteria for a multi-workout workout plan), displaying a plan creation recommendation (e.g., 610b in FIG. 6L) that recommends that the user create a multi-workout workout plan, wherein the plan creation recommendation, when selected, causes the computer system to initiate a process for creating a new multi-workout workout plan (e.g., defining, providing parameters for, and/or providing selection criteria for a multi-workout workout plan). Displaying, within the first scrollable region, a workout suggestion corresponding to a next workout in the user's current multi-workout workout plan provides the user with an indication of a current state of the computer system (e.g., the system has selected the workout suggestion as a next workout in the workout plan) and allows the user to access the next workout with fewer inputs. Displaying, within the first scrollable region, a plan creation recommendation when the user is not participating in a workout plan provides the user with an indication of a current state of the computer system (e.g., the computer system does not currently have record of an active workout plan for the user, but is able to create a workout plan for the user), and also allows the user to create a workout plan with fewer inputs. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, the first user interface (e.g., 604) is scrollable in a second direction different from the first direction (e.g., in some embodiments, the first scrollable region is not scrollable in the second direction). In some embodiments, while concurrently displaying the first scrollable region (e.g., 610) and the first workout suggestion (e.g., 612a, 612b, and/or 612c), the computer system detects, via the one or more input devices, a navigation input (e.g., 616) (e.g., one or more user inputs) (e.g., one or more touch inputs, one or more hardware control inputs, one or more button presses, one or more rotational inputs, one or more gesture inputs, and/or one or more spoken inputs) corresponding to a user request to scroll the first user interface in the second direction. In response to detecting the navigation input, the computer system displays scrolling of the first user interface to display one or more additional sections of the first user interface that were not displayed prior to detecting the navigation input, including a first section that includes a first set of workout suggestions (e.g., one or more workout suggestions) (e.g., FIGS. 6C-6D). Displaying various workout suggestions for selection by a user allows a user to access various workouts with fewer user inputs. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, the computer system concurrently displays, via the one or more display generation components: the first user interface object (e.g., 604a) that corresponds to the first user interface (e.g., 608); the second user interface object (e.g., 604b) that corresponds to the second user interface (e.g., 640); and a third user interface object (e.g., 604c) (e.g., a third button, a third tab, and/or a third affordance) that corresponds to a third user interface (e.g., 644) different from the first user interface and the second user interface. While concurrently displaying the first user interface, the second user interface object, and the third user interface object, the computer system detects, via the one or more input devices, a selection input (e.g., 642) (e.g., one or more user inputs) (e.g., one or more touch inputs, one or more hardware control inputs, one or more button presses, one or more rotational inputs, one or more gesture inputs, and/or one or more spoken inputs) corresponding to selection of the third user interface object. In response to detecting the selection input corresponding to selection of the third user interface object, the computer system displays, via the one or more display generation components, the third user interface (e.g., 644), wherein the third user interface includes representations of a plurality of folders (e.g., 644a, 644b, and/or 644f) (e.g., a plurality of digital storage regions and/or a plurality of digital categorizations), including a representation of a first folder and a representation of a second folder different from the first folder. Providing the user with different user interface objects that are selectable to display different sets of workout suggestions allows the user to access a greater variety of workout suggestions with fewer user inputs. Doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, while displaying the third user interface (e.g., 644), the computer system detects, via the one or more input devices, a selection input (e.g., one or more user inputs) (e.g., one or more touch inputs, one or more hardware control inputs, one or more button presses, one or more rotational inputs, one or more gesture inputs, and/or one or more spoken inputs). In response to detecting the selection input: in accordance with a determination that the selection input corresponds to selection of the representation of the first folder (e.g., 644a, 644b, and/or 644f), the computer system displays, via the one or more display generation components, a first collection of one or more workout suggestions, wherein the first collection of one or more workout suggestions was saved by the user of the computer system into the first folder; and in accordance with a determination that the selection input corresponds to selection of the representation of the second folder (e.g., 644a, 644b, and/or 644f), the computer system displays, via the one or more display generation components, a second collection of one or more workout suggestions different from the first collection of one or more workout suggestions, wherein the second collection of one or more workout suggestions was saved by the user of the computer system into the second folder. Allowing a user to save different workouts into different folders allows the user to access these workouts with fewer inputs. Doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, the computer system concurrently displays, via the one or more display generation components: the first user interface object (e.g., 604a) that corresponds to the first user interface (e.g., 608); the second user interface object (e.g., 604b) that corresponds to the second user interface (e.g., 640); and a fourth user interface object (e.g., 604d) (e.g., a fourth button, a fourth tab, and/or a fourth affordance) that corresponds to a fourth user interface (e.g., 648) different from the first user interface and the second user interface. While concurrently displaying the first user interface, the second user interface object, and the fourth user interface object, the computer system detects, via the one or more input devices, a selection input (e.g., 646) (e.g., one or more user inputs) (e.g., one or more touch inputs, one or more hardware control inputs, one or more button presses, one or more rotational inputs, one or more gesture inputs, and/or one or more spoken inputs) corresponding to selection of the fourth user interface object. In response to detecting the selection input corresponding to selection of the fourth user interface object, the computer system displays, via the one or more display generation components, the fourth user interface (e.g., 648), wherein the fourth user interface includes a search field (e.g., 648a) for searching for workouts. While displaying the fourth user interface, the computer system detects, via the one or more input devices, a search input (e.g., one or more user inputs) (e.g., one or more touch inputs, one or more hardware control inputs, one or more button presses, one or more rotational inputs, one or more gesture inputs, and/or one or more spoken inputs) corresponding to a user request to perform a search based on user-entered search terms. In response to detecting the search term, displaying, via the one or more display generation components, a first set of search results, wherein the first set of search results includes one or more workout suggestions that correspond to (e.g., are responsive to) the user-entered search terms. Allowing a user to search for workouts allows the user to access workouts with fewer inputs. Doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

Note that details of the processes described above with respect to method 800 (e.g., FIG. 8) are also applicable in an analogous manner to the methods described above and/or below. For example, method 700, method 900, and/or method 1100 optionally includes one or more of the characteristics of the various methods described above with reference to method 800. For example, the first user interface recited in method 700 is the first user interface recited in method 800 and/or method 900; and/or the first user interface recited in methods 700-900 and the workout sharing user interface recited in method 1100 are accessible via the same application. For brevity, these details are not repeated below.

FIG. 9 is a flow diagram illustrating a method for presenting workout content using a computer system in accordance with some embodiments. Method 900 is performed at a computer system (e.g., 100, 300, 500, and/or 600) (e.g., a smart phone, a smart watch, a tablet, a laptop, a desktop, a wearable device, wrist-worn device, and/or head-mounted device) that is in communication with one or more display generation components (e.g., 602) (e.g., a display, a touch-sensitive display, and/or a display controller) and one or more input devices (e.g., 6002) (e.g., a touch-sensitive surface, a touch-sensitive display, a button, a rotatable input mechanism, a depressible and rotatable input mechanism, a camera, an accelerometer, an inertial measurement unit (IM U), a heartrate sensor, a body temperature sensor, and/or a blood-oxygen level sensor). Some operations in method 900 are, optionally, combined, the orders of some operations are, optionally, changed, and some operations are, optionally, omitted.

As described below, method 900 provides an intuitive way for presenting workout content. The method reduces the cognitive burden on a user for accessing workout content, thereby creating a more efficient human-machine interface. For battery-operated computing devices, enabling a user to access workout content faster and more efficiently conserves power and increases the time between battery charges.

In some embodiments, the computer system detects (902), via the one or more input devices, a first user input (e.g., one or more user inputs) (e.g., one or more touch inputs, one or more hardware control inputs, one or more button presses, one or more rotational inputs, one or more gesture inputs, and/or one or more spoken inputs) corresponding to a user request to display a first user interface (e.g., 608) of a first workout application. In response to detecting the first user input, the computer system displays (904), via the one or more display generation components, the first user interface (e.g., 608) of the first workout application, wherein the first user interface includes (e.g., in some embodiments, include concurrently displaying) a plurality of workout suggestions (e.g., 612a-612c, 618a-618c, and/or 620a-620c), and further wherein: in accordance with a determination that a user of the computer system has completed a threshold number of workouts in the first workout application (906) (e.g., one or more workouts, two or more workouts, three or more workouts, five or more workouts, or ten or more workouts), the first user interface includes a first type of workout suggestion (e.g., a first category of workout suggestion and/or a first workout suggestion that is selected based on a first set of criteria) that includes a first set of workout suggestions that are selected for inclusion in the first user interface based on a workout history of a user of the computer system in the first workout application (e.g., one or more workout suggestions that are selected to match one or more of: a workout type, a workout duration, a workout trainer, and/or a workout music type of one or more workouts previously completed by the user of the computer system within the first workout application) (e.g., 626a-626b); and in accordance with a determination that the user of the computer system has not completed the threshold number of workouts in the first workout application and has completed one or more workouts in one or more other workout applications different from the first workout application (908): the first user interface does not include the first type of workout suggestion (e.g., in FIGS. 6O-6Q, user interface 608 does not include section 626); and the first user interface includes a second set of workout suggestions that are selected for inclusion in the first user interface based on a workout history of the user in the one or more other workout applications different from the first workout application (e.g. in some embodiments, 660a-660c, 664a-664c, and/or 668a-668c are selection for inclusion in user interface 608 based on the user's workout history in one or more other application). In some embodiments, a workout suggestion corresponds to (e.g., represents) a workout (e.g., audio and/or video content that guides a user to perform a physical activity). In some embodiments, selecting a workout suggestion initiates a process for playback of a workout corresponding to the workout suggestion. Displaying workout suggestions based on the workout history of the user allows the user to access a variety of workout suggestions that have a higher likelihood of being of interest to the user. Doing so also allows the user to access workouts with fewer inputs. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, the first type of workout suggestion is a trainer-based workout suggestion, the workout history of the user of the computer system in the first workout application includes one or more previously completed workouts that correspond to a first trainer (e.g., that were taught by and/or demonstrated by a first trainer); and the first set of workout suggestions is selected for inclusion in the first user interface based on the workout history of the user of the computer system in the first workout application including one or more previously completed workouts that correspond to the first trainer and the first set of workout suggestions corresponding to the first trainer (e.g., the first set of workout suggestions is selected for inclusion in the first user interface based on the first set of workout suggestions having a trainer that matches the trainer of one or more workouts the user has previously selected and/or completed in the first workout application) (e.g., in FIG. 6D, workout suggestions 620a-620c are selected for inclusion in user interface 608 at least in part based on the workout history of the user indicating that the user completed one or more workouts taught by Instructor Brock). In some embodiments, in accordance with a determination that the user of the computer system has completed the threshold number of workouts in the first workout application, the first user interface includes trainer-based workout suggestions. In some embodiments, in accordance with a determination that the user of the computer system has not completed the threshold number of workouts in the first workout application (and, optionally, has completed one or more workouts in one or more other workout applications different from the first workout application), the first user interface does not include trainer-based workout suggestions. In some embodiments, displaying the first user interface further includes: in accordance with a determination that the user of the computer system has completed the threshold number of workouts in the first workout application, displaying, within the first user interface, one or more trainer-based workout suggestions that correspond to a first trainer and that are selected for inclusion in the first user interface based on the workout history of the user of the computer system in the first workout application include one or more previously completed workouts that correspond to the first trainer and the one or more trainer-based workout suggestions corresponding to the first trainer (e.g., in FIG. 6D, workout suggestions 620a-620c are selected for inclusion in user interface 608 at least in part based on the workout history of the user indicating that the user completed one or more workouts taught by Instructor Brock); and in accordance with a determination that the user of the computer system has not completed the threshold number of workouts in the first workout application (and, optionally, has completed one or more workouts in one or more other workout applications different from the first workout application), forgoing display of the one or more trainer-based workout suggestions (e.g., forgoing display of any trainer-based workout suggestions) (e.g., in FIGS. 6O-6Q, user interface 608 does not include any trainer-based workout suggestions based, at least in part, on a determination that the user has not completed the threshold number of workouts in the fitness application). Displaying workout suggestions based on the workout history of the user allows the user to access a variety of workout suggestions that have a higher likelihood of being of interest to the user. Doing so also allows the user to access workouts with fewer inputs. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, displaying the first user interface further includes: in accordance with a determination that the user of the computer system has completed the threshold number of workouts in the first workout application, displaying (or, in some embodiments, including), within the first user interface, an achievements section (e.g., 632) that includes a representation of a first workout achievement (e.g., 632a, 632b, and/or 632c), wherein the first workout achievement corresponds to a first set of workout goals (e.g., the first workout achievement is accomplished and/or satisfied by completing the first set of workout goals); and in accordance with a determination that the user of the computer system has not completed the threshold number of workouts in the first workout application (and, optionally, has completed one or more workouts in one or more other workouts applications different from the first workout application), forgoing display of (or, in some embodiments, inclusion of) the achievements section within the first user interface (e.g., in FIGS. 6O-6Q, user interface 608 does not include section 632 based, at least in part, on a determination that the user has not completed the threshold number of workouts in the fitness application). In some embodiments, the achievements section includes a representation of a second workout achievement different from the first workout achievement, wherein the second workout achievement corresponds to a second set of workout goals different from the first set of workout goals. Displaying representations of different workout achievements provides the user with visual feedback about a state of the system (e.g., that the system is tracking the user's advancement towards these workout achievements and/or workout goals).

In some embodiments, displaying the first user interface further includes: in accordance with a determination that the user of the computer system has completed the threshold number of workouts in the first workout application, displaying (or, in some embodiments, including), within the first user interface, a first workout types section (e.g., 624 in FIG. 6E)), wherein: the first workout types section includes a first plurality of workout type options (e.g., 624a-624d) corresponding to different workout types (e.g., a plurality of workout modalities and/or a plurality of workout categories (e.g., HIIT, strength, yoga, core, upper body, lower body, pilates, kickboxing, and/or cycling)), including: a first workout type option corresponding to a first workout type, wherein the first workout type option, when selected, causes the computer system to display a first plurality of workout suggestions that correspond to the first workout type; and a second workout type option corresponding to a second workout type different from the first workout type, wherein the second workout type option, when selected, causes the computer system to display a second plurality of workout suggestions that correspond to the second workout type (e.g., a second plurality of workout suggestions different from the first plurality of workout suggestions); and in accordance with a determination that the user of the computer system has not completed the threshold number of workouts in the first workout application and has completed one or more workouts in one or more other workouts applications different from the first workout application, displaying (or, in some embodiments, including), within the first user interface, a second workout types section, (e.g., 672 in FIG. 6Q) wherein: the second workout types section includes a second plurality of workout type options (e.g., 672a-672d) corresponding to different workout types (e.g., a plurality of workout modalities and/or a plurality of workout categories (e.g., HIIT, strength, yoga, core, upper body, lower body, pilates, kickboxing, and/or cycling)), including: a third workout type option corresponding to a third workout type, wherein the third workout type option, when selected, causes the computer system to display a third plurality of workout suggestions that correspond to the third workout type; and a fourth workout type option corresponding to a fourth workout type different from the third workout type, wherein the fourth workout type option, when selected, causes the computer system to display a fourth plurality of workout suggestions that correspond to the fourth workout type (e.g., a fourth plurality of workout suggestions different from the third plurality of workout suggestions). Displaying workout type suggestions for selection by a user allows a user to access various workouts with fewer user inputs. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, the first workout type section (e.g., 624 in FIG. 6E) is arranged (e.g., ordered based on; and/or workout type options are included in the first workout type section based on) based on the workout history of the user of the computer system in the first workout application. In some embodiments, the workout type options are ordered based on how many workouts the user has previously completed in the first workout application that correspond to each workout type (e.g., the workout type that has been performed by the user the most is displayed first (e.g., at the left and/or at the top), the workout type that has been performed by the user the second most is displayed second (e.g., to the right or below the first workout type), and so forth). Displaying workout type suggestions for selection by a user allows a user to access various workouts with fewer user inputs. Displaying workout type suggestions based on the workout history of the user increases the likelihood that the user will be presented with workout suggestions that are of interest to the user. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, the second workout type section (e.g., 672 in FIG. 6Q) is arranged (e.g., ordered based on; and/or workout type options are included in the second workout type section based on) based on one or more workout type selections made by the user of the computer system during an onboarding process for the first workout application (e.g., FIGS. 6M-6N). Displaying workout type suggestions for selection by a user allows a user to access various workouts with fewer user inputs. Displaying workout type suggestions based on the workout history of the user increases the likelihood that the user will be presented with workout suggestions that are of interest to the user. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, the second workout type section (e.g., 672 in FIG. 6Q) is arranged (e.g., ordered based on; and/or workout type options are included in the second workout type section based on) based on the workout history of the user of the computer system in the one or more other workout applications. In some embodiments, the workout type options are ordered based on how many workouts the user has previously completed in the one or more other workout applications that correspond to each workout type (e.g., the workout type that has been performed by the user the most is displayed first (e.g., at the left and/or at the top), the workout type that has been performed by the user the second most is displayed second (e.g., to the right or below the first workout type), and so forth). Displaying workout type suggestions for selection by a user allows a user to access various workouts with fewer user inputs. Displaying workout type suggestions based on the workout history of the user increases the likelihood that the user will be presented with workout suggestions that are of interest to the user. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, displaying the first user interface further comprises: in accordance with a determination that the user of the computer system has completed the threshold number of workouts in the first application, displaying (or, in some embodiments, including), within the first user interface, a first workout shelf (e.g., 612, 618, and/or 620) (e.g., a display area, a display region, and/or a display section), wherein: the first workout shelf is associated with (e.g., corresponds with) a first set of inclusion criteria that pertains to the workout history of the user of the computer system in the first workout application; the first set of inclusion criteria includes two or more criteria that pertain to the workout history of the user of the computer system in the first workout application for inclusion in the first workout shelf (e.g., section 612 includes a workout modality criteria, a duration criteria, a music type criteria, and instructor criteria; section 618 includes a workout modality criteria, a duration criteria, and an instructor criteria; and section 620 includes a workout modality criteria, a duration criteria, and an instructor criteria); and the first workout shelf includes two or more workout recommendations (e.g., 612a-612c, 618a-618c, and/or 620a-620c) that are selected for inclusion in the first workout shelf based on the two or more workout recommendations satisfying the first set of inclusion criteria (e.g., workouts that do not meet the inclusion criteria are not included in and/or are excluded from the first workout shelf). In some embodiments, in accordance with a determination that the user of the computer system has not completed the threshold number of workouts in the first workout application, the first user interface does not include and/or display the first workout shelf and/or any workout shelves that are associated with criterion pertaining to the workout history of the user within the first workout application. Displaying workout suggestions based on the workout history of the user allows the user to access a variety of workout suggestions that have a higher likelihood of being of interest to the user. Doing so also allows the user to access workouts with fewer inputs. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, the first set of inclusion criteria includes two or more of: a workout-type inclusion criterion that filters out workout suggestions based on workout type (e.g., workout modality and/or workout category); a trainer inclusion criterion that filters out workout suggestions based on trainers (e.g., instructions and/or teachers); a duration inclusion criterion that filters out workout suggestions based on workout duration; and music inclusion criterion that filters out workout suggestions based on music (e.g., section 612 includes a workout modality criteria, a duration criteria, a music type criteria, and trainer criteria; section 618 includes a workout modality criteria, a duration criteria, and a trainer criteria; and section 620 includes a workout modality criteria, a duration criteria, and a trainer criteria). Displaying workout suggestions based on the workout history of the user allows the user to access a variety of workout suggestions that have a higher likelihood of being of interest to the user. Doing so also allows the user to access workouts with fewer inputs. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

Note that details of the processes described above with respect to method 900 (e.g., FIG. 9) are also applicable in an analogous manner to the methods described above and/or below. For example, method 700, method 800, and/or method 1100 optionally includes one or more of the characteristics of the various methods described above with reference to method 900. For example, the first user interface recited in method 700 is the first user interface recited in method 800 and/or method 900; and/or the first user interface recited in methods 700-900 and the workout sharing user interface recited in method 1100 are accessible via the same application. For brevity, these details are not repeated below.

FIGS. 10A-10M illustrate exemplary user interfaces for interacting with workout content, in accordance with some embodiments. The user interfaces in these figures are used to illustrate the processes described below, including the processes in FIG. 11.

FIG. 10A illustrates computer system 600, which is a smart phone with touch-sensitive display 602. At FIG. 10A, computer system 600 displays user interface 1000 and options 606a-606c. Various embodiments of options 606a-606c were discussed above with reference to FIG. 6A. In some embodiments, option 606b, when selected, causes computer system 600 to display user interface 608 described above. In some embodiments, option 606c, when selected, causes computer system 600 to display user interface 1000. User interface 1000 includes scrollable region 1002 and platters 1012, 1014, 1016. Platter 1012 corresponds to a first remote user, Maggie, that is sharing her physical activity metrics and/or workout information with the user of computer system 600. Platter 1012 includes daily metrics representation 1012a, which is indicative of Maggie's physical activity in the current day. For example, in some embodiments, the outermost ring of representation 1012a is representative of Maggie's progress towards a daily calorie goal; the second outermost ring of representation 1012a is representative of Maggie's progress towards a daily exercise goal (e.g., a daily exercise minutes goal); and the innermost ring of representation 1012a is representative of Maggie's progress towards a daily stand goal (e.g., a daily number of hours in which the person stood for a threshold amount of time). Platter 1012 also indicates that Maggie has burned 340 calories in the current day, and their daily calorie target is 800 calories burned.

Platter 1014 corresponds to a second remote user, Hugo, that is sharing his physical activity metrics and/or workout information with the user of computer system 600. Platter 1014 includes daily metrics representation 1014a, which is indicative of Hugo's physical activity in the current day. For example, in some embodiments, the outermost ring of representation 1014a is representative of Hugo's progress towards a daily calorie goal; the second outermost ring of representation 1014a is representative of Hugo's progress towards a daily exercise goal (e.g., a daily exercise minutes goal); and the innermost ring of representation 1014a is representative of Hugo's progress towards a daily stand goal (e.g., a daily number of hours in which the person stood for a threshold amount of time). Platter 1014 also indicates that Hugo has burned 401 calories in the current day, and his daily calorie target is 700 calories burned.

Platter 1016 corresponds to the user of computer system 600. Platter 1016 includes daily metrics representation 1016a, which is indicative of the user's physical activity in the current day. For example, in some embodiments, the outermost ring of representation 1016a is representative of the user of computer system 600's progress towards a daily calorie goal; the second outermost ring of representation 1016a is representative of the user's progress towards a daily exercise goal (e.g., a daily exercise minutes goal); and the innermost ring of representation 1016a is representative of the user's progress towards a daily stand goal (e.g., a daily number of hours in which the person stood for a threshold amount of time). Platter 1016 also indicates that the user of computer system 600 has burned 101 calories in the current day, and their daily calorie target is 720 calories burned.

Scrollable region 1002 is scrollable in a horizontal direction, and includes platters 1004, 1006, 1008. In FIG. 10A, platter 1004 is displayed via display 602, while platter 1006 is only partially displayed, and platter 1008 is not displayed. In some embodiments, the user can scroll scrollable region 1002 to view platter 1006 and/or platter 1008, as will be described in greater detail below.

Platter 1004 is indicative of an outdoor run workout completed by Maggie (e.g., a 2.45 mile outdoor run workout), and is displayed by computer system 600 in scrollable region 1002 in response to and/or based computer system 600 receiving information indicating that Maggie completed an outdoor run workout. Platter 1004 includes option 1004a that, when selected, causes computer system 600 to display one or more options for the user of computer system 600 to respond to the outdoor run workout completed by Maggie, as will be described in greater detail below. Platter 1006 is indicative of an outdoor run workout completed by Hugo (e.g., a 1.00 mile outdoor run workout), and is displayed by computer system 600 in scrollable region 1002 in response to and/or based computer system 600 receiving information indicating that Hugo completed an outdoor run workout. Platter 1006 includes option 1006a that, when selected, causes computer system 600 to display one or more options for the user of computer system 600 to respond to the outdoor run workout completed by Hugo. Platter 1008 is indicative of an indoor run workout completed by Maggie (e.g., a 2.05 mile indoor run workout), and is displayed by computer system 600 in scrollable region 1002 in response to and/or based computer system 600 receiving information indicating that Maggie completed an indoor run workout. Platter 1008 includes option 1008a that, when selected, causes computer system 600 to display one or more options for the user of computer system 600 to respond to the indoor run workout completed by Maggie. At FIG. 10A, computer system 600 detects user input 1018, which is a touch input (e.g., a tap input) corresponding to selection of option 1004a.

At FIG. 10B, in response to user input 1018, computer system 600 displays response options 1020a-1020e. Response option 1020a includes a first set of content (e.g., text, images, emojis, and/or visual content) and, when selected, causes computer system 600 to initiate a process for the user of computer system 600 to respond to Maggie's outdoor run workout with the first set of content. Response option 1020b includes a second set of content (e.g., text, images, emojis, and/or visual content) different from the first set of content and, when selected, causes computer system 600 to initiate a process for the user of computer system 600 to respond to Maggie's outdoor run workout with the second set of content. Response option 1020c includes a third set of content (e.g., text, images, emojis, and/or visual content) different from the first and second sets of content and, when selected, causes computer system 600 to initiate a process for the user of computer system 600 to respond to Maggie's outdoor run workout with the third set of content. Response option 1020d includes a fourth set of content (e.g., text, images, emojis, and/or visual content) different from the first, second, and third sets of content and, when selected, causes computer system 600 to initiate a process for the user of computer system 600 to respond to Maggie's outdoor run workout with the fourth set of content. Response option 1020e allows the user to enter their own content to respond to Maggie's outdoor run, as will be described in greater detail below. At FIG. 10B, computer system 600 detects user input 1022, which is a touch input (e.g., a tap input) corresponding to selection of response option 1020d.

At FIG. 10C, in response to user input 1022, computer system 600 displays response 1028 within messaging user interface 1024. Messaging user interface 1024 corresponds to a messaging session that includes the user of computer system 600 and Maggie. Messaging user interface 1024 includes participant indication 1024a, option 1024b, message region 1024c, text field 1024d, keyboard 1024e, and send option 1024f. Participant indication 1024a indicates that any messages transmitted via messaging user interface will be sent to M aggie (e.g., sent to one or more external computer systems associated with Maggie and/or one or more external computer systems that are logged into Maggie's user account). Option 1024b, when selected, causes computer system 600 to cease display of messaging user interface 1024 (e.g., and return to the state shown in FIG. 10B). Message region 1024c displays one or more previously transmitted messages 1026a-1026c that have previously been transmitted into the messaging session between the user of computer system 600 and Maggie. Keyboard 1024e allows the user to enter text into text field 1024d, and text and/or content shown in text field 1024d is transmitted into the messaging session (and, for example, shown in message region 1024c) when send option 1024f is selected. In FIG. 10C, in response to user input 1022, response 1028 is displayed within text field 1024d. Response 1028 includes the set of content that corresponds to the response option 1020d that was selected in FIG. 10B. Response 1028 also includes an indication of the workout that the user is responding to (e.g., Outdoor Run 2.45 mile workout). Response 1028 also includes option 1028a that, when selected, causes computer system 600 to remove, delete, and/or cease display of response 1028 within text entry field 1024d. At FIG. 10C, computer system 600 detects user input 1030, which is a touch input (e.g., a tap input) corresponding to selection of send option 1024f.

At FIG. 10D, in response to user input 1030, computer system 600 transmits response 1028 into the messaging session and to Maggie (e.g., to one or more computer systems associated with Maggie), and displays response 1028 within message region 1024c to indicate that response 1028 has been transmitted into the messaging session.

At FIG. 10E, computer system 600 displays user interface 1000. At FIG. 10E, computer system 600 detects user input 1032, which is a swipe left input on scrollable region 1002. At FIG. 10F, in response to user input 1032, computer system 600 displays scrolling of scrollable region 1002 to display platter 1008. At FIG. 10F, while platter 1008 is displayed, computer system 600 detects user input 1034, which is a touch input (e.g., a tap input) corresponding to selection of option 1008a.

At FIG. 10G, in response to user input 1034, computer system 600 displays response options 1036a-1036e. Response option 1036a includes a fifth set of content (e.g., text, images, emojis, and/or visual content) and, when selected, causes computer system 600 to initiate a process for the user of computer system 600 to respond to Maggie's indoor run workout with the fifth set of content. Response option 1036b includes a sixth set of content (e.g., text, images, emojis, and/or visual content) different from the fifth set of content and, when selected, causes computer system 600 to initiate a process for the user of computer system 600 to respond to Maggie's indoor run workout with the sixth set of content. Response option 1036c includes a seventh set of content (e.g., text, images, emojis, and/or visual content) different from the fifth and sixth sets of content and, when selected, causes computer system 600 to initiate a process for the user of computer system 600 to respond to Maggie's indoor run workout with the seventh set of content. Response option 1036d includes an eighth set of content (e.g., text, images, emojis, and/or visual content) different from the fifth, sixth, and seventh sets of content and, when selected, causes computer system 600 to initiate a process for the user of computer system 600 to respond to Maggie's indoor run workout with the eighth set of content. Response option 1036e allows the user to enter their own content to respond to Maggie's indoor run. At FIG. 10G, computer system 600 detects user input 1038, which is a touch input (e.g., a tap input) corresponding to selection of response option 1036e.

At FIG. 10H, in response to user input 1038, computer system 600 displays response 1042. Response 1042 includes text field 1042a that displays text entered by the user via keyboard 1044. Response 1042 also includes workout indication 1042b, that identifies the workout that is being responded to (e.g., Maggie's 2.05 mile indoor run workout). At FIG. 10H, computer system 600 detects user input 1046, which is one or more inputs interacting with keyboard 1044. At FIG. 10I, in response to user input 1046, computer system 600 displays text “Do Better” entered by the user within text field 1042a. At FIG. 10I, computer system 600 detects user input 1048, which is a touch input (e.g., a tap input) corresponding to a user request to transmit response 1048 to Maggie in response to Maggie's 2.05 mile indoor run workout.

At FIG. 10J, in response to user input 1048, computer system 600 transmits response 1048 into a messaging session between the user of computer system 600 and Maggie, which causes response 1048 to be transmitted to one or more computer systems associated with Maggie. Additionally, in FIG. 10J, in response to user input 1048, computer system 600 displays messaging user interface 1024, and displays response 1042 in messages region 1024c, indicating that response 1042 has been transmitted into the messaging session and to Maggie. At FIG. 10J, computer system 600 detects user input 1050, which is a touch input (e.g., a tap input) corresponding to selection of option 1024b.

At FIG. 10K, in response to user input 1050, computer system 600 ceases display of messaging user interface 1024 and re-displays user interface 1000. In some embodiments, selecting an area of platter 1004 outside of option 1004a causes computer system 600 to display a workout sharing user interface that corresponds to M aggie (e.g., based on platter 1004 being associated with a workout completed by Maggie). In some embodiments, selecting an area of platter 1006 outside of option 1006a causes computer system 600 to display a workout sharing user interface that corresponds to Hugo (e.g., based on platter 1006 being associated with a workout completed by Hugo). Similarly, in some embodiments, selecting an area of platter 1008 outside of option 1008a causes computer system 600 to display the workout sharing user interface that corresponds to Maggie (e.g., based on platter 1008 being associated with a workout completed by Maggie). At FIG. 10K, while displaying platter 1004 in scrollable region 1002, computer system 600 detects user input 1052, which is a touch input (e.g., a tap input) corresponding to selection of a region of platter 1004 outside of response option 1004a.

At FIG. 10L, in response to user input 1052, computer system 600 displays workout sharing user interface 1054. Workout sharing user interface 1054 displays physical activity information and/or workout information corresponding to Maggie. Workout sharing user interface 1054 includes indication 1054a, which identifies the person and/or individual for whom physical activity information is being displayed (e.g., Maggie). Workout sharing user interface 1054 also includes email address 1054b, which displays Maggie's email address. In FIG. 10L, workout sharing user interface also includes cancel option 1054c, section 1056, and section 1060. Cancel option 1054c, when selected, causes computer system 600 to cease display of workout sharing user interface 1054 and re-display user interface 1000.

Section 1056 includes daily metrics representation 1056d, and physical activity metrics 1056a-1056c, 1058a-1058b that are indicative of Maggie's physical activity during the current day. For example, in some embodiments, the outermost ring of representation 1056d is representative of Maggie's progress towards a daily calorie goal; the second outermost ring of representation 1056d is representative of Maggie's progress towards a daily exercise goal (e.g., a daily exercise minutes goal); and the innermost ring of representation 1056d is representative of Maggie's progress towards a daily stand goal (e.g., a daily number of hours in which the person stood for a threshold amount of time). Metric 1056a indicates that Maggie has burned 340 calories in the current day, and that her calorie goal for the day is 800 calories. Metric 1056b indicates that M aggie has exercised for 12 minutes in the current day, and that her exercise goal for the day is 45 minutes of exercise. Metric 1056c indicates that Maggie has stood for a threshold duration of time (e.g., 1 minute, 2 minutes, or 5 minutes) during 10 hours in the current day, and that her stand goal for the day is 12 hours. Metric 1058a indicates that Maggie has taken 4,906 steps in the current day, and metric 1058b indicates that Maggie has walked 2.04 miles in the current day.

Section 1060 displays representations 1060a-1060g, which are analogous to representation 1056d (e.g., displays the same type of information as representation 1056d), but for the past seven days. At FIG. 10L, computer system 600 detects user input 1062, which is a swipe up input.

At FIG. 10M, in response to user input 1062, computer system 600 displays scrolling of user interface 1054 to display, in FIG. 10M, sections 1064 and 1066 of user interface 1054. Section 1064 includes options 1064a-1064b. Option 1064a, when selected, causes computer system 600 to initiate a process for creating a competition between the user of computer system 600 and M aggie, and option 1064b, when selected, causes computer system 600 to display the rules for the competition.

Section 1066 includes option 1066a, and representations 1068, 1070, 1072. Representation 1068 is representative of a first workout completed by Maggie (e.g., a 2.45 mile outdoor run completed on the current day (e.g., “Today”)); representation 1070 is representative of a second workout completed by Maggie (e.g., a 2.05 mile indoor run completed on the current day (e.g., “Today”)); and representation 1072 is representative of a third workout completed by Maggie (e.g., a yoga workout completed on Sunday). In some embodiments, representations 1068, 1070, 1072 are representative of Maggie's three most recent workouts. Option 1066a, when selected, causes computer system 600 to display workout information for more of Maggie's workouts. Representation 1068 includes option 1068a which, when selected, causes computer system 600 to display one or more response options for responding to Maggie's outdoor run workout (e.g., similar to option 1004a and response options 1020a-1020e in FIGS. 10A-10B above). In some embodiments, selection of option 1068a causes computer system 600 to display the same response options as were displayed in FIG. 10B. Representation 1070 includes option 1070a which, when selected, causes computer system 600 to display one or more response options for responding to Maggie's indoor run workout (e.g., similar to option 1008a and response options 1036a-1036e in FIGS. 10F-10G above). In some embodiments, selection of option 1070a causes computer system 600 to display the same response options as were displayed in FIG. 10G. Representation 1072 includes option 1072a which, when selected, causes computer system 600 to display one or more response options for responding to Maggie's yoga workout (e.g., similar to option 1008a and response options 1036a-1036e in FIGS. 10F-10G above). In this way, the user of computer system 600 is able to respond to workouts completed by Maggie via user interface 1000 and via user interface 1054.

FIG. 11 is a flow diagram illustrating a method for interacting with workout content using a computer system in accordance with some embodiments. Method 1100 is performed at a computer system (e.g., 100, 300, 500, and/or 600) (e.g., a smart phone, a smart watch, a tablet, a laptop, a desktop, a wearable device, wrist-worn device, and/or head-mounted device) that is in communication with one or more display generation components (e.g., 602) (e.g., a display, a touch-sensitive display, and/or a display controller) and one or more input devices (e.g., 602) (e.g., a touch-sensitive surface, a touch-sensitive display, a button, a rotatable input mechanism, a depressible and rotatable input mechanism, a camera, an accelerometer, an inertial measurement unit (IM U), a heartrate sensor, a body temperature sensor, and/or a blood-oxygen level sensor). Some operations in method 1100 are, optionally, combined, the orders of some operations are, optionally, changed, and some operations are, optionally, omitted.

As described below, method 1100 provides an intuitive way for interacting with workout content. The method reduces the cognitive burden on a user for interacting with workout content, thereby creating a more efficient human-machine interface. For battery-operated computing devices, enabling a user to interact with workout content faster and more efficiently conserves power and increases the time between battery charges.

In some embodiments, the computer system (e.g., 600) detects (1102), via the one or more input devices, a user request (e.g., one or more user inputs) (e.g., one or more touch inputs, one or more hardware control inputs, one or more button presses, one or more rotational inputs, one or more gesture inputs, and/or one or more spoken inputs) to display a workout sharing user interface (e.g., 1000 and/or 1054) (e.g., a workout sharing user interface that corresponds to multiple external users or a workout sharing user interface that corresponds to a single external user). In response to detecting the user request to display the workout sharing user interface, the computer system displays (1104), via the one or more display generation components, the workout sharing user interface (e.g., 1000 and/or 1054). In some embodiments, the workout sharing user interface includes: a representation (e.g., a user interface object and/or a platter) of a first workout achievement by a first remote user (e.g., 1004, 1006, 1008, 1068, 1070, and/or 1072) (e.g., a completed workout by the first remote user and/or an achievement pertaining to a workout performed by the first remote user) different from a user of the computer system, wherein the representation of the first workout achievement includes a first response object (e.g., 1004a, 1006a, 1008a, 1068a, 1070a, and/or 1072a) (e.g., a user interface object, an affordance, and/or a displayed object) that, when selected, causes the computer system to display a first set of response options (e.g., 1020a-1020e and/or 1036a-1036e) for responding to the first workout achievement by the first remote user; and a representation (e.g., a user interface object and/or a platter) of a second workout achievement by the first remote user (e.g., 1004, 1006, 1008, 1068, 1070, and/or 1072) different from the representation of the first workout achievement by the first remote user, wherein the representation of the second workout achievement includes a second response object (e.g., 1004a, 1006a, 1008a, 1068a, 1070a, and/or 1072a) (e.g., a user interface object, an affordance, and/or a displayed object) that, when selected, causes the computer system to display a second set of response options (e.g., 1020a-1020e and/or 1036a-1036e) for responding to the second workout achievement by the first remote user. While displaying the workout sharing user interface, the computer system detects (1106), via the one or more input devices, a selection input (e.g., 1018 and/or 1034) (e.g., one or more user inputs) (e.g., one or more touch inputs, one or more hardware control inputs, one or more button presses, one or more rotational inputs, one or more gesture inputs, and/or one or more spoken inputs). In response to detecting the selection input (1108): in accordance with a determination that the selection input is directed to the first response object (and, optionally, is not directed to the second response object), the computer system displays (1110), via the one or more display generation components, the first set of response options (e.g., 1020a-1020e and/or 1036a-1036e) for responding to the first workout achievement by the first remote user, including: a first response option that, when selected, initiates a process for transmitting a first response to the first remote user in response to the first workout achievement; and a second response option that, when selected, initiates a process for transmitting a second response different from the first response to the first remote user in response to the first workout achievement; and in accordance with a determination that the selection input is directed to the second response object (and, optionally, is not directed to the first response object), the computer system displays (1112), via the one or more display generation components, the second set of response options (e.g., 1020a-1020e and/or 1036a-1036e) for responding to the second workout achievement by the first remote user, including: a third response option that, when selected, initiates a process for transmitting a third response to the first remote user in response to the second workout achievement; and a fourth response option that, when selected, initiates a process for transmitting a fourth response different from the third response to the first remote user in response to the second workout achievement. Providing the user with options for responding to a workout achievement allows the user to perform these operations with fewer user inputs. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, the workout sharing user interface (e.g., 1000 and/or 1054) further includes a representation (e.g., a user interface object and/or a platter) of a third workout achievement by a second remote user (e.g., 1006 and/or 1072) (e.g., a second remote user different from or the same as the first remote user), wherein the representation of the third workout achievement is different from the representation of the first workout achievement and the representation of the second workout achievement, wherein the representation of the third workout achievement includes a third response object (e.g., 1006a and/or 1072a) (e.g., a user interface object, an affordance, and/or a displayed object) that, when selected, causes the computer system to display a third set of response options for responding to the third workout achievement by the second remote user. Providing the user with options for responding to a workout achievement allows the user to perform these operations with fewer user inputs. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, displaying the workout sharing user interface comprises concurrently displaying the representation of the first workout achievement and the representation of the second workout achievement (e.g., 1068, 1070, and 1072 in user interface 1054 in FIG. 10M). Providing the user with options for responding to a workout achievement allows the user to perform these operations with fewer user inputs. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, the workout sharing user interface (e.g., 1000 and/or 1054) further includes a representation of daily physical activity metrics corresponding to the first remote user (e.g., 1012, 1012a, 1056, and/or 1056d), wherein the daily physical activity metrics are indicative of physical activity by the first remote user during a current day (e.g., during a current 24-hour period and/or during a current calendar day). Displaying physical activity metrics corresponding to one or more remote users provides the user with visual feedback about a state of the system (e.g., the system is receiving physical activity information from one or more remote users). Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, the workout sharing user interface (e.g., 1000) further includes a representation of second daily physical activity metrics corresponding to a second remote user different from the first remote user (e.g., 1012, 1014, 1012a, and/or 1014a), wherein the second daily physical activity metrics are indicative of physical activity by the second remote user during the current day (e.g., during the current 24-hour period and/or during the current calendar day). Displaying physical activity metrics corresponding to one or more remote users provides the user with visual feedback about a state of the system (e.g., the system is receiving physical activity information from one or more remote users). Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, the representation of the first workout achievement and the representation of the second workout achievement are located within a first scrollable region (e.g., 1002) of the first user interface (e.g., 1000); the first scrollable region (e.g., 1002) is scrollable in a first direction (e.g., horizontally or vertically); and the first user interface is scrollable in a second direction different from the first direction (e.g., vertically or horizontally) (e.g., a second direction that is perpendicular to the first direction or a second direction that is opposite the first direction) (e.g., in some embodiments, user interface 1000 is scrollable vertically and scrollable region 1002 is scrollable horizontally, or vice versa). Displaying user interface objects in a scrollable user interface allows for the user to access the user interface objects while conserving limited display space.

In some embodiments, the workout sharing user interface (e.g., 1054) further includes a daily metrics section (e.g., 1060), wherein the daily metrics section includes: a representation of first daily physical activity metrics corresponding to the first remote user, wherein the first daily physical activity metrics are indicative of physical activity by the first remote user during a first day (e.g., during a first 24-hour period and/or during a first calendar day) (e.g., 1060a, 1060b, 1060c, 1060d, 1060e, 1060f, and/or 1060g); and a representation of second daily physical activity metrics corresponding to the first remote user separate from the representation of first daily physical activity metrics, wherein the second daily physical activity metrics are indicative of physical activity by the first remote user during a second day different from the first day (e.g., during a second 24-hour period and/or during a second calendar day) (e.g., 1060a, 1060b, 1060c, 1060d, 1060e, 1060f, and/or 1060g). In some embodiments, the daily metrics section further includes: a representation of third daily physical activity metrics corresponding to the first remote user separate from the representation of first daily physical activity metrics and the representation of second daily physical activity metrics, wherein the third daily physical activity metrics are indicative of physical activity by the first remote user during a third day different from the first day and the second day (e.g., during a third 24-hour period and/or during a third calendar day) (e.g., 1060a, 1060b, 1060c, 1060d, 1060e, 1060f, and/or 1060g). Displaying physical activity metrics corresponding to one or more remote users provides the user with visual feedback about a state of the system (e.g., the system is receiving physical activity information from one or more remote users). Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, while concurrently displaying the first response option and the second response option (e.g., 1020a, 1020b, 1020c, 1020d, and/or 1020e), the computer system detects, via the one or more input devices, a selection input (e.g., 1022) (e.g., one or more user inputs) (e.g., one or more touch inputs, one or more hardware control inputs, one or more button presses, one or more rotational inputs, one or more gesture inputs, and/or one or more spoken inputs) corresponding to selection of the first response option. In response to detecting the selection input corresponding to selection of the first response option, the computer system displays, via the one or more display generation components, the first response within a messaging user interface (e.g. in FIG. 10C, response 1028 is displayed within messaging session user interface 1024), wherein the messaging user interface corresponds to a messaging session that includes the user of the computer system and the first remote user. In some embodiments, the messaging user interface displays one or more previous messages that were previously transmitted into the messaging session by the user of the computer system and/or the first remote user. Providing the user with options for responding to a workout achievement allows the user to perform these operations with fewer user inputs. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, the messaging user interface includes a text entry field (e.g., 1024d) for entering text to be transmitted into the messaging session (e.g., a text entry field that displays text entered by the user prior to submitting the entered text into the messaging session); and displaying the first response within the messaging user interface comprises displaying the first response within the text entry field (e.g., without transmitting the first response into the messaging session and/or to the first remote user) (e.g. in FIG. 10C, response 1028 is displayed in text entry field 1024d). Providing the user with options for responding to a workout achievement allows the user to perform these operations with fewer user inputs. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, while displaying the first response (e.g., 1028) within the text entry field (e.g., 1024d), the computer system detects, via the one or more input devices, a user request (e.g., one or more user inputs) (e.g., one or more touch inputs, one or more hardware control inputs, one or more button presses, one or more rotational inputs, one or more gesture inputs, and/or one or more spoken inputs) to transmit the first response into the messaging session (e.g., user input 1030). In response to detecting the user request to transmit the first response into the messaging session, the computer system transmits the first response into the messaging session and to the first remote user (e.g., FIGS. 10C-10D). In some embodiments, in response to detecting the user request to transmit the first response into the messaging session, the computer system ceases displaying the first response in the text entry field and displays the first response in a transmitted messages region of the messaging user interface that displays one or more messages (e.g., two or more messages) that have been transmitted into the messaging session (e.g., by the user of the computer system and/or the first remote user). Providing the user with options for responding to a workout achievement allows the user to perform these operations with fewer user inputs. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, displaying the first response within the messaging user interface further comprises: while displaying the first response in the text entry field, displaying, in a transmitted messages area (e.g., 1024c) of the messaging user interface that is distinct from the text entry field (e.g., 1024d), one or more previous messages that were previously transmitted into the messaging session (e.g., by the user of the computer system and/or the first remote user) (e.g., 1026a-1026c). Providing the user with options for responding to a workout achievement allows the user to perform these operations with fewer user inputs. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, the first set of response options includes a fifth response option (e.g., 1020e and/or 1036e) that, when selected, initiates a process for transmitting a user-entered response to the first remote user in response to the first workout achievement (e.g., a custom response; a non-pre-generated response; and/or a non-automatically generated response). In some embodiments, the second set of response options includes a sixth response option that, when selected, initiates a process for transmitting a user-entered response to the first remote user in response to the second workout achievement. Providing the user with options for responding to a workout achievement allows the user to perform these operations with fewer user inputs. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, while displaying the workout sharing user interface (e.g., 1000), the computer system detects, via the one or more input devices, a first set of user inputs (e.g., one or more user inputs) (e.g., one or more touch inputs, one or more hardware control inputs, one or more button presses, one or more rotational inputs, one or more gesture inputs, and/or one or more spoken inputs) (e.g., 1018 and/or 1052). In response to detecting the first set of user inputs: in accordance with a determination that the first set of user inputs is directed to the first response object (e.g., 1004a) (e.g., user input 1018), the computer system displays, via the one or more display generation components, the first set of response options (e.g., 1020a-1020e); and in accordance with a determination that the first set of user inputs is directed to a first region of the representation of the first workout achievement that does not include the first response object (e.g., user input 1052) (e.g., is directed to the representation of the first workout achievement but is not directed to the first response object; and/or is directed to an area of the representation of the first workout achievement that is outside of the first response object), the computer system displays, via the one or more display generation components, an activity history user interface (e.g., 1054) corresponding to the first remote user (e.g., without displaying the first set of response options), wherein the activity history user interface corresponding to the first remote user displays physical activity information corresponding to the first remote user that is not displayed in the workout sharing user interface (e.g., 1000) (e.g., workout history information and/or daily physical activity information corresponding to the first remote user) (e.g., in some embodiments, the activity history user interface displays physical activity information corresponding to the first remote user without displaying physical activity information corresponding to any other remote users). Providing the user with an option to view activity information corresponding to the first remote user allows the user to perform these operations with fewer user inputs. Furthermore, performing different operations based on selection of different regions of the representation of the first workout achievement allows the user to perform different operations while conserving limited display space. Doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, the activity history user interface (e.g., 1054) includes a first respective representation of the first workout achievement (e.g., 1068, 1070, and/or 1072) (e.g., a user interface object that is indicative of and/or representative of the first workout achievement) by the first remote user, wherein the first respective representation of the first workout achievement includes a first respective response object (e.g., 1068a, 1070a, and/or 1072a) (e.g., a user interface object, an affordance, and/or a displayed object) that, when selected, causes the computer system to display a first respective set of response options for responding to the first workout achievement by the first remote user (e.g., similar to 1020a-1020e) (e.g., a first respective set of response options that is the same as or different from the first set of response options). In some embodiments, while displaying the activity history user interface, the computer system detects, via the one or more input devices, an input. In response to detecting the input, in accordance with a determination that the input corresponds to selection of the first respective response object, the computer system displays, via the one or more display generation components, the first respective set of response options for responding to the first workout achievement by the first remote user, including: a first respective response option that, when selected, initiates a process for transmitting a first respective response to the first remote user in response to the first workout achievement; and a second respective response option that, when selected, initiates a process for transmitting a second respective response different from the first respective response to the first remote user in response to the first workout achievement. Providing the user with options for responding to a workout achievement allows the user to perform these operations with fewer user inputs. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, the activity history user interface (e.g., 1054) further includes a second respective representation of the second workout achievement (e.g., 1068, 1070, and/or 1072) (e.g., a user interface object that is indicative of and/or representative of the first workout achievement) by the first remote user, wherein the second respective representation of the second workout achievement includes a second respective response object (e.g., 1068a, 1070a, and/or 1072a) (e.g., a user interface object, an affordance, and/or a displayed object) that, when selected, causes the computer system to display a second respective set of response options for responding to the second workout achievement by the first remote user (e.g., similar to 1020a-1020e and/or 1036a-1036e) (e.g., a second respective set of response options that is the same as or different from the second set of response options). In some embodiments, while displaying the activity history user interface, the computer system detects, via the one or more input devices, an input. In response to detecting the input, in accordance with a determination that the input corresponds to selection of the second respective response object, the computer system displays, via the one or more display generation components, the second respective set of response options for responding to second first workout achievement by the first remote user, including: a third respective response option that, when selected, initiates a process for transmitting a third respective response to the first remote user in response to the second workout achievement; and a fourth respective response option that, when selected, initiates a process for transmitting a fourth respective response different from the third respective response to the first remote user in response to the second workout achievement. Providing the user with options for responding to a workout achievement allows the user to perform these operations with fewer user inputs. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

Note that details of the processes described above with respect to method 1100 (e.g., FIG. 11) are also applicable in an analogous manner to the methods described above. For example, method 700, method 800, and/or method 900 optionally includes one or more of the characteristics of the various methods described above with reference to method 1100. For example, the first user interface recited in method 700 is the first user interface recited in method 800 and/or method 900; and/or the first user interface recited in methods 700-900 and the workout sharing user interface recited in method 1100 are accessible via the same application. For brevity, these details are not repeated below.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

As described above, one aspect of the present technology is the gathering and use of data available from various sources to improve the delivery to users of workout content or any other content that may be of interest to them. The present disclosure contemplates that in some instances, this gathered data may include personal information data that uniquely identifies or can be used to contact or locate a specific person. Such personal information data can include demographic data, location-based data, telephone numbers, email addresses, social network IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to deliver targeted content that is of greater interest to the user. Accordingly, use of such personal information data enables users to have calculated control of the delivered content. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of content delivery services, the present technology can be configured to allow users to select to “opt in” or “opt out” of participation in the collection of personal information data during registration for services or anytime thereafter. In another example, users can select not to provide personal data, such as workout history information and/or physical activity metric information, for targeted content delivery services. In yet another example, users can select to limit the length of time personal data is maintained or entirely prohibit saving and/or transfer of personal data. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publicly available information.

1-95. (canceled)

96. A computer system configured to communicate with one or more display generation components and one or more input devices, comprising:
one or more processors; and
memory storing one or more programs configured to be executed by the one or more processors, the one or more programs including instructions for:
displaying, via the one or more display generation components, a first user interface that includes:
a first scrollable region that is scrollable in a first direction; and
a plurality of workout suggestions that are selected for inclusion in the first user interface based on a workout history of a user of the computer system, including a first workout suggestion that is selected for inclusion in the first user interface based on the workout history of the user of the computer system and that, when selected, causes the computer system to initiate a process for playback of a first workout corresponding to the first workout suggestion;
displaying, within a first portion of the first scrollable region of the first user interface and concurrently with the first workout suggestion, a second workout suggestion different from the first workout suggestion, wherein the second workout suggestion is selected for inclusion in the first user interface based on the workout history of the user of the computer system and, when selected, causes the computer system to initiate a process for playback of a second workout different from the first workout;
while displaying the second workout suggestion within the first portion of the first scrollable region of the first user interface, detecting, via the one or more input devices, a first user input; and
in response to detecting the first user input:
in accordance with a determination that the first user input is directed to the first scrollable region, displaying, concurrently with the first workout suggestion, scrolling of the first scrollable region to display, within the first portion of the first scrollable region, a workout plan recommendation, wherein:
the workout plan recommendation is determined based on the workout history of the user of the computer system; and
the workout plan recommendation pertains to a multi-workout workout plan.

97. The computer system of claim 96, the one or more programs further including instructions for:
while displaying the second workout suggestion within the first portion of the first scrollable region of the first user interface, detecting, via the one or more input devices, a second user input that is different from the first user input; and
in response to detecting the second user input:
in accordance with a determination that the second user input is directed to the first scrollable region, displaying, concurrently with the first workout suggestion, scrolling of the first scrollable region to display, within the first portion of the first scrollable region, a third workout suggestion that is different from the first workout suggestion and the second workout suggestion, wherein the third workout suggestion is selected for inclusion in the first user interface without regard for the workout history of the user of the computer system and, when selected, causes the computer system to initiate a process for playback of a third workout different from the first workout and the second workout.

98. The computer system of claim 96, wherein displaying the workout plan recommendation within the first portion of the first scrollable region comprises:
in accordance with a determination that the user of the computer system is participating in a first multi-workout workout plan, displaying a fourth workout suggestion, wherein the fourth workout suggestion corresponds to a fourth workout, and the fourth workout suggestion is selected for inclusion in the first scrollable region based on the fourth workout being selected as a next workout in the first multi-workout workout plan, and wherein the fourth workout suggestion, when selected, causes the computer system to initiate a process for playback of the fourth workout; and
in accordance with a determination that the user of the computer system is not participating in a multi-workout workout plan, displaying a plan creation recommendation that recommends that the user create a multi-workout workout plan, wherein the plan creation recommendation, when selected, causes the computer system to initiate a process for creating a new multi-workout workout plan.

99. The computer system of claim 98, the one or more programs further including instructions for:
while displaying the fourth workout suggestion within the first portion of the first scrollable region, detecting, via the one or more input devices, a selection input corresponding to selection of the fourth workout suggestion; and
in response to detecting the selection input corresponding to selection of the fourth workout suggestion, initiating playback of the fourth workout.

100. The computer system of claim 98, the one or more programs further including instructions for:
while displaying the plan creation recommendation within the first portion of the first scrollable region, detecting, via the one or more input devices, a selection input corresponding to selection of the plan creation recommendation; and
in response to detecting the selection input corresponding to selection of the plan creation recommendation, displaying, via the one or more display generation components, a plan creation user interface for creating a new multi-workout workout plan, wherein the plan creation user interface includes one or more of:
a set of workout modality options that are selectable to define one or more workout modalities to be included in the new multi-workout workout plan;
a set of workout frequency options that are selectable to define the frequency of workouts in the new multi-workout workout plan; and
a set of workout duration options that are selectable to define the duration of workouts to be included in the new multi-workout workout plan.

101. The computer system of claim 100, wherein the set of workout frequency options includes a set of workout day options that correspond to days of a week, including:
a first workout day option that corresponds to a first day of the week;
a second workout day option that corresponds to a second day of the week different from the first day of the week; and
a third workout day option that corresponds to a third day of the week different from the first day of the week and the second day of the week.

102. The computer system of claim 96, wherein:
the workout history of the user of the computer system includes one or more previously completed workouts that correspond to a first workout type; and
the first workout suggestion is selected for inclusion in the first user interface based on the workout history of user of the computer system including one or more previously completed workouts that correspond to the first workout type and the first workout suggestion corresponding to the first workout type.

103. The computer system of claim 96, wherein:
the workout history of the user of the computer system includes one or more previously completed workouts that correspond to a first trainer; and
the first workout suggestion is selected for inclusion in the first user interface based on the workout history of the user of the computer system including one or more previously completed workouts that correspond to the first trainer and the first workout suggestion corresponding to the first trainer.

104. The computer system of claim 96, wherein:
the workout history of the user of the computer system includes one or more previously completed workouts that correspond to a first duration; and
the first workout suggestion is selected for inclusion in the first user interface based on the workout history of the user of the computer system including one or more previously completed workouts that correspond to the first duration and the first workout suggestion corresponding to the first duration.

105. The computer system of claim 96, wherein:
the workout history of the user of the computer system includes one or more previously completed workouts that correspond to a first music type; and
the first workout suggestion is selected for inclusion in the first user interface based on the workout history of the user of the computer system including one or more previously completed workouts that correspond to the first music type and the first workout suggestion corresponding to the first music type.

106. The computer system of claim 96, wherein:
the first user interface is scrollable in a second direction different from the first direction; and
the one or more programs further include instructions for:
while concurrently displaying the first scrollable region and the first workout suggestion, detecting, via the one or more input devices, a navigation input corresponding to a user request to scroll the first user interface in the second direction; and
in response to detecting the navigation input:
displaying scrolling of the first user interface to display one or more additional sections of the first user interface that were not displayed prior to detecting the navigation input, including a first section that includes a first set of workout suggestions.

107. The computer system of claim 106, wherein:
the first set of workout suggestions is selected for inclusion in the first section based on a first set of selection criteria pertaining to the workout history of the user.

108. The computer system of claim 107, wherein:
the one or more additional sections of the first user interface includes a second section different from the first section and that includes a second set of workout suggestions different from the first set of workout suggestions; and
the second set of workout suggestions is selected for inclusion in second first section based on a second set of selection criteria, wherein the second set of selection criteria is different from the first set of selection criteria.

109. The computer system of claim 105, wherein the one or more additional sections of the first user interface includes a workout types section, wherein:
the workout types section includes a plurality of workout type options corresponding to different workout types, including:
a first workout type option corresponding to a first workout type, wherein the first workout type option, when selected, causes the computer system to display a first plurality of workout suggestions that correspond to the first workout type; and
a second workout type option corresponding to a second workout type different from the first workout type, wherein the second workout type option, when selected, causes the computer system to display a second plurality of workout suggestions that correspond to the second workout type.

110. The computer system of claim 109, wherein:
the plurality of workout type options are displayed in a first order; and
the first order is determined based on the workout history of the user of the computer system.

111. The computer system of claim 105, wherein the one or more additional sections of the first user interface includes a trainers section, wherein:
the trainers section includes a plurality of trainer options corresponding to different trainers, including:
a first trainer option corresponding to a first trainer, wherein the first trainer option, when selected, causes the computer system to display a first plurality of workout suggestions that correspond to the first trainer; and
a second trainer option corresponding to a second trainer different from the first trainer, wherein the second trainer option, when selected, causes the computer system to display a second plurality of workout suggestions that correspond to the second trainer.

112. The computer system of claim 111, wherein:
the plurality of trainer options are displayed in a second order; and
the second order is determined based on the workout history of the user of the computer system.

113. The computer system of claim 105, wherein the one or more additional sections of the first user interface includes an achievements section that includes a representation of a first workout achievement, wherein the first workout achievement corresponds to a first set of workout goals.

114. The computer system of claim 113, wherein the representation of the first workout achievement, when selected, causes the computer system to display a first set of workout suggestions, wherein the first set of workout suggestions is selected based on the first set of workout goals corresponding to the first workout achievement.

115. The computer system of claim 96, the one or more programs further including instructions for:
displaying, concurrently with the first user interface, a first user interface object and a second user interface object distinct from the first user interface object, wherein:
the first user interface object corresponds to the first user interface and, when selected, causes the computer system to display the first user interface; and
the second user interface object corresponds to a second user interface different from the first user interface and, when selected, causes the computer system to display the second user interface, wherein the second user interface includes a second plurality of workout suggestions that are selected for inclusion in the second user interface without regard for the workout history of the user of the computer system.

116. A non-transitory computer-readable storage medium storing one or more programs configured to be executed by one or more processors of a computer system that is in communication with one or more display generation components and one or more input devices, the one or more programs including instructions for:
displaying, via the one or more display generation components, a first user interface that includes:
a first scrollable region that is scrollable in a first direction; and
a plurality of workout suggestions that are selected for inclusion in the first user interface based on a workout history of a user of the computer system, including a first workout suggestion that is selected for inclusion in the first user interface based on the workout history of the user of the computer system and that, when selected, causes the computer system to initiate a process for playback of a first workout corresponding to the first workout suggestion;
displaying, within a first portion of the first scrollable region of the first user interface and concurrently with the first workout suggestion, a second workout suggestion different from the first workout suggestion, wherein the second workout suggestion is selected for inclusion in the first user interface based on the workout history of the user of the computer system and, when selected, causes the computer system to initiate a process for playback of a second workout different from the first workout;
while displaying the second workout suggestion within the first portion of the first scrollable region of the first user interface, detecting, via the one or more input devices, a first user input; and
in response to detecting the first user input:
in accordance with a determination that the first user input is directed to the first scrollable region, displaying, concurrently with the first workout suggestion, scrolling of the first scrollable region to display, within the first portion of the first scrollable region, a workout plan recommendation, wherein:
the workout plan recommendation is determined based on the workout history of the user of the computer system; and
the workout plan recommendation pertains to a multi-workout workout plan.

117. A method, comprising:
at a computer system that is in communication with one or more display generation components and one or more input devices:
displaying, via the one or more display generation components, a first user interface that includes:
a first scrollable region that is scrollable in a first direction; and
a plurality of workout suggestions that are selected for inclusion in the first user interface based on a workout history of a user of the computer system, including a first workout suggestion that is selected for inclusion in the first user interface based on the workout history of the user of the computer system and that, when selected, causes the computer system to initiate a process for playback of a first workout corresponding to the first workout suggestion;
displaying, within a first portion of the first scrollable region of the first user interface and concurrently with the first workout suggestion, a second workout suggestion different from the first workout suggestion, wherein the second workout suggestion is selected for inclusion in the first user interface based on the workout history of the user of the computer system and, when selected, causes the computer system to initiate a process for playback of a second workout different from the first workout;
while displaying the second workout suggestion within the first portion of the first scrollable region of the first user interface, detecting, via the one or more input devices, a first user input; and
in response to detecting the first user input:
in accordance with a determination that the first user input is directed to the first scrollable region, displaying, concurrently with the first workout suggestion, scrolling of the first scrollable region to display, within the first portion of the first scrollable region, a workout plan recommendation, wherein:
the workout plan recommendation is determined based on the workout history of the user of the computer system; and
the workout plan recommendation pertains to a multi-workout workout plan.
